(19) United States
(12) Patent Application Publication
(10) Pub. No.: US 2023/0203378 A1
(43) Pub. Date: Jun. 29, 2023

(54) FORMULATIONS OF BIOREACHABLE DOPANTS FOR LIQUID CRYSTALS

(71) Applicants: Zymergen Inc., Emeryville, CA (US); Kent State University, Kent, OH (US)

(72) Inventors: Shilpa Naresh Raja, Emeryville, CA (US); Arjan Zoombelt, Emeryville, CA (US); Adam Safir, Berkeley, CA (US); Peter Palffy-Muhoray, Kent, OH (US); Robert J. Twieg, Kent, OH (US); Hiroshi Yokoyama, Kent, OH (US); Tianyi Guo, Kent, OH (US); Pawan Nepal, Kent, OH (US)

(21) Appl. No.: 17/928,265

(22) PCT Filed: Jun. 4, 2021
(86) PCT No.: PCT/US2021/035956

§ 371 Date: Nov. 28, 2022

Related U.S. Application Data
(60) Provisional application No. 62/704,994, filed on Jun. 5, 2020.

(51) Int. Cl. C09K 19/58; C09K 19/02; G02F 1/13

(52) U.S. Cl. CPC C09K 19/586; C09K 19/0208; G02F 1/13; C09K 2219/03; C09K 2323/031

(57) ABSTRACT

The present disclosure relates to formulations having one, two, or more chiral dopants, as well as materials and methods including such formulations. In particular instances, the formulation can include an achiral host, such as a nematic substance.

### CROSS-REFERENCE TO RELATED APPLICATION

This application claims the benefit of U.S. Provisional Application No. 62/704,994, Filed Jun. 5, 2020, which is incorporated by reference in its entirety.

### STATEMENT OF GOVERNMENT INTEREST

This invention was made with Government support under Agreement No. HR0011-15-9-0014, awarded by DARPA. The Government has certain rights in the invention.

### FIELD OF THE DISCLOSURE

The present disclosure relates to formulations having one, two, or more chiral dopants, as well as materials and methods including such formulations. In particular instances, the formulation can include an achiral host, such as a nematic substance, in addition to such dopant(s).

### BACKGROUND

Liquid crystalline (LC) materials have uses in a variety of applications, including liquid crystal displays, electronic writers or tablets, electronic skins, reflective films, optical filters, polarizers, paints, and inks, among others. In particular, the material can include a formulation having a nematic LC component with a small amount of a chiral dopant. The composition and purity of the dopant can impact the physical properties of the formulation. Accordingly, there is a need for dopants and formulations with controllable properties.

### SUMMARY OF THE DISCLOSURE

The present disclosure relates to a formulation including chiral, bioreachable dopants having origin from biological resources. In non-limiting embodiment, microbes produce chiral biomolecules (e.g., betulin or glycyrrhetinic acid) through fermentation, and then such biomolecules are structurally modified by chemical synthesis (e.g., to include one or more chemical moieties, such as any described herein). In this way, optically pure, stabilized dopants can be achieved. In particular embodiments, such chiral dopants can be employed with a host (e.g., achiral molecule(s)) to provide a doped material.

The present disclosure also relates to the use of multicomponent mixtures to provide a desired optical or physical property. For instance, assume that a certain threshold percentage of a single chiral dopant is required in a particular host to achieve a desired pitch value, yet that threshold percentage cannot be practically achieved because the resultant mixture is unstable due to phase separation in the required temperature range. Described herein are approaches to achieve a desired pitch value by using multicomponent mixtures. In one non-limiting embodiment, the multicomponent mixture is a ternary mixture having a first chiral dopant, a second chiral dopant, and an achiral host. The concentration of each of the first and second chiral dopants can be dramatically reduced in the ternary mixture, thereby avoiding crystallization or phase separation from the host. Yet, the combined concentration of both dopants can be sufficiently high enough to reach that threshold percentage, thereby providing a formulation having the desired pitch. In this way, multicomponent mixtures having a plurality of dopants can provide stable formulations having desired optical or physical properties.

Accordingly, in some non-limiting embodiments, the formulation includes a plurality of chiral dopants, which provides enhanced properties as compared to the use of a single chiral dopant. In use, the dopants can be combined with a host to provide a formulation. Without wishing to be limited by the mechanism, it is believed that the presence of two or more chiral dopants could provide desired physical or optical properties, while maintaining the stability or homogeneity of the formulation or doped material. In some instances, the overall concentration of the dopants can be reduced, as compared to the requisite concentration of a single dopant to achieve comparable optical or other physical properties. Also described herein are compositions, formulations, materials, and methods thereof.

In a first aspect, the present disclosure features a formulation including about 0.5 wt. % to about 30 wt. % of a chiral dopant (e.g., a first chiral dopant) derived from betulin or glycyrrhetinic acid; and about 50 wt. % to about 99.5 wt. % of an achiral host. Other non-limiting amounts of a chiral dopant (e.g., a first, second, and/or third chiral dopant) is from about 0.1 wt. % to about 60 wt. %, as well as other ranges disclosed herein. In particular embodiments, the glycyrrhetinic acid is a 18β-glycyrrhetinic acid derivative.

In some embodiments, the chiral dopant (e.g., the first chiral dopant) includes a structure having formula (I) or (III):

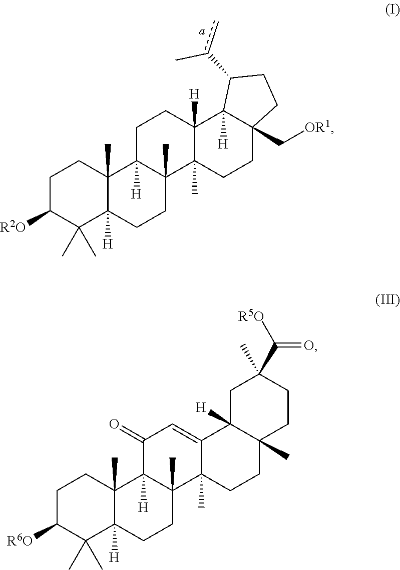

or a salt thereof, wherein each of R¹, R², and R⁶ is, independently, H, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl; R⁵ is H, optionally substituted alkyl, optionally substituted alkenyl, optionally substituted aralkyl, optionally substituted aryl, or optionally substituted alkaryl; and letter “a” represents a pi-bond, in which the pi-bond “a” may be present or absent. In other embodiments, the chiral dopant does not include a salt.

In some embodiments, the chiral dopant includes a structure having formula (IA) or (IB):

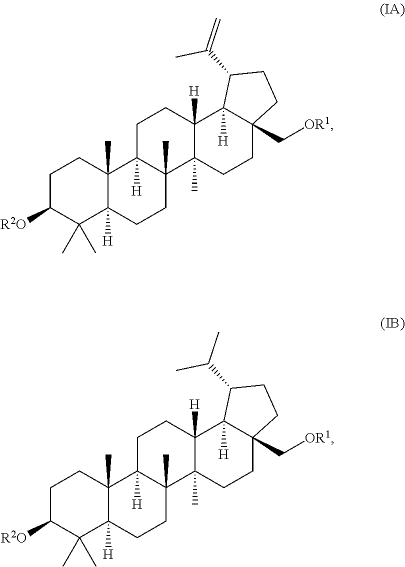

or a salt thereof, in which illustrative substituents for R¹ and R² are described herein (e.g., as for formula (I)).

In other embodiments, the chiral dopant includes a structure having formula (IAa), (IBa), (IAb), or (IBb):

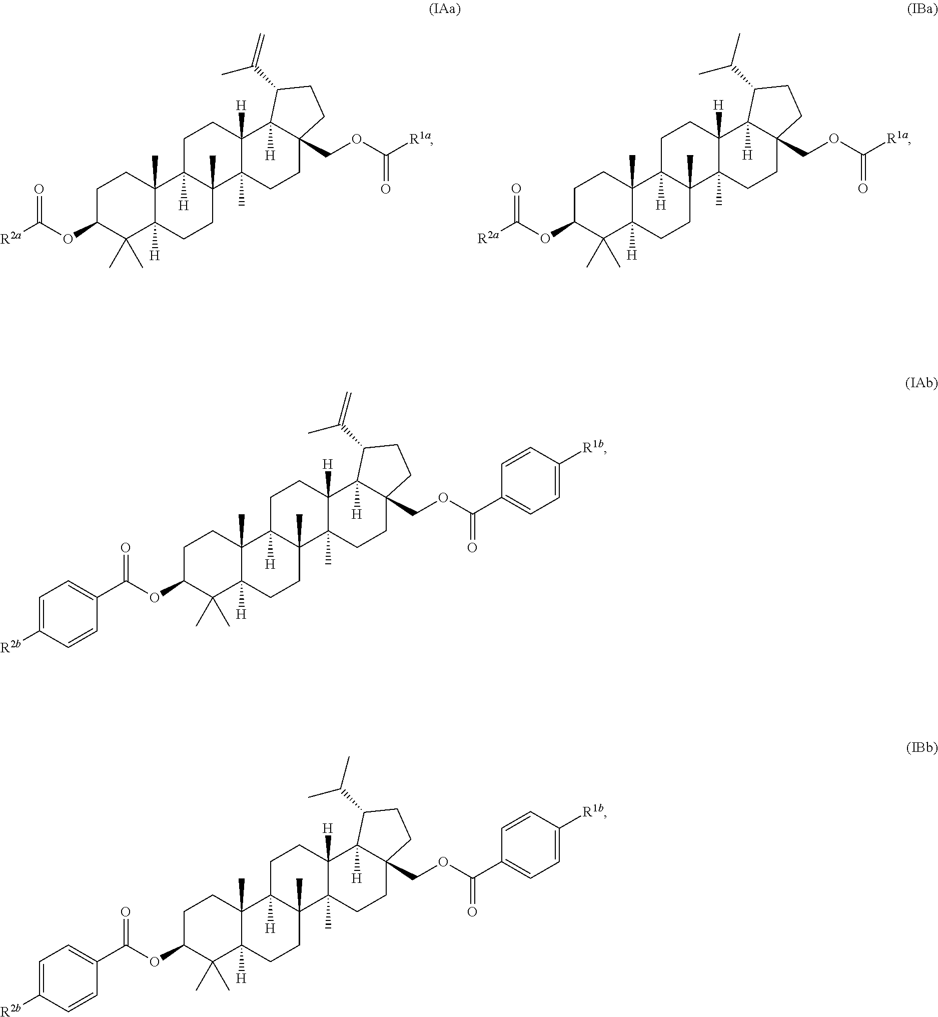

or a salt thereof, wherein each of R^{1a}, R^{2a}, R^{1b}, and R^{2b} is, independently, H, optionally substituted alkyl, optionally substituted haloalkyl, optionally substituted alkenyl, optionally substituted aralkyl, optionally substituted aryl, or optionally substituted alkaryl. In particular embodiments, each of R^{1a}, R^{2a}, R^{1b}, and R^{2b} is, independently, optionally substituted alkyl (e.g., optionally substituted C₂₋₆, C₂₋₁₂, C₂₋₁₆, C₂₋₁₈, C₂₋₂₀, or C₂₋₂₄ alkyl). In some embodiments, each of R^{1a}, R^{2a}, R^{1b}, and R^{2b} is not H.

In a second aspect, the present disclosure features a formulation including: a first chiral dopant derived from betulin or glycyrrhetinic acid; and a second chiral dopant derived from betulin or glycyrrhetinic acid, in which the first and second chiral dopants are different. In further embodiments, the formulation includes an achiral host. In other embodiments, the formulation includes about 0.5 wt. % to about 30 wt. % of the first chiral dopant, about 0.5 wt. % to about 30 wt. % of the second chiral dopant, and about 40 wt. % to about 99 wt. % of the achiral host.

In some embodiments, the first chiral dopant includes a structure having formula (I), and the second chiral dopant includes a structure having formula (II):

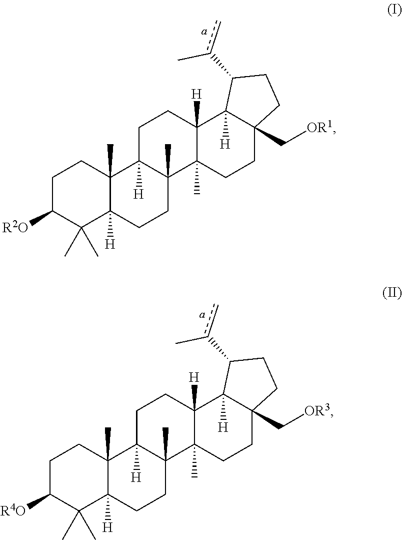

or a salt thereof, wherein each of R¹, R², R³, and R⁴ is, independently, H, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl; and letter “a” represents a pi-bond, in which the pi-bond “a” may be present or absent. In further embodiments, at least one of R¹ and R² in formula (I) is different from at least one of R³ and R⁴ in formula (II).

In some embodiments, the first chiral dopant includes a structure having formula (IA) or (IB):

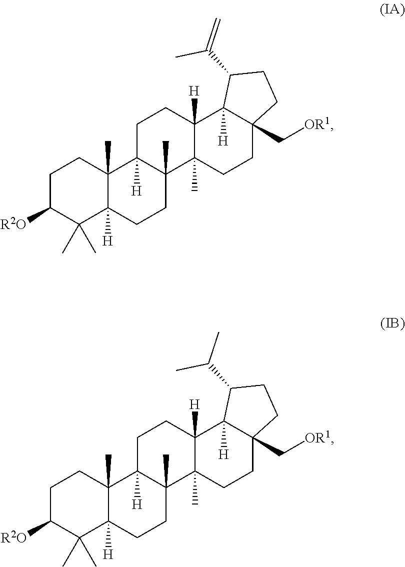

or a salt thereof, in which illustrative substituents for R¹ and R² are described herein (e.g., as for formula (I)). In particular embodiments, each of R¹ and R² includes, independently, optionally substituted alkyl, optionally substituted aryl, optionally substituted alkaryl, and/or optionally substituted aralkyl. In some embodiments, at least one of R¹ and R² is not H. In other embodiments, each of R¹ and R² is not H. In yet other embodiments, the first chiral dopant does not include a salt.

In some embodiments, the second chiral dopant includes a structure having formula (IIA) or (IIB):

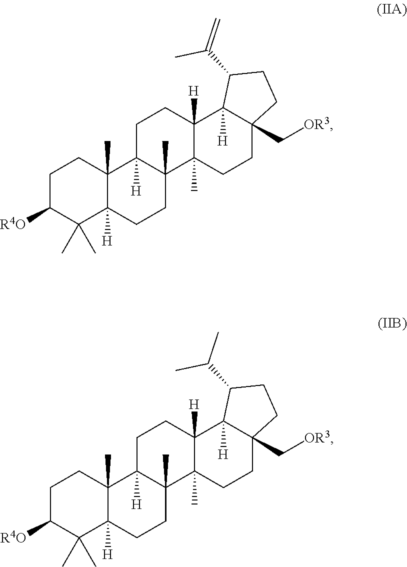

or a salt thereof, in which illustrative substituents for R³ and R⁴ are described herein (e.g., as for formula (II)). In particular embodiments, each of R³ and R⁴ includes, independently, optionally substituted alkyl, optionally substituted aryl, optionally substituted alkaryl, and/or optionally substituted aralkyl. In some embodiments, at least one of R³ and R⁴ is not H. In other embodiments, each of R³ and R⁴ is not H. In yet other embodiments, the first chiral dopant does not include a salt.

In some embodiments, the first or second chiral dopant includes a structure having formula (IAa), (IBa), (IAb), or (IBb):

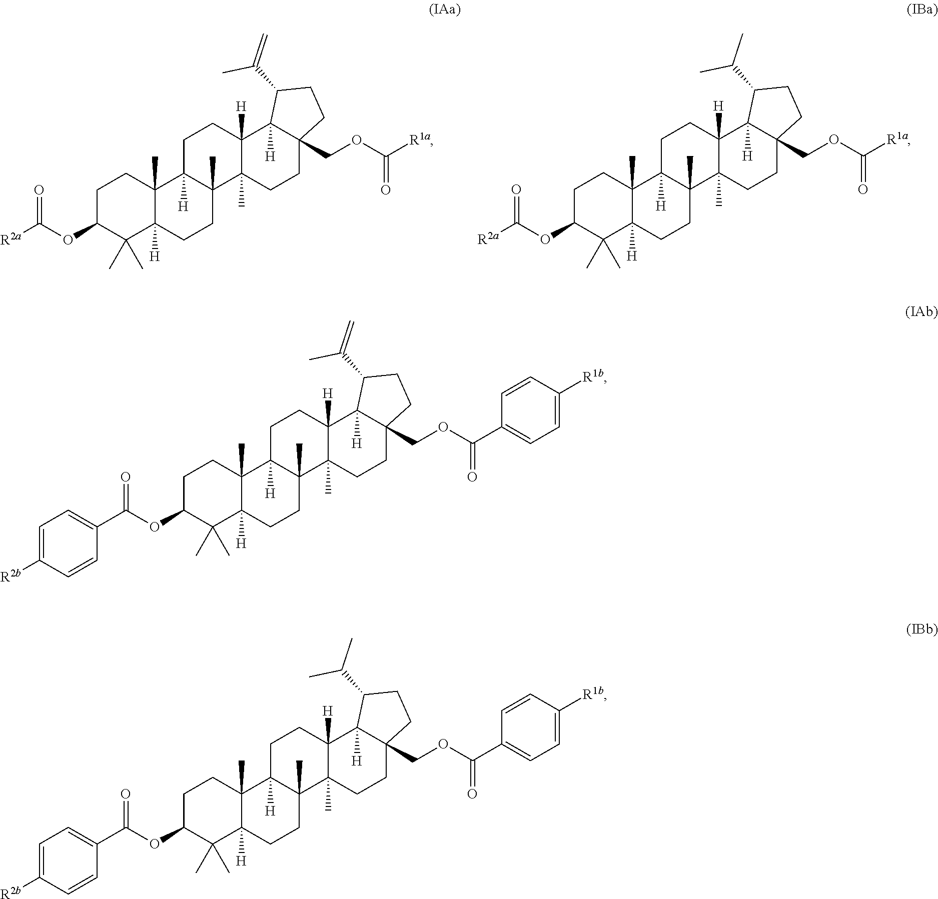

or a salt thereof, wherein each of R^{1a}, R^{2a}, R^{1b}, and R^{2b} is, independently, H, optionally substituted alkyl, optionally substituted haloalkyl, optionally substituted alkenyl, optionally substituted aralkyl, optionally substituted aryl, or optionally substituted alkaryl. In particular embodiments, each of R^{1a}, R^{2a}, R^{1b}, and R^{2b} is, independently, optionally substituted alkyl (e.g., optionally substituted C₂₋₆, C₂₋₁₂, C₂₋₁₆, C₂₋₁₈, C₂₋₂₀, or C₂₋₂₄ alkyl). In some embodiments, each of R^{1a}, R^{2a}, R^{1b}, and R^{2b} is not H.

In further embodiments, the formulation includes a third chiral dopant derived from betulin, wherein the first, second, and third chiral dopants are different. In some embodiments, the third chiral dopant includes a structure having formula (IA), (IB), or a salt thereof (e.g., as described herein). In other embodiments, none of the chiral dopants in the formulation is in salt form.

In a third aspect, the present disclosure features a liquid crystalline material including about 0.5 wt. % to about 20 wt. % of a first chiral dopant derived from betulin or glycyrrhetinic acid; and about 0.5 wt. % to about 20 wt. % of a second chiral dopant derived from betulin or glycyrrhetinic acid, wherein the first and second chiral dopants are different. In some embodiments, the ratio of the first chiral dopant to the second chiral dopant is from about 90:10 (w/w) to about 10:90 (w/w) ratio, as well as ratios therebetween (e.g., as described herein). In other embodiments, the material further includes a third chiral dopant derived from betulin or glycyrrhetinic acid, wherein the first, second, and third chiral dopants are different. In yet other embodiments, the material further includes from about 40 wt. % to about 99 wt. % of an achiral host.

In some embodiments, the first chiral dopant includes a structure having formula (I), (IA), (IB), (IAa), (IBa), (IAb), (IBb), (III), or a salt thereof (e.g., as described herein); and/or second chiral dopant includes a structure having formula (II), (IIA), (IIB), (IAa), (IBa), (IAb), (IBb), (III), or a salt thereof (e.g., as described herein). In other embodiments, R¹ in formula (I) is -Lk-R^{1a} or -Lk-Ar—R^{1a}; R² in formula (I) is -Lk-R^{2a} or -Lk-Ar—R^{2a}; R³ in formula (II) is -Lk-R^{3a} or -Lk-Ar—R^{3a}; R⁴ in formula (II) is -Lk-R^{4a} or -Lk-Ar—R^{4a}; R⁵ in formula (III) is -Lk-R^{5a} or -Lk-Ar—R^{5a}; and/or R⁶ in formula (III) is -Lk-R^{6a} or -Lk-Ar—R^{6a}, wherein each of R^{1a}, R^{2a}, R^{3a}, R^{4a}, and R^{6a} is H, optionally substituted alkyl, optionally substituted haloalkyl, optionally substituted alkenyl, optionally substituted aralkyl, optionally substituted aryl, or optionally substituted alkaryl; in which Ar is optionally substituted arylene; and in which Lk is a covalent bond, optionally substituted alkylene, —O—, or —C(O)—.

In some embodiments, the material includes a helical twisting power of from about 1 μm⁻¹ to about 100 μm⁻¹, as well as ranges therebetween (e.g., as described herein).

In a fourth aspect, the present disclosure features a liquid crystal display, optical element, or color filter including any formulation, mixture, or material described herein. In particular embodiments, the liquid crystal display, optical element, or color filter includes one or more layers, in which at least one of the layers includes any formulation, mixture, or material described herein. In some embodiments, the layer having a liquid crystalline material is characterized by a cholesteric pitch (P) and a thickness (d), wherein a ratio of d/P is at least 0.01, at least 0.02, at least 0.05, at least 0.1, or at least 0.15. In other embodiments, the ratio of d/P is not greater than 1, not greater than 0.8, not greater than 0.6, not greater than 0.4, not greater than 0.3, or not greater than 0.25.

In a fifth aspect, the present disclosure features a method of making a formulation (e.g., any formulation described herein). In some embodiments, the method includes reacting a first biomolecule with a first derivatizing agent to provide a first chiral dopant including a structure having formula (I), (III), or a salt thereof (e.g., as described herein); and combining the first chiral dopant with an achiral host to provide the formulation.

In particular embodiments, the first biomolecule includes betulin or glycyrrhetinic acid. In other embodiments, the formulation includes about 0.5 wt. % to about 30 wt. % of the first chiral dopant and about 50 wt. % to about 99.5 wt. % of the achiral host.

In some embodiments, the first derivatizing agent (e.g., for use with betulin) includes R¹-L, R^{1a}—C(O)-L, R^{1a}—Ar—C(O)-L, R²-L, R^{2a}—C(O)-L, or R^{2a}—Ar—C(O)-L, in which R¹, R^{1a}, R², and R^{2a} can be any described herein and L is a leaving group, such as chloro, bromo, iodo, sulfonate (e.g., mesylate, tosylate, or triflate), or carboxylate (e.g., —OC(O)—R^{1a} or —OC(O)—R^{2a}, in which R^{1a} and R^{2a} are any described herein). In particular embodiments, each of R¹ and R² is, independently, H, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl; each of R^{1a} and R^{2a} is H, optionally substituted alkyl, optionally substituted haloalkyl, optionally substituted alkenyl, optionally substituted aralkyl, optionally substituted aryl, or optionally substituted alkaryl; and Ar is optionally substituted arylene.

In other embodiments, the first derivatizing agent (e.g., for use with glycyrrhetinic acid) includes R⁵-L, R⁵—OH, R⁶-L, R^{6a}—C(O)-L, or R^{6a}—Ar—C(O)-L, in which R⁵, R⁶, and R^{6a} can be any described herein and L is a leaving group, such as chloro, bromo, iodo, sulfonate (e.g., mesylate, tosylate, or triflate), or carboxylate (e.g., —OC(O)—R^{6a}, as described herein). In particular embodiments, R⁵ is H, optionally substituted alkyl, optionally substituted alkenyl, optionally substituted aralkyl, optionally substituted aryl, or optionally substituted alkaryl; R⁶ is H, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl; R^{6a} is H, optionally substituted alkyl, optionally substituted haloalkyl, optionally substituted alkenyl, optionally substituted aralkyl, optionally substituted aryl, or optionally substituted alkaryl; and Ar is optionally substituted arylene.

In further embodiments, the method further includes reacting a second biomolecule with a second derivatizing agent to provide a second chiral dopant. In some embodiments, the second chiral dopant includes a structure having formula (I), (III), or a salt thereof; and the first and second chiral dopants are different. In other embodiments, the second biomolecule includes betulin or glycyrrhetinic acid.

In some embodiments, the second derivatizing agent (e.g., for use with betulin) includes R¹-L, R^{1a}—C(O)-L, R^{1a}—Ar—C(O)-L, R²-L, R^{2a}—C(O)-L, or R^{2a}—Ar—C(O)-L, in which R¹, R^{1a}, R², and R^{2a} can be any described herein and L is a leaving group, such as chloro, bromo, iodo, sulfonate (e.g., mesylate, tosylate, or triflate), or carboxylate (e.g., —OC(O)—R^{1a} or —OC(O)—R^{2a}, in which R^{1a} and R^{2a} are any described herein). In particular embodiments, each of R¹ and R² is, independently, H, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl; each of R^{1a} and R^{2a} is H, optionally substituted alkyl, optionally substituted haloalkyl, optionally substituted alkenyl, optionally substituted aralkyl, optionally substituted aryl, or optionally substituted alkaryl; and Ar is optionally substituted arylene. In other embodiments, the first and second derivatizing agents are different. In yet other embodiments, at least one of R¹, R^{1a}, R², and R^{2a} in the first derivatizing agent is different from at least one of R¹, R^{1a}, R², and R^{2a} in the second derivatizing agent.

In other embodiments, the second derivatizing agent (e.g., for use with glycyrrhetinic acid) includes R⁵-L, R⁵—OH, R⁶-L, R^{6a}—C(O)-L, or R^{6a}—Ar—C(O)-L, in which R⁵, R⁶, and R^{6a} can be any described herein and L is a leaving group, such as chloro, bromo, iodo, sulfonate (e.g., mesylate, tosylate, or triflate), or carboxylate (e.g., —OC(O)—R^{6a}, as described herein). In particular embodiments, R⁵ is H, optionally substituted alkyl, optionally substituted alkenyl, optionally substituted aralkyl, optionally substituted aryl, or optionally substituted alkaryl; R⁶ is H, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl; R^{6a} is H, optionally substituted alkyl, optionally substituted haloalkyl, optionally substituted alkenyl, optionally substituted aralkyl, optionally substituted aryl, or optionally substituted alkaryl; and Ar is optionally substituted arylene. In other embodiments, the first and second derivatizing agents are different. In yet other embodiments, at least one of R⁵, R⁶, and R^{6a} in the first derivatizing agent is different from at least one of R⁵, R⁶, and R^{6a} in the second derivatizing agent.

In yet further embodiments, the method further includes combining the first and second chiral dopants to provide a formulation (e.g., any described herein). In other embodiments, said combining further includes combining the first and second chiral dopants with an achiral host to provide a further formulation. In some embodiments, the further formulation comprising about 0.5 wt. % to about 30 wt. % of the first chiral dopant, about 0.5 wt. % to about 30 wt. % of the second chiral dopant, and about 40 wt. % to about 99 wt. % of the achiral host.

In any embodiment herein, the chiral dopant (e.g., the first, second, and/or third chiral dopant) is selected from the group of:

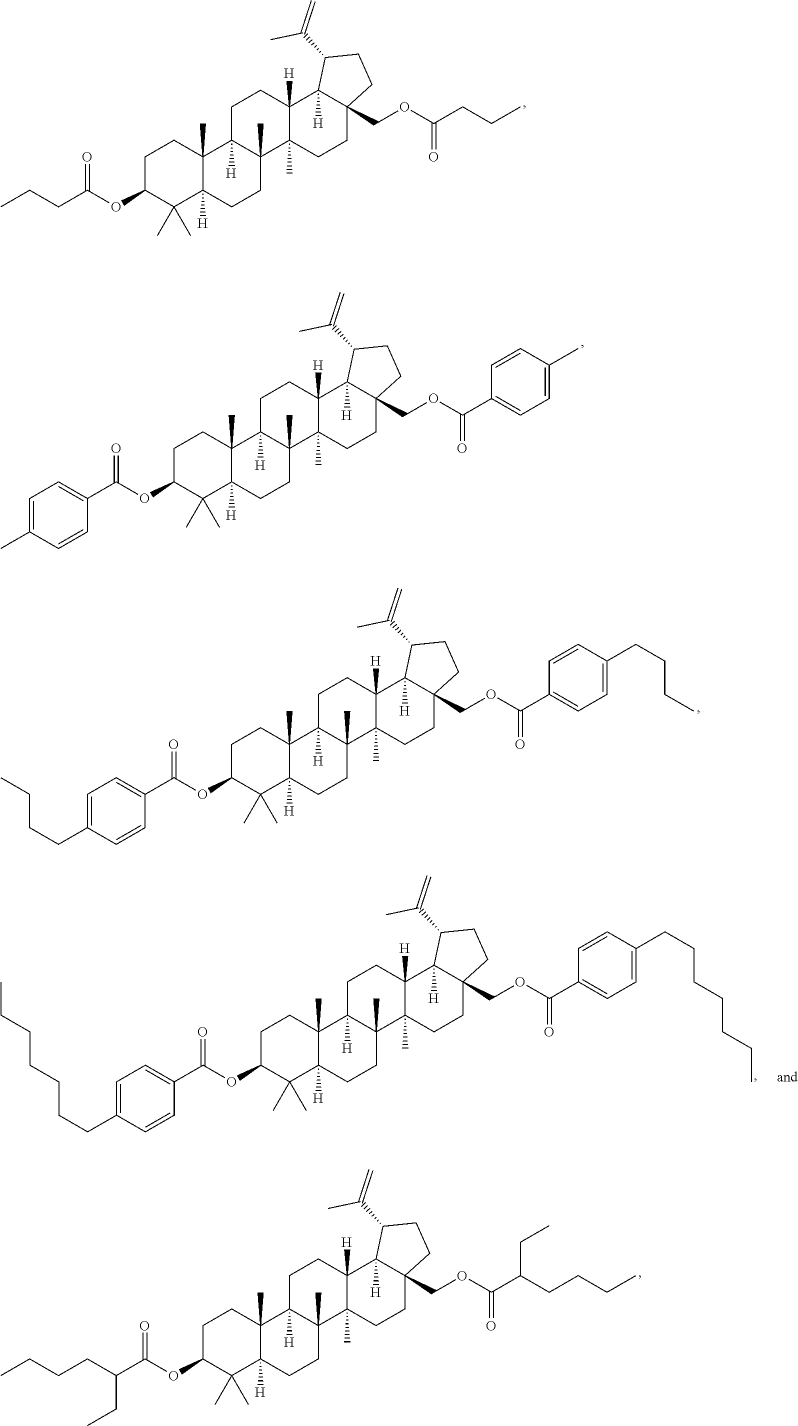

In any embodiment herein, each of R¹, R², R³, R⁴, R⁵, and R⁶ in any formula herein (e.g., formulas (I), (IA), (IB), (II), (IIA), (IIB), and/or (III)) comprises, independently, optionally substituted alkyl, optionally substituted aryl, optionally substituted alkaryl, and/or optionally substituted aralkyl.

In any embodiment herein, at least one of R¹, R², R³, R⁴, R⁵, and R⁶ in any formula herein (e.g., formulas (I), (IA), (IB), (II), (IIA), (IIB), and/or (III)) is not H. In other embodiments, each of R¹, R², R³, R⁴, R⁵, and R⁶ is not H.

In any embodiment herein, the formulation, mixture, or material includes at least one polymerizable mesogenic compound having at least one polymerizable functional group. In particular embodiments, the achiral host of the formulation, mixture, or material includes at least one polymerizable mesogenic compound having at least one polymerizable functional group. In some embodiments, the polymerizable functional group includes an epoxy group, a vinyl group, an allyl group, an acrylate, a methacrylate, an isoprene group, an alpha-amino carboxylate, or any combination thereof.

In any embodiment herein, the formulation, mixture, or material includes one or more achiral hosts. In some embodiments, the host further includes a nematic or a nematogenic substance. In particular embodiments, the nematic or the nematogenic substance is selected from azoxybenzenes, benzylideneanilines, biphenyls, terphenyls, phenyl benzoates, cyclohexyl benzoates, phenyl esters of cyclohehexanecarboxylic acid, cyclohexyl esters of cyclohehexanecarboxylic acid, phenyl esters of cyclohexylbenzoic acid, cyclohexyl esters of cyclohexylbenzoic acid, phenyl esters of cyclohexylcyclohexanecarboxylic acid, cyclohexyl esters of cyclohexylcyclohexanecarboxylic acid, cyclohexylphenyl esters of benzoic acid, cyclohexylphenyl esters of cyclohexanecarboxylic acid, cyclohexylphenyl esters of cyclohexylcyclohexanecarboxylic acid, phenylcyclohexanes, cyclohexylbiphenyls, phenylcyclohexylcyclohexanes, cyclohexylcyclohexanes, cyclohexylcyclohexenes, cyclohexylcyclohexylcyclohexenes, 1,4-bis-cyclohexylbenzenes, 4,4′-bis-cyclohexylbiphenyls, phenylpyrimidines, cyclohexylpyrimidines, phenylpyridines, cyclohexylpyridines, phenylpyridazines, cyclohexylpyridazines, phenyldioxanes, cyclohexyldioxanes, phenyl-1,3-dithianes, cyclohexyl-1,3-dithianes, 1,2-diphenylethanes, 1,2-dicyclohexylethanes, 1-phenyl-2-cyclohexylethanes, 1-cyclohexyl-2-(4-phenylcyclohexyl) ethanes, 1-cyclohexyl-2-biphenylethanes, 1-phenyl2-cyclohexylphenylethanes, halogenated stilbenes, benzyl phenyl ether, tolanes, substituted cinnamic acids, or any combination thereof.

In any embodiment herein, the formulation, mixture, or material includes one or more hosts having formula R′—[O]ₕ₁-[A¹]ₕ₂-L¹-[A²]ₕ₃-L²-[O]ₕ₄—R″ or R′—[O]ₕ₁-[A¹]ₕ₂-L¹-[A²]ₕ₃-L²-R″ or R′—[O]-[A¹]-L¹-[A²]-L²-R″ or R′-[A¹]-L¹-[A²]-L²-R″, where each of A¹ and A² is, independently, -Phe-, -Cyc-, -Phe-Phe-, -Phe-Phe-Phe-, -Phe-Cyc-, -Cyc-Phe-, -Cyc-Cyc-, -Het-, —B-Phe-, and —B-Cyc-; Phe is unsubstituted or halo-substituted 1,4-phenylene, naphthalene-2,6-diyl, decahydronaphthalene-2,6-diyl, or 1,2,3,4-tetrahydronaphthalene-2,6-diyl; Cyc is trans-1,4-cyclohexylene or 1,4-cyclohexenylene or bicyclo [2.2.2]octane; Het is pyrimidine-2,5-diyl, pyridine-2,5-diyl, 1,3-dioxane-2,5-diyl, or tetrahydropyran-2,5-diyl; B is 2-(trans-1,4-cyclohexyl)ethyl, pyrimidine-2,5-diyl, pyridine-2,5-diyl 1,3-dioxane-2,5-diyl, or tetrahydropyran-2,5-diyl; each of L¹ and L² is, independently, —CH═CY′—, —CH═CH—, —C≡C—, —N═N(O)—, —CH═N(O)—, —CY′═N—, —CH═N—, —CY′₂—, —(CY′₂)₂—, —CY′₂O—, —OCY′₂—, —COO—, —O—, —C(O)—, —OCO—, —CY′₂—O—, —O—CY′₂—, —CO—S—, —CY′₂—S—, —COO-Phe-COO—, or a single bond; each Y′ is, independently, hydrogen, halo, or —CN; and each of R′ and R″ is, independently, alkyl (e.g., linear or branched C₁₋₁₂ or C₁₋₂₄ alkyl), alkenyl, alkoxy, alkenyloxy, alkanoyloxy, alkoxycarbonyl, alkoxycarbonyloxy, halo, —CF₃, —OCF₃, —NCS, —CN, —OR′″, —OC(O)R′″, —C(O)OR′″, —C(O)OH, or —OC(O)OR′″, in which R′″ is H, optionally substituted C₁₋₁₀ alkyl, or optionally substituted C₂₋₁₀ alkenyl; h1 is 0 or 1; h2 is 0, 1, 2, 3, 4, or 5; h3 is 0, 1, 2, 3, 4, or 5; and h4 is 0 or 1.

In any embodiment herein, the formulation, mixture, or material includes from about 0.1 wt. % to about 60 wt. % of one or more chiral dopant(s). In some embodiments, the formulation, mixture, or material includes from about 0.1 wt. % to about 60 wt. % of two or more chiral dopants, in which the provided wt. % indicates the amount of the chiral dopants taken together. In other embodiments, formulation, mixture, or material includes from about 0.1 wt. % to about 60 wt. % of each of the two or more chiral dopants. Non-limiting amounts of dopant(s) include about 0.1 wt. % to 1 wt. %, 0.1 wt. % to 3 wt. %, 0.1 wt. % to 5 wt. %, 0.1 wt. % to 10 wt. %, 0.1 wt. % to 15 wt. %, 0.1 wt. % to 20 wt. %, 0.1 wt. % to 25 wt. %, 0.1 wt. % to 30 wt. %, 0.1 wt. % to 35 wt. %, 0.1 wt. % to 40 wt. %, 0.1 wt. % to 45 wt. %, 0.1 wt. % to 50 wt. %, 0.1 wt. % to 55 wt. %, 0.5 wt. % to 3 wt. %, 0.5 wt. % to 5 wt. %, 0.5 wt. % to 10 wt. %, 0.5 wt. % to 15 wt. %, 0.5 wt. % to 20 wt. %, 0.5 wt. % to 30 wt. %, 0.5 wt. % to 40 wt. %, 0.5 wt. % to 50 wt. %, 0.5 wt. % to 60 wt. %, 1 wt. % to 5 wt. %, 1 wt. % to 10 wt. %, 1 wt. % to 15 wt. %, 1 wt. % to 20 wt. %, 1 wt. % to 30 wt. %, 1 wt. % to 40 wt. %, 1 wt. % to 50 wt. %, 1 wt. % to 60 wt. %, 3 wt. % to 5 wt. %, 3 wt. % to 10 wt. %, 3 wt. % to 15 wt. %, 3 wt. % to 20 wt. %, 3 wt. % to 30 wt. %, 3 wt. % to 40 wt. %, 3 wt. % to 50 wt. %, 3 wt. % to 60 wt. %, 5 wt. % to 10 wt. %, 5 wt. % to 15 wt. %, 5 wt. % to 20 wt. %, 5 wt. % to 30 wt. %, 5 wt. % to 40 wt. %, 5 wt. % to 50 wt. %, 5 wt. % to 60 wt. %, 8 wt. % to 10 wt. %, 8 wt. % to 15 wt. %, 8 wt. % to 20 wt. %, 8 wt. % to 30 wt. %, 8 wt. % to 40 wt. %, 8 wt. % to 50 wt. %, 8 wt. % to 60 wt. %, 10 wt. % to 15 wt. %, 10 wt. % to 20 wt. %, 10 wt. % to 30 wt. %, 10 wt. % to 40 wt. %, 10 wt. % to 50 wt. %, 10 wt. % to 60 wt. %, 12 wt. % to 15 wt. %, 12 wt. % to 20 wt. %, 12 wt. % to 30 wt. %, 12 wt. % to 40 wt. %, 12 wt. % to 50 wt. %, 12 wt. % to 60 wt. %, 15 wt. % to 20 wt. %, 15 wt. % to 30 wt. %, 15 wt. % to 40 wt. %, 15 wt. % to 50 wt. %, 15 wt. % to 60 wt. %, 20 wt. % to 30 wt. %, 20 wt. % to 40 wt. %, 20 wt. % to 50 wt. %, 20 wt. % to 60 wt. %, 30 wt. % to 40 wt. %, 30 wt. % to 50 wt. %, 30 wt. % to 60 wt. %, 40 wt. % to 50 wt. %, 40 wt. % to 60 wt. %, or 50 wt. % to 60 wt. %, based on the weight of the formulation, the mixture, or the material.

In any embodiment herein, the formulation, mixture, or material includes from about 0.1 wt. % to about 30 wt. % of a first chiral dopant and from about 0.1 wt. % to about 30 wt. % of a second chiral dopant, in which the first and second chiral dopants are different. Non-limiting amounts of each dopant include about 0.1 wt. % to 1 wt. %, 0.1 wt. % to 3 wt. %, 0.1 wt. % to 5 wt. %, 0.1 wt. % to 10 wt. %, 0.1 wt. % to 15 wt. %, 0.1 wt. % to 20 wt. %, 0.1 wt. % to 25 wt. %, 0.5 wt. % to 5 wt. %, 0.5 wt. % to 10 wt. %, 0.5 wt. % to 15 wt. %, 0.5 wt. % to 20 wt. %, 0.5 wt. % to 30 wt. %, 1 wt. % to 5 wt. %, 1 wt. % to 10 wt. %, 1 wt. % to 15 wt. %, 1 wt. % to 20 wt. %, 1 wt. % to 30 wt. %, 3 wt. % to 5 wt. %, 3 wt. % to 10 wt. %, 3 wt. % to 15 wt. %, 3 wt. % to 20 wt. %, 3 wt. % to 30 wt. %, 5 wt. % to 10 wt. %, 5 wt. % to 15 wt. %, 5 wt. % to 20 wt. %, 5 wt. % to 30 wt. %, 8 wt. % to 10 wt. %, 8 wt. % to 15 wt. %, 8 wt. % to 20 wt. %, 8 wt. % to 30 wt. %, 10 wt. % to 15 wt. %, 10 wt. % to 20 wt. %, 10 wt. % to 30 wt. %, 12 wt. % to 15 wt. %, 12 wt. % to 20 wt. %, 12 wt. % to 30 wt. %, 15 wt. % to 20 wt. %, 15 wt. % to 30 wt. %, 20 wt. % to 30 wt. %, or 25 wt. % to 30 wt. %, based on the weight of the formulation, the mixture, or the material.

In any embodiment herein, the formulation, mixture, or material includes from about 40 wt. % to about 99.9 wt. % of one or more achiral hosts. Non-limiting amounts of achiral host(s) include about 40 wt. % to 50 wt. %, 40 wt. % to 60 wt. %, 40 wt. % to 70 wt. %, 40 wt. % to 75 wt. %, 40 wt. % to 80 wt. %, 40 wt. % to 85 wt. %, 40 wt. % to 90 wt. %, 40 wt. % to 95 wt. %, 40 wt. % to 98 wt. %, 40 wt. % to 99 wt. %, 40 wt. % to 99.5 wt. %, 45 wt. % to 50 wt. %, 45 wt. % to 60 wt. %, 45 wt. % to 70 wt. %, 45 wt. % to 75 wt. %, 45 wt. % to 80 wt. %, 45 wt. % to 85 wt. %, 45 wt. % to 90 wt. %, 45 wt. % to 95 wt. %, 45 wt. % to 98 wt. %, 45 wt. % to 99 wt. %, 45 wt. % to 99.5 wt. %, 45 wt. % to 99.9 wt. %, 50 wt. % to 60 wt. %, 50 wt. % to 70 wt. %, 50 wt. % to 75 wt. %, 50 wt. % to 80 wt. %, 50 wt. % to 85 wt. %, 50 wt. % to 90 wt. %, 50 wt. % to 95 wt. %, 50 wt. % to 98 wt. %, 50 wt. % to 99 wt. %, 50 wt. % to 99.5 wt. %, 50 wt. % to 99.9 wt. %, 55 wt. % to 60 wt. %, 55 wt. % to 70 wt. %, 55 wt. % to 75 wt. %, 55 wt. % to 80 wt. %, 55 wt. % to 85 wt. %, 55 wt. % to 90 wt. %, 55 wt. % to 95 wt. %, 55 wt. % to 98 wt. %, 55 wt. % to 99 wt. %, 55 wt. % to 99.5 wt. %, 55 wt. % to 99.9 wt. %, 60 wt. % to 70 wt. %, 60 wt. % to 75 wt. %, 60 wt. % to 80 wt. %, 60 wt. % to 85 wt. %, 60 wt. % to 90 wt. %, 60 wt. % to 95 wt. %, 60 wt. % to 98 wt. %, 60 wt. % to 99 wt. %, 60 wt. % to 99.5 wt. %, 60 wt. % to 99.9 wt. %, 65 wt. % to 70 wt. %, 65 wt. % to 75 wt. %, 65 wt. % to 80 wt. %, 65 wt. % to 85 wt. %, 65 wt. % to 90 wt. %, 65 wt. % to 95 wt. %, 65 wt. % to 98 wt. %, 65 wt. % to 99 wt. %, 65 wt. % to 99.5 wt. %, 65 wt. % to 99.9 wt. %, 70 wt. % to 75 wt. %, 70 wt. % to 80 wt. %, 70 wt. % to 85 wt. %, 70 wt. % to 90 wt. %, 70 wt. % to 95 wt. %, 70 wt. % to 98 wt. %, 70 wt. % to 99 wt. %, 70 wt. % to 99.5 wt. %, 70 wt. % to 99.9 wt. %, 75 wt. % to 80 wt. %, 75 wt. % to 85 wt. %, 75 wt. % to 90 wt. %, 75 wt. % to 95 wt. %, 75 wt. % to 98 wt. %, 75 wt. % to 99 wt. %, 75 wt. % to 99.5 wt. %, 75 wt. % to 99.9 wt. %, 80 wt. % to 85 wt. %, 80 wt. % to 90 wt. %, 80 wt. % to 95 wt. %, 80 wt. % to 98 wt. %, 80 wt. % to 99 wt. %, 80 wt. % to 99.5 wt. %, 80 wt. % to 99.9 wt. %, 85 wt. % to 90 wt. %, 85 wt. % to 95 wt. %, 85 wt. % to 98 wt. %, 85 wt. % to 99 wt. %, 85 wt. % to 99.5 wt. %, 85 wt. % to 99.9 wt. %, 90 wt. % to 95 wt. %, 90 wt. % to 98 wt. %, 90 wt. % to 99 wt. %, 90 wt. % to 99.5 wt. %, 90 wt. % to 99.9 wt. %, 95 wt. % to 98 wt. %, 95 wt. % to 99 wt. %, 95 wt. % to 99.5 wt. %, or 95 wt. % to 99.9 wt. %, based on the weight of the formulation, the mixture, or the material. Additional details follow.

### Definitions

The term “acyl,” or “alkanoyl,” as used interchangeably herein, represents an alkyl group, as defined herein, or hydrogen attached to the parent molecular group through a carbonyl group, as defined herein. For instance, the alkanoyl group can be —C(O)-Ak, in which Ak is alkyl, as defined herein. This group is exemplified by formyl, acetyl, propionyl, butanoyl, and the like. The alkanoyl group can be substituted or unsubstituted. For example, the alkanoyl group can be substituted with one or more substitution groups, as described herein for alkyl. In some embodiments, the unsubstituted acyl group is a C₂₋₇ acyl or alkanoyl group.

By “alkaryl” or “alkylaryl” is meant —Ar-Ak, in which Ar is an optionally substituted arylene, as defined herein, and Ak is an optionally substituted alkyl, as defined herein. The alkaryl group can be substituted or unsubstituted. For example, the alkaryl group can be substituted with one or more substitution groups, as described herein for alkyl and/or aryl. Non-limiting unsubstituted alkaryl groups are of from 7 to 16 carbons (C₇₋₁₆ alkaryl), as well as those having an alkyl group with 1 to 6 carbons and an arylene group with 4 to 18 carbons (i.e., —C₄₋₁₈ arylene-C₁₋₆ alkyl).

By “alkenyl” is meant an optionally substituted C₂₋₂₄ alkyl group having one or more double bonds. The alkenyl group can be cyclic (e.g., C₃₋₂₄ cycloalkenyl) or acyclic. The alkenyl group can also be substituted or unsubstituted. For example, the alkenyl group can be substituted with one or more substitution groups, as described herein for alkyl.

By “alkoxy” is meant —OR, where R is an optionally substituted alkyl group, as described herein. Non-limiting alkoxy groups include methoxy, ethoxy, butoxy, trihaloalkoxy, such as trifluoromethoxy, etc. The alkoxy group can be substituted or unsubstituted. For example, the alkoxy group can be substituted with one or more substitution groups, as described herein for alkyl. Non-limiting unsubstituted alkoxy groups include C₁₋₃, C₁₋₆, C₁₋₁₂, C₁₋₁₆, C₁₋₁₈, C₁₋₂₀, or C₁₋₂₄ alkoxy groups.

By “aliphatic” is meant a hydrocarbon group having at least one carbon atom to 50 carbon atoms (C₁₋₅₀), such as one to 25 carbon atoms (C₁₋₂₅), or one to ten carbon atoms (C₁₋₁₀), and which includes alkanes (or alkyl), alkenes (or alkenyl), alkynes (or alkynyl), including cyclic versions thereof, and further including straight- and branched-chain arrangements, and all stereo and position isomers as well.

By “alkyl” and the prefix “alk” is meant a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic (e.g., C₃₋₂₄ cycloalkyl) or acyclic. The alkyl group can be branched or unbranched. The alkyl group can also be substituted or unsubstituted. For example, the alkyl group can be substituted with one, two, three or, in the case of alkyl groups of two carbons or more, four substituents independently selected from the group consisting of: (1) C₁₋₆ alkoxy (e.g., —O-Ak, wherein Ak is optionally substituted C₁₋₆ alkyl); (2) C₁₋₆ alkylsulfinyl (e.g., —S(O)-Ak, wherein Ak is optionally substituted C₁₋₆ alkyl); (3) C₁₋₆ alkylsulfonyl (e.g., —SO₂-Ak, wherein Ak is optionally substituted C₁₋₆ alkyl); (4) amino (e.g., —NR^{N1}R^{N2}, where each of R^{N1} and R^{N2} is, independently, H or optionally substituted alkyl, or R^{N1} and R^{N2}, taken together with the nitrogen atom to which each are attached, form a heterocyclyl group); (5) aryl; (6) arylalkoxy (e.g., —O-L-Ar, wherein L is a bivalent form of optionally substituted alkyl and Ar is optionally substituted aryl); (7) aryloyl (e.g., —C(O)—Ar, wherein Ar is optionally substituted aryl); (8) azido (e.g., —N═N—); (9) cyano (e.g., —CN); (10) carboxyaldehyde (e.g., —C(O)H); (11) C₃₋₈ cycloalkyl (e.g., a monovalent saturated or unsaturated non-aromatic cyclic C₃₋₈ hydrocarbon group); (12) halo (e.g., F, Cl, Br, or I); (13) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (14) heterocyclyloxy (e.g., —O-Het, wherein Het is heterocyclyl, as described herein); (15) heterocyclyloyl (e.g., —C(O)—Het, wherein Het is heterocyclyl, as described herein); (16) hydroxyl (e.g., —OH); (17) N-protected amino; (18) nitro (e.g., —NO₂); (19) oxo (e.g., ═O); (20) C₃₋₈ spirocyclyl (e.g., an alkylene or heteroalkylene diradical, both ends of which are bonded to the same carbon atom of the parent group); (21) C₁₋₆ thioalkoxy (e.g., —S-Ak, wherein Ak is optionally substituted C₁₋₆ alkyl); (22) thiol (e.g., —SH); (23) —CO₂R^{A}, where R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (24) —C(O)NR^{B}R^{C}, where each of R^{B} and R^{C} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (25) —SO₂R^{D}, where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl group and Ar is optionally substituted aryl); (26) —SO₂NR^{E}R^{F}, where each of R^{E} and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); and (27) —NR^{G}R^{H}, where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., L-Ar, wherein L is a bivalent form of optionally substituted alkyl group and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl group and Cy is optionally substituted cycloalkyl, as described herein), wherein in one embodiment no two groups are bound to the nitrogen atom through a carbonyl group or a sulfonyl group. The alkyl group can be a primary, secondary, or tertiary alkyl group substituted with one or more substituents (e.g., one or more halo or alkoxy). In some embodiments, the unsubstituted alkyl group is a C₁₋₃, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, C₂₋₂₄, C₃₋₆, C₃₋₁₂, C₃₋₁₆, C₃₋₁₈, C₃₋₂₀, C₃₋₂₄, C₄₋₆, C₄₋₁₂, C₄₋₁₆, C₄₋₁₈, C₄₋₂₀, C₄₋₂₄, C₅-6, C₅₋₁₂, C₅₋₁₆, C₅₋₁₈, C₅₋₂₀, C₅₋₂₄, C₆₋₁₂, C₆₋₁₆, C₆₋₁₈, C₆₋₂₀, C₆₋₂₄, C₇₋₁₂, C₇₋₁₆, C₇₋₁₈, C₇₋₂₀, C₇₋₂₄, C₈₋₁₂, C₈₋₁₆, C₈₋₁₈, C₈₋₂₀, C₈₋₂₄, C₉₋₁₂, C₉₋₁₆, C₉₋₁₈, C₉₋₂₀, C₉₋₂₄, C₁₀₋₁₂, C₁₀₋₁₆, C₁₀₋₁₈, C₁₀₋₂₀, or C₁₋₂₄ alkyl group.

By “alkylene” is meant a multivalent (e.g., bivalent) form of an alkyl group, as described herein. Non-limiting alkylene groups include methylene, ethylene, propylene, butylene, etc. In some embodiments, the alkylene group is a C₁₋₃, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. The alkylene group can be branched or unbranched. The alkylene group can also be substituted or unsubstituted. For example, the alkylene group can be substituted with one or more substitution groups, as described herein for alkyl.

By “aralkyl” or “arylalkyl” is meant -Ak-Ar, in which Ak is an optionally substituted alkylene, as defined herein, and Ar is an optionally substituted aryl, as defined herein. The aralkyl group can be substituted or unsubstituted. For example, the aralkyl group can be substituted with one or more substitution groups, as described herein for aryl and/or alkyl. Non-limiting unsubstituted aralkyl groups are of from 7 to 16 carbons (C₇₋₁₆ aralkyl), as well as those having an aryl group with 4 to 18 carbons and an alkylene group with 1 to 6 carbons (i.e., —C₁₋₆ alkylene-C₄₋₁₈ aryl).

By “aryl” is meant a group that contains any carbon-based aromatic group including, but not limited to, phenyl, benzyl, anthracenyl, anthryl, benzocyclobutenyl, benzocyclooctenyl, biphenylyl, chrysenyl, dihydroindenyl, fluoranthenyl, indacenyl, indenyl, naphthyl, phenanthryl, phenoxybenzyl, picenyl, pyrenyl, terphenyl, and the like, including fused benzo-C₄₋₈ cycloalkyl radicals (e.g., as defined herein) such as, for instance, indanyl, tetrahydronaphthyl, fluorenyl, and the like. The term aryl also includes heteroaryl, which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be substituted or unsubstituted. The aryl group can be substituted with one, two, three, four, or five substituents independently selected from the group consisting of: (1) C₁₋₆ alkanoyl (e.g., —C(O)-Ak, wherein Ak is optionally substituted C₁₋₆ alkyl); (2) C₁₋₆ alkyl; (3) C₁₋₆ alkoxy (e.g., —O-Ak, wherein Ak is optionally substituted C₁₋₆ alkyl); (4) C₁₋₆ alkoxy-C₁₋₆ alkyl (e.g., -L-O-Ak, wherein L is a bivalent form of optionally substituted alkyl group and Ak is optionally substituted C₁₋₆ alkyl); (5) C₁₋₆ alkylsulfinyl (e.g., —S(O)-Ak, wherein Ak is optionally substituted C₁₋₆ alkyl); (6) C₁₋₆ alkylsulfinyl-C₁₋₆ alkyl (e.g., -L-S(O)-Ak, wherein L is a bivalent form of optionally substituted alkyl group and Ak is optionally substituted C₁₋₆ alkyl); (7) C₁₋₆ alkylsulfonyl (e.g., —SO₂-Ak, wherein Ak is optionally substituted C₁₋₆ alkyl); (8) C₁₋₆ alkylsulfonyl-C₁₋₆ alkyl (e.g., -L-SO₂-Ak, wherein L is a bivalent form of optionally substituted alkyl group and Ak is optionally substituted C₁₋₆ alkyl); (9) aryl; (10) amino (e.g., —NR^{N1}R^{N2}, where each of R^{N1} and R^{N2} is, independently, H or optionally substituted alkyl, or R^{N1} and R^{N2}, taken together with the nitrogen atom to which each are attached, form a heterocyclyl group); (11) C₁₋₆ aminoalkyl (e.g., an alkyl group, as defined herein, substituted by one or more —NR^{N1}R^{N2} groups, as described herein); (12) heteroaryl (e.g., a subset of heterocyclyl groups (e.g., a 5-, 6- or 7-membered ring, unless otherwise specified, containing one, two, three, or four non-carbon heteroatoms), which are aromatic); (13) (C₄₋₁₈ aryl) C₁₋₆ alkyl (e.g., -L-Ar, wherein L is a bivalent form of optionally substituted alkyl and Ar is optionally substituted aryl); (14) aryloyl (e.g., —C(O)—Ar, wherein Ar is optionally substituted aryl); (15) azido (e.g., —N═N—); (16) cyano (e.g., —CN); (17) C₁₋₆ azidoalkyl (e.g., an alkyl group, as defined herein, substituted by one or more azido groups, as described herein); (18) carboxyaldehyde (e.g., —C(O)H); (19) carboxyaldehyde-C₁₋₆ alkyl (e.g., an alkyl group, as defined herein, substituted by one or more carboxyaldehyde groups, as described herein); (20) C₃₋₈ cycloalkyl (e.g., a monovalent saturated or unsaturated non-aromatic cyclic C₃₋₈ hydrocarbon group); (21) (C₃₋₈ cycloalkyl) C₁₋₆ alkyl (e.g., an alkyl group, as defined herein, substituted by one or more cycloalkyl groups, as described herein); (22) halo (e.g., F, Cl, Br, or I); (23) C₁₋₆ haloalkyl (e.g., an alkyl group, as defined herein, substituted by one or more halo groups, as described herein); (24) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (25) heterocyclyloxy (e.g., —O-Het, wherein Het is heterocyclyl, as described herein); (26) heterocyclyloyl (e.g., —C(O)—Het, wherein Het is heterocyclyl, as described herein); (27) hydroxyl (e.g., —OH); (28) C₁₋₆ hydroxyalkyl (e.g., an alkyl group, as defined herein, substituted by one or more hydroxyl, as described herein); (29) nitro (e.g., —NO₂); (30) C₁₋₆ nitroalkyl (e.g., an alkyl group, as defined herein, substituted by one or more nitro, as described herein); (31) N-protected amino; (32) N-protected amino-C₁₋₆ alkyl (e.g., an alkyl group, as defined herein, substituted by one or more N-protected amino groups); (33) oxo (e.g., ═O); (34) C₁₋₆ thioalkoxy (e.g., —S-Ak, wherein Ak is optionally substituted C₁₋₆ alkyl); (35) thio-C₁₋₆ alkoxy-C₁₋₆ alkyl (e.g., -L-S-Ak, wherein L is a bivalent form of optionally substituted alkyl and Ak is optionally substituted C₁₋₆ alkyl); (36) —(CH₂)ᵣCO₂R^{A}, where r is an integer of from zero to four, and R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (37) —(CH₂)ᵣCONR^{B}R^{C}, where r is an integer of from zero to four and where each R^{B} and R^{C} is independently selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (38) —(CH₂)ᵣSO₂R^{D}, where r is an integer of from zero to four and where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl and Ar is optionally substituted aryl); (39) —(CH₂)ᵣSO₂NR^{E}R^{F}, where r is an integer of from zero to four and where each of R^{E} and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (40) —(CH₂)ᵣNR^{G}R^{H}, where r is an integer of from zero to four and where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., -L-Ar, wherein L is a bivalent form of optionally substituted alkyl and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl and Cy is optionally substituted cycloalkyl, as described herein), wherein in one embodiment no two groups are bound to the nitrogen atom through a carbonyl group or a sulfonyl group; (41) thiol (e.g., —SH); (42) perfluoroalkyl (e.g., an alkyl group having each hydrogen atom substituted with a fluorine atom); (43) perfluoroalkoxy (e.g., —OR^{f}, where R^{f} is an alkyl group having each hydrogen atom substituted with a fluorine atom); (44) aryloxy (e.g., —OAr, where Ar is optionally substituted aryl); (45) cycloalkoxy (e.g., —O-Cy, wherein Cy is optionally substituted cycloalkyl, as described herein); (46) cycloalkylalkoxy (e.g., —O-L-Cy, wherein L is a bivalent form of optionally substituted alkyl and Cy is optionally substituted cycloalkyl, as described herein); and (47) arylalkoxy (e.g., —O-L-Ar, wherein L is a bivalent form of optionally substituted alkyl and Ar is optionally substituted aryl). In particular embodiments, an unsubstituted aryl group is a C₄₋₁₈, C₄₋₁₄, C₄₋₁₂, C₄₋₁₀, C₆₋₁₈, C₆₋₁₄, C₆₋₁₂, or C₆₋₁₀ aryl group.

By “arylene” is meant a multivalent (e.g., bivalent) form of an aryl group, as described herein. Non-limiting arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. The arylene group can be branched or unbranched. The arylene group can also be substituted or unsubstituted. For example, the arylene group can be substituted with one or more substitution groups, as described herein for aryl.

By “aryloxy” is meant —OR, where R is an optionally substituted aryl group, as described herein. In some embodiments, an unsubstituted aryloxy group is a C₄_is or C₆₋₁₈ aryloxy group.

By “aryloyl” is meant —C(O)—R, where R is an optionally substituted aryl group, as described herein. In some embodiments, an unsubstituted aryloyl group is a C₇₋₁₁ aryloyl or C₅₋₁₉ aryloyl group.

By “carbonyl” is meant a —C(O)— group, which can also be represented as >C═O.

By “halo” is meant F, Cl, Br, or I.

By “haloalkyl” is meant an alkyl group, as defined herein, substituted with one or more halo.

By “heterocyclyl” is meant a 3-, 4-, 5-, 6- or 7-membered ring (e.g., a 5-, 6-, or 7-membered ring), unless otherwise specified, containing one, two, three, or four non-carbon heteroatoms (e.g., independently selected from the group consisting of nitrogen, oxygen, phosphorous, sulfur, selenium, or halo). The 3-membered ring has zero to one double bonds, the 4- and 5-membered ring has zero to two double bonds, and the 6- and 7-membered rings have zero to three double bonds. The term “heterocyclyl” also includes bicyclic, tricyclic and tetracyclic groups in which any of the above heterocyclic rings is fused to one, two, or three rings independently selected from the group consisting of an aryl ring, a cyclohexane ring, a cyclohexene ring, a cyclopentane ring, a cyclopentene ring, and another monocyclic heterocyclic ring, such as indolyl, quinolyl, isoquinolyl, tetrahydroquinolyl, benzofuryl, benzothienyl and the like. Heterocyclics include acridinyl, adenyl, alloxazinyl, azaadamantanyl, azabenzimidazolyl, azabicyclononyl, azacycloheptyl, azacyclooctyl, azacyclononyl, azahypoxanthinyl, azaindazolyl, azaindolyl, azecinyl, azepanyl, azepinyl, azetidinyl, azetyl, aziridinyl, azirinyl, azocanyl, azocinyl, azonanyl, benzimidazolyl, benzisothiazolyl, benzisoxazolyl, benzodiazepinyl, benzodiazocinyl, benzodihydrofuryl, benzodioxepinyl, benzodioxinyl, benzodioxanyl, benzodioxocinyl, benzodioxolyl, benzodithiepinyl, benzodithiinyl, benzodioxocinyl, benzofuranyl, benzophenazinyl, benzopyranonyl, benzopyranyl, benzopyrenyl, benzopyronyl, benzoquinolinyl, benzoquinolizinyl, benzothiadiazepinyl, benzothiadiazolyl, benzothiazepinyl, benzothiazocinyl, benzothiazolyl, benzothienyl, benzothiophenyl, benzothiazinonyl, benzothiazinyl, benzothiopyranyl, benzothiopyronyl, benzotriazepinyl, benzotriazinonyl, benzotriazinyl, benzotriazolyl, benzoxathiinyl, benzotrioxepinyl, benzoxadiazepinyl, benzoxathiazepinyl, benzoxathiepinyl, benzoxathiocinyl, benzoxazepinyl, benzoxazinyl, benzoxazocinyl, benzoxazolinonyl, benzoxazolinyl, benzoxazolyl, benzylsultamyl benzylsultimyl, bipyrazinyl, bipyridinyl, carbazolyl (e.g., 4H-carbazolyl), carbolinyl (e.g., O-carbolinyl), chromanonyl, chromanyl, chromenyl, cinnolinyl, coumarinyl, cytdinyl, cytosinyl, decahydroisoquinolinyl, decahydroquinolinyl, diazabicyclooctyl, diazetyl, diaziridinethionyl, diaziridinonyl, diaziridinyl, diazirinyl, dibenzisoquinolinyl, dibenzoacridinyl, dibenzocarbazolyl, dibenzofuranyl, dibenzophenazinyl, dibenzopyranonyl, dibenzopyronyl (xanthonyl), dibenzoquinoxalinyl, dibenzothiazepinyl, dibenzothiepinyl, dibenzothiophenyl, dibenzoxepinyl, dihydroazepinyl, dihydroazetyl, dihydrofuranyl, dihydrofuryl, dihydroisoquinolinyl, dihydropyranyl, dihydropyridinyl, dihydroypyridyl, dihydroquinolinyl, dihydrothienyl, dihydroindolyl, dioxanyl, dioxazinyl, dioxindolyl, dioxiranyl, dioxenyl, dioxinyl, dioxobenzofuranyl, dioxolyl, dioxotetrahydrofuranyl, dioxothiomorpholinyl, dithianyl, dithiazolyl, dithienyl, dithiinyl, furanyl, furazanyl, furoyl, furyl, guaninyl, homopiperazinyl, homopiperidinyl, hypoxanthinyl, hydantoinyl, imidazolidinyl, imidazolinyl, imidazolyl, indazolyl (e.g., 1H-indazolyl), indolenyl, indolinyl, indolizinyl, indolyl (e.g., 1H-indolyl or 3H-indolyl), isatinyl, isatyl, isobenzofuranyl, isochromanyl, isochromenyl, isoindazoyl, isoindolinyl, isoindolyl, isopyrazolonyl, isopyrazolyl, isoxazolidiniyl, isoxazolyl, isoquinolinyl, isoquinolinyl, isothiazolidinyl, isothiazolyl, morpholinyl, naphthindazolyl, naphthindolyl, naphthiridinyl, naphthopyranyl, naphthothiazolyl, naphthothioxolyl, naphthotriazolyl, naphthoxindolyl, naphthyridinyl, octahydroisoquinolinyl, oxabicycloheptyl, oxauracil, oxadiazolyl, oxazinyl, oxaziridinyl, oxazolidinyl, oxazolidonyl, oxazolinyl, oxazolonyl, oxazolyl, oxepanyl, oxetanonyl, oxetanyl, oxetyl, oxtenayl, oxindolyl, oxiranyl, oxobenzoisothiazolyl, oxochromenyl, oxoisoquinolinyl, oxoquinolinyl, oxothiolanyl, phenanthridinyl, phenanthrolinyl, phenazinyl, phenothiazinyl, phenothienyl (benzothiofuranyl), phenoxathiinyl, phenoxazinyl, phthalazinyl, phthalazonyl, phthalidyl, phthalimidinyl, piperazinyl, piperidinyl, piperidonyl (e.g., 4-piperidonyl), pteridinyl, purinyl, pyranyl, pyrazinyl, pyrazolidinyl, pyrazolinyl, pyrazolopyrimidinyl, pyrazolyl, pyridazinyl, pyridinyl, pyridopyrazinyl, pyridopyrimidinyl, pyridyl, pyrimidinyl, pyrimidyl, pyronyl, pyrrolidinyl, pyrrolidonyl (e.g., 2-pyrrolidonyl), pyrrolinyl, pyrrolizidinyl, pyrrolyl (e.g., 2H-pyrrolyl), quinazolinyl, quinolinyl, quinolizinyl (e.g., 4H-quinolizinyl), quinoxalinyl, quinuclidinyl, selenazinyl, selenazolyl, selenophenyl, succinimidyl, sulfolanyl, tetrahydrofuranyl, tetrahydrofuryl, tetrahydroisoquinolinyl, tetrahydroisoquinolyl, tetrahydropyridinyl, tetrahydropyridyl (piperidyl), tetrahydropyranyl, tetrahydropyronyl, tetrahydroquinolinyl, tetrahydroquinolyl, tetrahydrothienyl, tetrahydrothiophenyl, tetrazinyl, tetrazolyl, thiadiazinyl (e.g., 6H-1,2,5-thiadiazinyl or 2H,6H-1,5,2-dithiazinyl), thiadiazolyl, thianthrenyl, thianyl, thianaphthenyl, thiazepinyl, thiazinyl, thiazolidinedionyl, thiazolidinyl, thiazolyl, thienyl, thiepanyl, thiepinyl, thietanyl, thietyl, thiiranyl, thiocanyl, thiochromanonyl, thiochromanyl, thiochromenyl, thiodiazinyl, thiodiazolyl, thioindoxyl, thiomorpholinyl, thiophenyl, thiopyranyl, thiopyronyl, thiotriazolyl, thiourazolyl, thioxanyl, thioxolyl, thymidinyl, thyminyl, triazinyl, triazolyl, trithianyl, urazinyl, urazolyl, uretidinyl, uretinyl, uricyl, uridinyl, xanthenyl, xanthinyl, xanthionyl, and the like, as well as modified forms thereof (e.g., including one or more oxo and/or amino), and salts thereof. The heterocyclyl group can be substituted or unsubstituted. For example, the heterocyclyl group can be substituted with one or more substitution groups, as described herein for aryl.

By “heterocyclyloyl” is meant a heterocyclyl group, as defined herein, attached to the parent molecular group through a carbonyl group.

By “salt” is meant an ionic form of a compound or structure (e.g., any formulas, compounds, or compositions described herein), which includes a cation or anion compound to form an electrically neutral compound or structure. Salts are well known in the art. For example, non-toxic salts are described in Berge S M et al., “Pharmaceutical salts,” J. Pharm. Sci. 1977 January; 66(1):1-19; and in “Handbook of Pharmaceutical Salts: Properties, Selection, and Use,” Wiley-VCH, April 2011 (2nd rev. ed., eds. P. H. Stahl and C. G. Wermuth. The salts can be prepared in situ during the final isolation and purification of the compounds of the disclosure or separately by reacting the free base group with a suitable organic acid (thereby producing an anionic salt) or by reacting the acid group with a suitable metal or organic salt (thereby producing a cationic salt). Representative anionic salts include acetate, adipate, alginate, ascorbate, aspartate, benzenesulfonate, benzoate, bicarbonate, bisulfate, bitartrate, borate, bromide, butyrate, camphorate, camphorsulfonate, chloride, citrate, cyclopentanepropionate, digluconate, dihydrochloride, diphosphate, dodecylsulfate, edetate, ethanesulfonate, fumarate, glucoheptonate, gluconate, glutamate, glycerophosphate, hemisulfate, heptonate, hexanoate, hydrobromide, hydrochloride, hydroiodide, hydroxyethanesulfonate, hydroxynaphthoate, iodide, lactate, lactobionate, laurate, lauryl sulfate, malate, maleate, malonate, mandelate, mesylate, methanesulfonate, methylbromide, methylnitrate, methylsulfate, mucate, 2-naphthalenesulfonate, nicotinate, nitrate, oleate, oxalate, palmitate, pamoate, pectinate, persulfate, 3-phenylpropionate, phosphate, picrate, pivalate, polygalacturonate, propionate, salicylate, stearate, subacetate, succinate, sulfate, tannate, tartrate, theophyllinate, thiocyanate, triethiodide, toluenesulfonate, undecanoate, valerate salts, and the like. Representative cationic salts include metal salts, such as alkali or alkaline earth salts, e.g., barium, calcium (e.g., calcium edetate), lithium, magnesium, potassium, sodium, and the like; other metal salts, such as aluminum, bismuth, iron, and zinc; as well as nontoxic ammonium, quaternary ammonium, and amine cations, including, but not limited to ammonium, tetramethylammonium, tetraethylammonium, methylamine, dimethylamine, trimethylamine, triethylamine, ethylamine, pyridinium, and the like. Other cationic salts include organic salts, such as chloroprocaine, choline, dibenzylethylenediamine, diethanolamine, ethylenediamine, methylglucamine, and procaine. Yet other salts include ammonium, sulfonium, sulfoxonium, phosphonium, iminium, imidazolium, benzimidazolium, amidinium, guanidinium, phosphazinium, phosphazenium, pyridinium, etc., as well as other cationic groups described herein (e.g., optionally substituted isoxazolium, optionally substituted oxazolium, optionally substituted thiazolium, optionally substituted pyrrolium, optionally substituted furanium, optionally substituted thiophenium, optionally substituted imidazolium, optionally substituted pyrazolium, optionally substituted isothiazolium, optionally substituted triazolium, optionally substituted tetrazolium, optionally substituted furazanium, optionally substituted pyridinium, optionally substituted pyrimidinium, optionally substituted pyrazinium, optionally substituted triazinium, optionally substituted tetrazinium, optionally substituted pyridazinium, optionally substituted oxazinium, optionally substituted pyrrolidinium, optionally substituted pyrazolidinium, optionally substituted imidazolinium, optionally substituted isoxazolidinium, optionally substituted oxazolidinium, optionally substituted piperazinium, optionally substituted piperidinium, optionally substituted morpholinium, optionally substituted azepanium, optionally substituted azepinium, optionally substituted indolium, optionally substituted isoindolium, optionally substituted indolizinium, optionally substituted indazolium, optionally substituted benzimidazolium, optionally substituted isoquinolinum, optionally substituted quinolizinium, optionally substituted dehydroquinolizinium, optionally substituted quinolinium, optionally substituted isoindolinium, optionally substituted benzimidazolinium, and optionally substituted purinium).

The term “optical isomer” or “a stereoisomer” refers to any of the various stereoisomeric configurations that may exist for a given compound of the present invention and includes geometric isomers. It is understood that a substituent may be attached at a chiral center of a carbon atom. The term “chiral” refers to molecules which have the property of non-superimposability on their mirror image partner, while the term “achiral” refers to molecules which are superimposable on their mirror image partner. Therefore, the disclosure includes enantiomers, diastereomers or racemates of the compound. “Enantiomers” are a pair of stereoisomers that are non-superimposable mirror images of each other. A 1:1 mixture of a pair of enantiomers is a “racemic” mixture. The term is used to designate a racemic mixture where appropriate. “Diastereomers” are stereoisomers that have at least two asymmetric atoms, but which are not mirror-images of each other. The absolute stereochemistry can be specified according to the Cahn-Ingold-Prelog R-S system.

By “attaching,” “attachment,” or related word forms is meant any covalent or non-covalent bonding interaction between two components. Non-covalent bonding interactions include, without limitation, hydrogen bonding, ionic interactions, halogen bonding, electrostatic interactions, π bond interactions, hydrophobic interactions, inclusion complexes, clathration, van der Waals interactions, and combinations thereof.

As used herein, the term “about” means+/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

### BRIEF DESCRIPTION OF THE DRAWINGS

FIG. 1A-1B illustrates (A) liquid crystal molecules as ellipsoids, ordered more or less parallel in one direction in a nematic liquid and (B) three independent modes of distortion in nematic liquid crystals each with its own unique elastic constant.

FIG. 2A-2B illustrates (A) selective reflection spectra from a planar cholesteric liquid crystal structure, showing a progressively deteriorated efficiency and sharpness of the band edge with the increase of applied electric field; and (B) a planar structure of a cholesteric liquid crystal, showing a Bragg-type reflection for one color only.

FIG. 3 depicts the constituents for an illustrative nematic mixture E7.

FIG. 4A-4B show pitch measurement of a 1 wt. % CD29+E7 formulation using the circular Cano wedge method. Provided are (A) a polarizing optical microscopy (POM) image of the material and (B) a graph showing the number of circular disinclination lines versus their radius.

FIG. 5 shows pitch versus concentration data and helical twisting power (HTP) determination for scaled-up synthesis of CD29 in a CD29+E7 formulation.

FIG. 6A-6C shows characterization of a 10 wt. % CD13+E7 formulation. Provided are (A) optical images at 2.5× magnification taken ten days after the start of the test; and (B,C) absorption spectra (in the visible range) of the formulation (B) at the start of testing and (C) ten days later.

FIG. 7A-7C shows characterization of an 8 wt. % CD46+E7 formulation. Provided are (A) optical images at 5× magnification taken ten days after the start of the test; (B) a transmission spectrum of the formulation at the start of testing; and (C) an absorption spectrum of the formulation ten days later.

FIG. 8A-8C shows characterization of a 10 wt. % CD46+E7 formulation. Provided are (A) optical images at 10× magnification taken ten days after the start of the test; (B) a transmission spectrum of the formulation at the start of testing; and (C) an absorption spectrum of the formulation ten days later.

FIG. 9A-9B shows characterization of a CD46+E7 formulation. Provided are (A) an optical image showing defects in chiral LC constrained between a planar substrate and a convex lens (at 10× magnification); and (B) a graph showing inverse pitch versus concentration dependence for the formulation.

FIG. 10A-10B shows characterization of a CD47+E7 formulation. Provided are optical images showing (A) polarizing microscope textures and (B) pitch for the formulation with different dopant concentrations.

FIG. 11 shows characterization of a CD48+E7 formulation. Provided are optical images showing polarizing microscope textures for the formulation with different dopant concentrations.

FIG. 12A-12B shows characterization of a 5 wt. % CD13+5 wt. % CD29+MAT 12-978 formulation. Provided are absorption spectra of the formulation (A) at the start of testing and (B) ten days later.

FIG. 13A-13B shows characterization of a 5 wt. % CD29+5 wt. % CD46+E7 formulation. Provided are transmission spectra of the formulation (A) at the start of testing and (B) twenty days later.

FIG. 14A-14C shows characterization of a 5 wt. % CD13+5 wt. % CD29+E7 formulation. Provided are (A) optical images at 2.5× magnification taken ten days after the start of the test; and (B,C) transmission spectra of the formulation (B) at the start of testing and (C) ten days later.

FIG. 15A-15B shows pitch in a 5 wt. % CD29+E7 formulation (A) before or (B) after 15 hours of UVA-340 exposure.

FIG. 16A-16B shows transmission spectra in a 5 wt. % CD29+5 wt. % CD46+E7 formulation before (black) or after (gray) 24 hours of UVA-340 exposure. Provided are (A) the original spectrum and (B) the scaled amplitude spectrum.

FIG. 17 shows transmission spectra of a 5 wt. % CD29+5 wt. % CD46+E7 formulation before (black) and after (gray) thermocycling for 24 hours.

FIG. 18 shows transmitted intensity as function of applied voltage, in which data are provided for three different days. The material is 5 wt. % CD29+E7; the steepest slope of the curve indicates the critical voltage.

FIG. 19 shows the transmitted intensity as function of voltage before (black) and after (gray) thermocycling, in which there appears to be no significant change in the critical voltage.

FIG. 20A-20C shows characterization of an 8 wt. % CD46+E7 formulation. Provided are optical images at 5× magnification (left) and transmission spectrum of the formulation (A) at the start of testing, (B) ten days later, and (C) more than seven months later.

FIG. 21A-21B shows characterization of a 5 wt. % CD29+5 wt. % CD46+E7 formulation. Provided are optical images at 5× magnification (left) and transmission spectrum of the formulation (A) at the start of testing or (B) more than seven months later.

### DETAILED DESCRIPTION

The present disclosure relates to stable formulations including one or more chiral dopants in various hosts. In particular embodiments, enhanced stability was observed by including smaller percentages of different dopants rather than using mono-dopant formulations. Illustrative enhanced stability metrics can include enhanced thermal cycling stability, enhanced phase stability, enhanced voltage cycling stability, long term phase stability (e.g., for over 6 months, 7 months, or more), UV stability, among others (e.g., described herein). In another embodiment, enhanced stability was observed by dopants having extended aliphatic groups (e.g., linear or branched C₃₋₁₂ alkyl groups), as compared to those lacking such aliphatic groups.

In use, the dopant(s) act as a twist agent. When combined with a host, the resultant material forms a twisted cholesteric structure in a self-assembled layer, which can then act as an interference filter. Light can be regarded as being composed of right- and left-handed circularly polarized modes, where the electric field of light rotates in space clockwise and counterclockwise. The cholesteric structure gives rise to destructive interference of forward-propagating light and constructive interference of backward-propagating light of one handedness, resulting in essentially total reflection of one mode.

In addition, the periodicity of cholesteric structure provides a material that behaves like a perfect mirror in a selected range of wavelengths—the photonic bandgap. The location and the width of the bandgap can be determined by the refractive indices of the nematic host and the pitch of the cholesteric structure. The contrast can be determined by the film or layer thickness. Furthermore, an applied field can modify the underlying liquid crystal structure, thereby providing a material in which the bandgap location and bandwidth can be tuned. Such optical and physical properties can depend on the stability of the liquid crystalline material.

Accordingly, also described herein are methodologies for mitigating crystallization or phase segregation instabilities within such liquid crystalline materials. Illustrative methodologies include using a robust mixing protocol to provide uniform mixtures and formulations; enhancing solubility of a single dopant by chemical modification or derivatization (e.g., including aryl groups and/or longer alkyl groups); and developing multicomponent formulations including a host and two or more dopants. These methodologies can be used alone in combination. In one non-limiting instance, the methodologies provide a ternary formulation having a first dopant, a second dopant that is different than the first dopant, and a host.

Additional details follow.

Dopants

The present disclosure relates to the use of one or more chiral dopants. In particular embodiments, the dopant is derived from a biomolecule (e.g., a molecule produced by biology, such as an organism). Without wishing to be limited by mechanism, biomolecules are generally enantiomerically pure chiral compounds. If chemistry with such biomolecules is controlled to retain stereochemistry, then the resultant dopants can also be of high optical purity. Thus, biomolecules are excellent candidates as twist agents for application in cholesteric liquid crystal technology.

In some embodiments, the chiral dopant (or precursor thereof) is obtained from a bioreachable source that employs engineered microbes to overexpress desired biomolecules (e.g., through fermentation). In some embodiments, the dopant is derived from betulin or glycyrrhetinic acid (e.g., 18α glycyrrhetinic acid or 180 glycyrrhetinic acid, such as 3β,18β glycyrrhetinic acid). In certain embodiments, salts are avoided in the formulation when used with otherwise non-ionic hosts or liquid crystal media. As described herein, one, two, three, four, or more dopants can be included within a mixture or formulation.

Such biomolecules may be further modified or derivatized, e.g., as described herein. Such derivatization can include, e.g., modification of polar functional groups in the original biotarget materials to enhance physically compatibility (e.g., miscibility or solubility) with the host nematic materials (e.g., enhancing their interaction with the nematic components instead of themselves); enhancement of chemical stability, e.g., by including one or more aryl, alkaryl, or aralkyl groups; or enhancement of solubility, e.g., within a host, such as by including one or more extended alkyl moieties.

Chemical modification can result in ethers or esters having small or large moieties of a saturated aliphatic, unsaturated aliphatic, saturated alicyclic, unsaturated alicyclic, aromatic, or a combination thereof. Likewise, hydroxyl groups or keto groups can be converted into amines or imines by ways of substitution reactions or conjugation reactions followed by reduction. Acids can be converted into amides.

Further modifications include oxidation or reduction reactions. For example, a primary alcohol can be converted into an aldehyde or carboxylic acid group, or a secondary alcohol can be converted into a keto group. As for reduction, a carboxy group can be converted into a C—OH group or ether group; a carbon-carbon double bond can be reduced to a single bond.

In one aspect, a chiral dopant (e.g., a first dopant) can include a structure having formula (I), (IA), (IB), or (III):

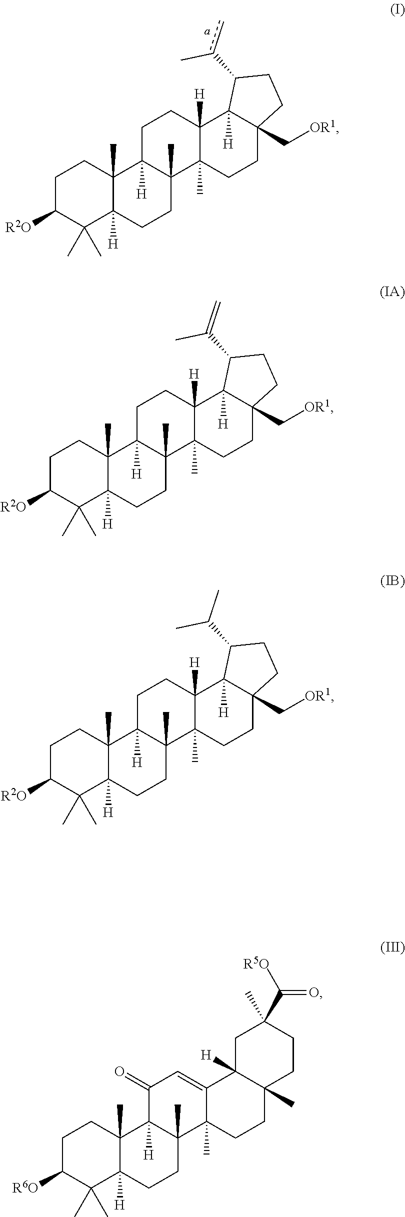

or a salt thereof, wherein each of R¹, R², and R⁶ is, independently, H, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl; R⁵ is H, optionally substituted alkyl, optionally substituted alkenyl, optionally substituted aralkyl, optionally substituted aryl, or optionally substituted alkaryl; and letter “a” represents a pi-bond, in which the pi-bond “a” may be present or absent. In particular embodiments of formulas (I), (IA), or (IB), R¹ and R² are the same. In other embodiments, R¹ and R² are different. In some embodiments of formula (III), R⁵ and R⁶ are the same. In other embodiments, R⁵ and R⁶ are different. In yet other embodiments, at least one R¹, R², R⁵, and R⁶ is not H. In some embodiments, each of R¹, R², R⁵, and R⁶ is not H.

As can be seen, formula (III) includes the hydrogen at C18 that is in a β-conformation, thereby providing a 18β-glycyrrhetinic acid derivative. In other embodiments, formula (III) can include the hydrogen at C18 that is in an α-conformation, thereby providing a 18α-glycyrrhetinic acid derivative.

A formulation of chiral dopants can include a first dopant (e.g., including a structure having formula (I), (IA), (IB), or (III)) in combination with a second dopant including a structure having the formula (II), (IIA), or (IIB):

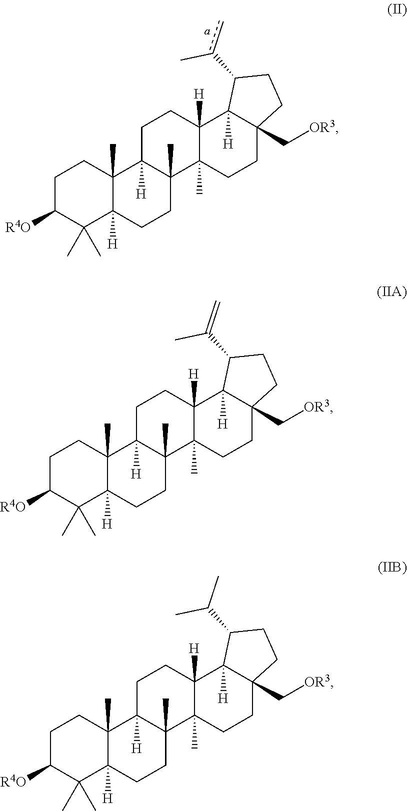

or a salt thereof, wherein each of R³ and R⁴ is, independently, H, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl; and letter “a” represents a pi-bond, in which the pi-bond “a” may be present or absent. In some embodiments of formula (II), R³ and R⁴ are the same. In other embodiments, R³ and R⁴ are different. In yet other embodiments, at least one R¹, R², R³, R⁴, R⁵, and R⁶ is not H. In some embodiments, each of R¹, R², R³, R⁴, R⁵, and R⁶ is not H.

In particular embodiments, the first and second chiral dopants are different. For example and without limitation, R¹ can be different from R³; R² can be different from R⁴; or both of R¹ and R² can be different from R³ and R⁴. In other embodiments, R¹ and R² are the same; R³ and R⁴ are the same; but R¹ and R³ are different. In yet other embodiments, each of R¹, R², R³, and R⁴ can be the same but the pi-bond “a” is present in one of formula (I) and (II) and absent in the other formula.

In some embodiments, the first and second chiral dopants are present in any useful ratio. A representative ratio includes a 1:1 ratio of the first chiral dopant to the second chiral dopant. Yet other illustrative ratios of the first and second chiral dopants include from about 90:10 (w/w) to about 10:90 (w/w) ratio, as well as ratios therebetween (e.g., 90:10 to 20:80, 90:10 to 30:70, 90:10 to 40:60, 90:10 to 50:50, 90:10 to 60:40, 90:10 to 70:30, 90:10 to 80:20, 80:20 to 10:90, 80:20 to 20:80, 80:20 to 30:70, 80:20 to 40:60, 80:20 to 50:50, 80:20 to 60:40, 80:20 to 70:30, 70:30 to 10:90, 70:30 to 20:80, 70:30 to 30:70, 70:30 to 40:60, 70:30 to 50:50, 70:30 to 60:40, 60:40 to 10:90, 60:40 to 20:80, 60:40 to 30:70, 60:40 to 40:60, 60:40 to 50:50, 50:50 to 10:90, 50:50 to 20:80, 50:50 to 30:70, 50:50 to 40:60, 40:60 to 10:90, 40:60 to 20:80, 40:60 to 30:70, 30:70 to 10:90, 30:70 to 20:80, or 20:80 to 10:90). In particular embodiments, the ratio of two or more chiral dopants are determined by compensating for the temperature dependence of the cholesteric pitch and thus the selective reflection wavelength, for example.

In particular embodiments, R¹, R², R³, R⁴, and/or R⁶ includes one of optionally substituted alkyl, aryl, alkaryl, or aralkyl groups that is attached to the parent molecular group through a carbonyl group. In some embodiments, R¹ is —C(O)R^{1a} or —C(O)—Ar—R^{1a}, in which R^{1a} is H, optionally substituted alkyl, optionally substituted haloalkyl, optionally substituted alkenyl, optionally substituted aralkyl, optionally substituted aryl, or optionally substituted alkaryl; and in which Ar is optionally substituted arylene. In other embodiments, R² is —C(O)R^{2a} or —C(O)—Ar—R^{2a}; R³ is —C(O)R^{3a} or —C(O)—Ar—R^{3a}; R⁴ is —C(O)R^{4a} or —C(O)—Ar—R^{4a}; and R⁶ is —C(O)R^{6a} or —C(O)—Ar—R^{6a}; and in which each of R^{2a}, R^{3a}, R^{4a}, and R^{6a} is H, optionally substituted alkyl, optionally substituted haloalkyl, optionally substituted alkenyl, optionally substituted aralkyl, optionally substituted aryl, or optionally substituted alkaryl; and in which Ar is optionally substituted arylene.

In any of formulas (I), (IA), (IB), (II), (IIA), (IIB), and (III), any of R¹, R², R³, R⁴, R⁵, or R⁶ can be selected independently for each occasion from the group consisting of hydrogen, an aliphatic moiety, an aryl moiety, an aryl alkylene (or aralkyl) moiety, an alkyl arylene (or alkaryl) moiety, an alkanoyl moiety, an arylalkanoyl (or aralkanoyl) moiety, and any halogenated derivative of the foregoing moieties.

In any of formulas (I), (IA), (IB), (II), (IIA), (IIB), and (III), any of R¹, R², R³, R⁴, R⁵, or R⁶ can be selected independently for each occasion from the group consisting of hydrogen, a methyl, an ethyl, a propyl, a butyl, a pentyl, a hexyl, a heptyl, an octyl, a nonyl, a decyl, a phenyl, a benzyl, a p-tolyl, a p-halophenyl, a p-biphenyl, a p-(4-halophenyl)phenylene, a p-(4-cyanophenyl) phenylene, an o-biphenyl, a 3,5-dimethoxyphenyl, an acetyl, a propionyl, a butanoyl, a pentanoyl, a hexanoyl, a heptanoyl, an octanoyl, a nonanoyl, a decanoyl, an undecanoyl, a dodecanoyl, a 1-naphthyl, and a 2-naphthyl.

Further non-limiting dopants are provided in Table 1.

TABLE 1
Non-limiting dopants

| | | Melting |
|---|---|---|
| Compound | | point/phase |
| No. | Structure | Transition [° C.] |
| PN02063 CD13 | 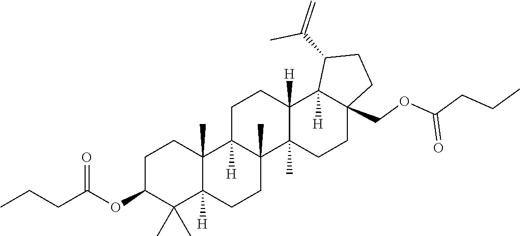 | 102-104 |
| PN02075 CD29 | 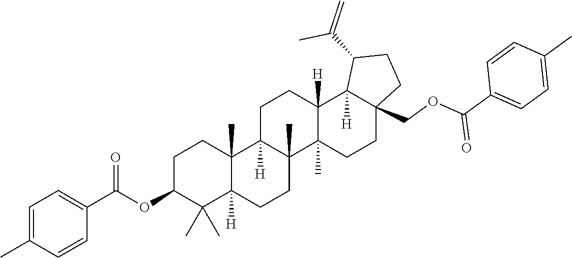 | 207-209 |
| PN02082 (reduced form of CD29) | 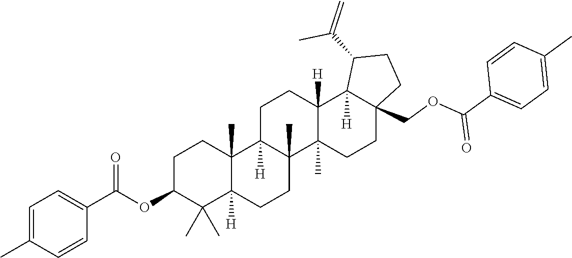 | 210.5 |
| PN02087 CD46 | 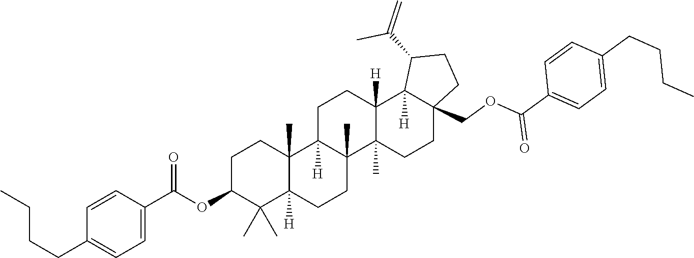 | 164.8 |
| PN02088 CD47 | 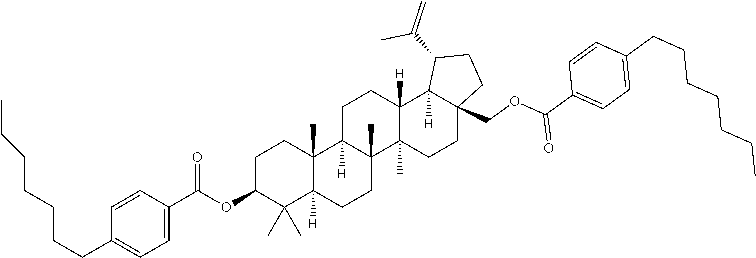 | liquid |
| PN02089 | 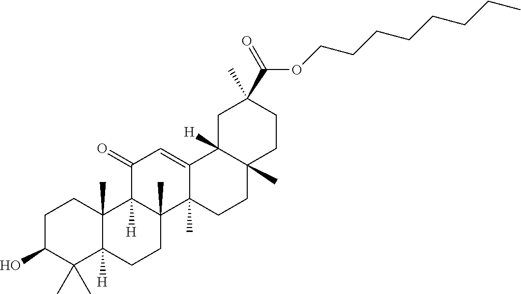 | 92.5 |
| PN02090 | 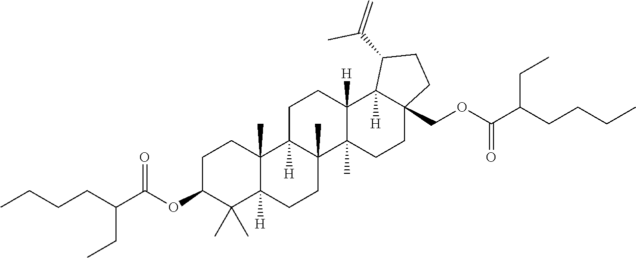 | liquid |
| PN02094 | 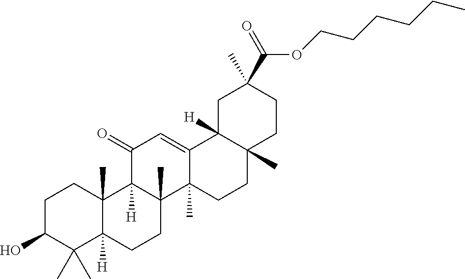 | 98.2 |
| PN02095 | 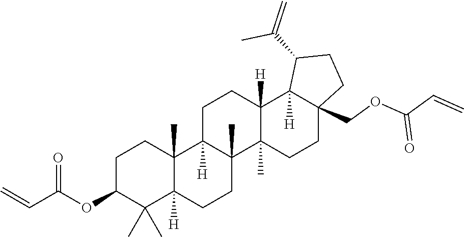 | |

The dopants herein can be prepared by processes analogous to those established in the art, for example, by the reaction sequences shown in Scheme 1 and Scheme 2.

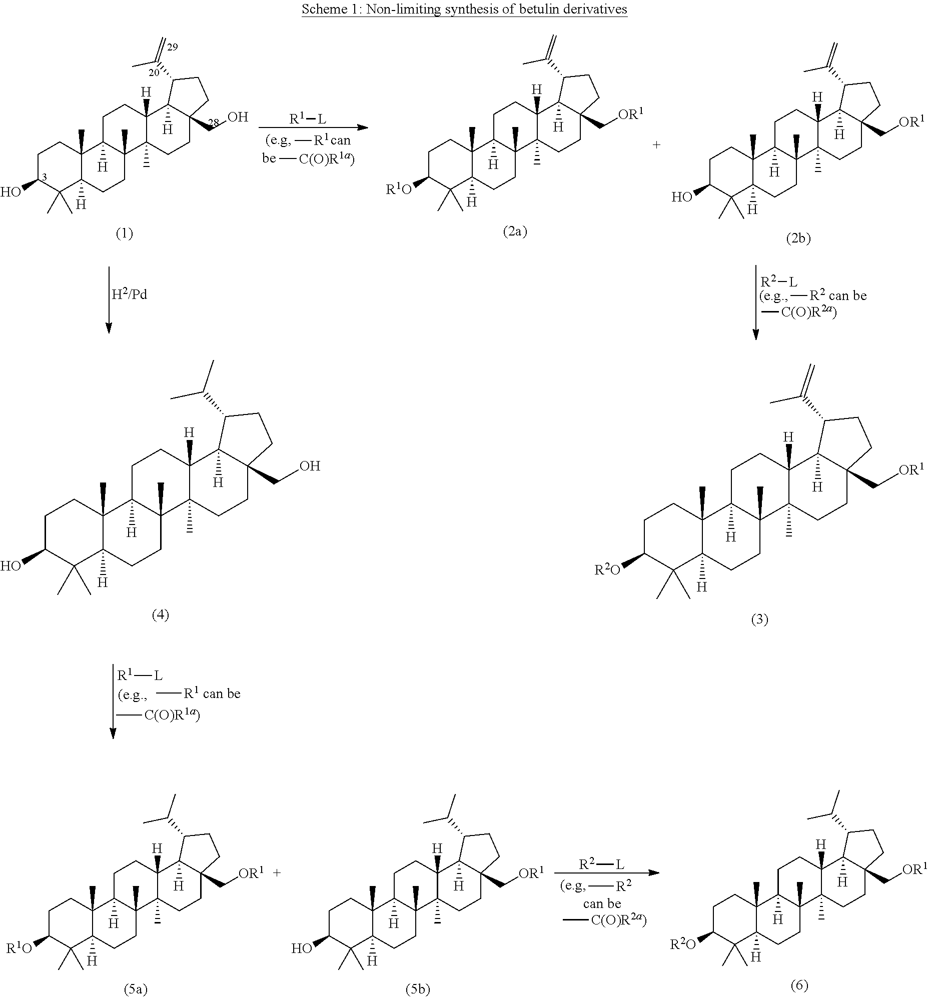

As seen in Scheme 1, a betulin compound (1) can be provided. In non-limiting instances, betulin is provided from a biological resource as a highly optically pure compound. Betulin can be provided in any useful stereoisomer.

Compounds 2a, 2b can be provided under standard etherification or esterification conditions by treating compound 1 with a compound (e.g. a derivatizing agent) of formula R¹-L or R^{1a}—C(O)-L, in which R¹ and R^{1a} can be any described herein and L is a leaving group, such as chloro, bromo, iodo, sulfonate (e.g., mesylate, tosylate, or triflate), or carboxylate (e.g., —OC(O)—R^{1a}, in which R^{1a} is any described herein). Based on experimental conditions, compounds 2a and/or 2b can be formed in this reaction. Whereas both hydroxyl moieties at C₃ and C₂₈ are modified in compound 2a, only the hydroxyl moiety at C₂₈ is modified in compound 2b. In some instances, the hydroxyl group at C₃ can be further modified by treating compound 2b with a compound (e.g. a derivatizing agent) of formula R²-L or R^{2a}—C(O)-L, thereby providing compound 3. R² and R^{2a} can be any described herein; and L is a leaving group, such as chloro, bromo, iodo, sulfonate (e.g., mesylate, tosylate, or triflate), or carboxylate (e.g., —OC(O)—R^{1a} or —OC(O)—R^{2a}, in which R^{1a} and R^{2a} are any described herein).

Conditions to provide compounds 2a, 2b may include heating compound 1 and R¹-L with or without a solvent, preferably with a suitable solvent such as THF, optionally in the presence of a suitable base, such as potassium carbonate, sodium carbonate, potassium hydride, or sodium hydride. Other conditions to provide compounds 2a, 2b may include heating compound 1 and R^{1a}—C(O)-L with or without a solvent, preferably with a suitable solvent such as DCM, optionally in the presence of a suitable base, such as pyridine or DMAP.

Similarly, these conditions can be applied to provide compound 3, which may include heating compound 2b and R²-L with or without a solvent (e.g., THF) and optionally in the presence of a suitable base (e.g., any herein). Other conditions to provide compound 3 may include heating a compound of formula 2b and R^{2a}—C(O)-L with or without a solvent (e.g., any herein) and optionally in the presence of a suitable base (e.g., any herein).

Betulin (1) can be further treated prior to derivatization. For instance, betulin (1) can be treated under standard reduction conditions to provide, e.g., dihydrobetulin (4) with a single bond between C20 and C29. Illustrative reduction conditions can include use of hydrogen in the presence of nickel, platinum, or palladium. In another instance, betulin (1) can be treated under standard oxidation conditions to provide, e.g., betulone having a carbonyl at C3. Illustrative oxidation conditions can include use of pyridinium chlorochromate or Jones reagent. Such compounds can then be further derivatized (e.g., similar to conditions provided above with respect to compounds 2a, 2b).

Compound 5a and/or 5b can be provided under standard etherification or esterification conditions by treating compound 4 with a compound (e.g. a derivatizing agent) of formula R¹-L or R^{1a}—C(O)-L, as described herein. Reaction conditions may include heating compound 4 with R¹-L or R^{1a}—C(O)-L with or without a solvent (e.g., any herein), optionally in the presence of a suitable base (e.g., any herein). Compound 5b, if present, can be heated in the presence of R²-L or R^{2a}—C(O)-L (e.g. a derivatizing agent), either with or without a solvent (e.g., any herein), and optionally in the presence of a suitable base (e.g., any herein) to provide compound 6.

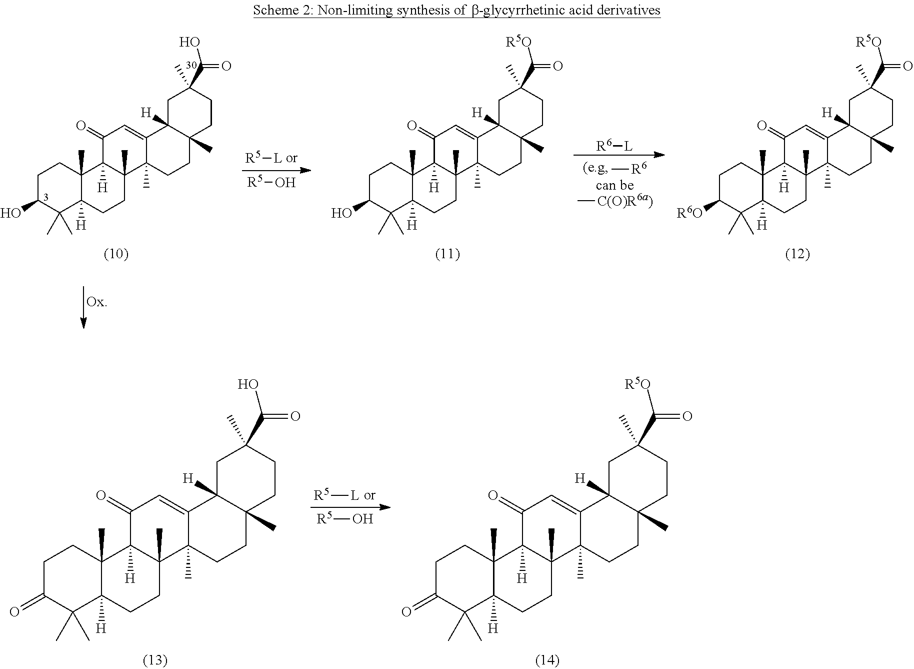

As seen in Scheme 2, an 18β-glycyrrhetinic acid compound (10) can be provided. In non-limiting instances, glycyrrhetinic acid is provided from a biological resource as a highly optically pure compound. Glycyrrhetinic acid can be provided in any useful stereoisomer, such as 18α-glycyrrhetinic acid and 18β-glycyrrhetinic acid in which the hydrogen at C18 is in the a or R conformation, respectively. In particular embodiments, glycyrrhetinic acid is 18β-glycyrrhetinic acid.

Compound 11 can be provided under standard esterification conditions by treating compound 10 with a compound (e.g. a derivatizing agent) of formula R⁵-L or R⁵—OH, in which R⁵ can be any described herein and L is a leaving group, such as chloro, bromo, iodo, sulfonate (e.g., mesylate, tosylate, or triflate), or carboxylate). Conditions to provide compound 11 can include optional use of a solvent (e.g., DMF) in the presence of a suitable agent (e.g., a base, such as potassium carbonate, sodium carbonate, potassium hydride, or sodium hydride; a coupling reagent, such as N,N′-dicyclohexylcarbodiimide; or an acid, such as sulfuric acid).

Compound 12 can be provided under standard etherification or esterification conditions by treating compound 11 with a compound (e.g. a derivatizing agent) of formula R⁶-L or R^{6a}—C(O)-L, in which R⁶ and R^{6a} can be any described herein and L is a leaving group, such as chloro, bromo, iodo, sulfonate (e.g., mesylate, tosylate, or triflate), or carboxylate (e.g., —OC(O)—R^{6a}, as described herein). Conditions to provide compound 12 can include use of a solvent (e.g., THF or DCM), and optionally in the presence of a suitable base (e.g., potassium carbonate, sodium carbonate, potassium hydride, sodium hydride, pyridine, DMAP, etc.).

Glycyrrhetinic acid (10) can be further treated prior to derivatization. For instance, glycyrrhetinic acid (10) can be treated under standard oxidation conditions to provide, e.g., compound 13 having a carbonyl at C3. Illustrative oxidation conditions can include use of pyridinium chlorochromate or Jones reagent. Compound 13 can be further derivatized under standard esterification conditions to provide compound 14 by treating with a compound of formula R⁵-L or R⁵—OH, in which R⁵ can be any described herein and L can be any leaving group described herein. Reaction conditions to provide compound 14 can include optional use of a solvent (e.g., DMF) in the presence of a suitable agent (e.g., a base, such as potassium carbonate, sodium carbonate, potassium hydride, or sodium hydride; a coupling reagent, such as N,N′-dicyclohexylcarbodiimide; or an acid, such as sulfuric acid).

In some cases, the chemistries outlined above may have to be modified, for instance, by the use of protective groups to prevent side reactions due to reactive groups, e.g., attached as substituents. Further, desired compound salts and solvates may be formed, e.g., by treating with an acid or an appropriate solvent; and by isolating with filtration, extraction, additional of an antisolvent, drying, azeotroping, or any other suitable method. Additional modifications can include purification (e.g., by separation, recrystallization, or other suitable method) and preparation of an optical isomer (e.g., by reaction of the appropriate optically active starting materials under reaction conditions which will not cause racemization; or by separation of a racemic mixture using standard techniques, such as fractional crystallization or chiral HPLC).

Generally, the dopant (or twist agent) is a chiral molecule (often a pure enantiomer or diastereomer), which can be added to the achiral nematic to provide an increase in twist in the average molecular orientation of the bulk material. The amount of twist can be in proportion to the concentration, and the dopant can be employed at any useful concentration. However, in some instances, the proportion of dopant that can be added is limited by solubility or loss or cholesteric temperature range of the formulation.

The dopant can have any useful characteristic or property (e.g., any described herein). For instance, the helical twisting power (HTP) indicates a dopant's ability to induce twist, which is a property for light control. In some embodiments, the dopant has an HTP from about 1 μm⁻¹ to about 100 μm⁻¹ (e.g., from 1 μm⁻¹ to 10 μm⁻¹, 1 μm⁻¹ to 20 μm⁻¹, 1 μm⁻¹ to 30 μm⁻¹, 1 μm⁻¹ to 40 μm⁻¹, 1 μm⁻¹ to 50 μm⁻¹, 1 μm⁻¹ to 60 μm⁻¹, 1 μm⁻¹ to 70 μm⁻¹, 1 μm⁻¹ to 80 μm⁻¹, 1 μm⁻¹ to 90 μm⁻¹, 5 μm⁻¹ to 10 μm⁻¹, 5 μm⁻¹ to 20 μm⁻¹, 5 μm⁻¹ to 30 μm⁻¹, 5 μm⁻¹ to 40 μm⁻¹, 5 μm⁻¹ to 50 μm⁻¹, 5 μm⁻¹ to 60 μm⁻¹, 5 μm⁻¹ to 70 μm⁻¹, 5 μm⁻¹ to 80 μm⁻¹, 5 μm⁻¹ to 90 μm⁻¹, 5 μm⁻¹ to 100 μm⁻¹, 10 μm⁻¹ to 20 μm⁻¹, 10 μm⁻¹ to 30 μm⁻¹, 10 μm⁻¹ to 40 μm⁻¹, 10 μm⁻¹ to 50 μm⁻¹, 10 μm⁻¹ to 60 μm⁻¹, 10 μm⁻¹ to 70 μm⁻¹, 10 μm⁻¹ to 80 μm⁻¹, 10 μm⁻¹ to 90 μm⁻¹, 10 μm⁻¹ to 100 μm⁻¹, 20 μm⁻¹ to 30 μm¹, 20 m⁻¹ to 40 μm⁻¹, 20 μm⁻¹ to 50 μm⁻¹, 20 μm⁻¹ to 60 μm⁻¹, 20 μm⁻¹ to 70 μm⁻¹, 20 μm⁻¹ to 80 μm⁻¹, 20 μm⁻¹ to 90 μm⁻¹, 20 μm⁻¹ to 100 μm⁻¹, 25 μm⁻¹ to 30 μm⁻¹, 25 μm⁻¹ to 35 μm⁻¹, 25 μm⁻¹ to 40 μm⁻¹, 25 μm⁻¹ to 50 μm⁻¹, 25 μm⁻¹ to 60 μm⁻¹, 25 μm⁻¹ to 70 μm⁻¹, 25 μm⁻¹ to 80 μm⁻¹, 25 μm⁻¹ to 90 μm⁻¹, 25 μm⁻¹ to 100 μm⁻¹, 30 μm⁻¹ to 35 μm⁻¹, 30 μm⁻¹ to 40 μm⁻¹, 30 μm⁻¹ to 50 μm⁻¹, 30 μm⁻¹ to 60 μm⁻¹, 30 μm⁻¹ to 70 μm⁻¹, 30 μm⁻¹ to 80 μm⁻¹, 30 μm⁻¹ to 90 μm⁻¹, 30 μm⁻¹ to 100 μm⁻¹, 40 μm⁻¹ to 50 μm⁻¹, 40 μm⁻¹ to 60 μm⁻¹, 40 μm⁻¹ to 70 μm⁻¹, 40 μm⁻¹ to 80 μm⁻¹, 40 μm⁻¹ to 90 μm⁻¹, 40 μm⁻¹ to 100 μm⁻¹, 50 μm⁻¹ to 60 μm⁻¹, 50 μm⁻¹ to 70 μm⁻¹, 50 μm⁻¹ to 80 μm⁻¹, 50 μm⁻¹ to 90 μm⁻¹, 50 μm⁻¹ to 100 μm⁻¹, 60 μm⁻¹ to 70 μm⁻¹, 60 μm⁻¹ to 80 μm⁻¹, 60 μm⁻¹ to 90 μm⁻¹, 60 μm⁻¹ to 100 μm⁻¹, 70 μm⁻¹ to 80 μm⁻¹, 70 μm⁻¹ to 90 μm⁻¹, 70 μm⁻¹ to 100 μm⁻¹, 80 μm⁻¹ to 90 μm⁻¹, 80 μm⁻¹ to 100 μm⁻¹, or 90 μm⁻¹ to 100 μm⁻¹).

In another instance, the dopant can be characterized by a high solubility value that provide a stable formulation, in which exemplary values include from about 0.1 wt. % to about 60 wt. % of the dopant(s) in a formulation or a material (e.g., 0.1 wt. % to 5 wt. %, 0.1 wt. % to 10 wt. %, 0.1 wt. % to 15 wt. %, 0.1 wt. % to 20 wt. %, 0.1 wt. % to 25 wt. %, 0.1 wt. % to 30 wt. %, 0.1 wt. % to 35 wt. %, 0.1 wt. % to 40 wt. %, 0.1 wt. % to 45 wt. %, 0.1 wt. % to 50 wt. %, 0.1 wt. % to 55 wt. %, 0.5 wt. % to 5 wt. %, 0.5 wt. % to 10 wt. %, 0.5 wt. % to 15 wt. %, 0.5 wt. % to 20 wt. %, 0.5 wt. % to 30 wt. %, 0.5 wt. % to 40 wt. %, 0.5 wt. % to 50 wt. %, 0.5 wt. % to 60 wt. %, 1 wt. % to 5 wt. %, 1 wt. % to 10 wt. %, 1 wt. % to 15 wt. %, 1 wt. % to 20 wt. %, 1 wt. % to 30 wt. %, 1 wt. % to 40 wt. %, 1 wt. % to 50 wt. %, 1 wt. % to 60 wt. %, 3 wt. % to 5 wt. %, 3 wt. % to 10 wt. %, 3 wt. % to 15 wt. %, 3 wt. % to 20 wt. %, 3 wt. % to 30 wt. %, 3 wt. % to 40 wt. %, 3 wt. % to 50 wt. %, 3 wt. % to 60 wt. %, 5 wt. % to 10 wt. %, 5 wt. % to 15 wt. %, 5 wt. % to 20 wt. %, 5 wt. % to 30 wt. %, 5 wt. % to 40 wt. %, 5 wt. % to 50 wt. %, 5 wt. % to 60 wt. %, 8 wt. % to 10 wt. %, 8 wt. % to 15 wt. %, 8 wt. % to 20 wt. %, 8 wt. % to 30 wt. %, 8 wt. % to 40 wt. %, 8 wt. % to 50 wt. %, 8 wt. % to 60 wt. %, 10 wt. % to 15 wt. %, 10 wt. % to 20 wt. %, 10 wt. % to 30 wt. %, 10 wt. % to 40 wt. %, 10 wt. % to 50 wt. %, 10 wt. % to 60 wt. %, 12 wt. % to 15 wt. %, 12 wt. % to 20 wt. %, 12 wt. % to 30 wt. %, 12 wt. % to 40 wt. %, 12 wt. % to 50 wt. %, 12 wt. % to 60 wt. %, 15 wt. % to 20 wt. %, 15 wt. % to 30 wt. %, 15 wt. % to 40 wt. %, 15 wt. % to 50 wt. %, 15 wt. % to 60 wt. %, 20 wt. % to 30 wt. %, 20 wt. % to 40 wt. %, 20 wt. % to 50 wt. %, 20 wt. % to 60 wt. %, 30 wt. % to 40 wt. %, 30 wt. % to 50 wt. %, 30 wt. % to 60 wt. %, 40 wt. % to 50 wt. %, 40 wt. % to 60 wt. %, or 50 wt. % to 60 wt. %, based on the weight of the formulation or the material).

In yet another instance, the dopant or combination of dopants is characterized by an HTP from about 1 μm⁻¹ to about 100 μm⁻¹ and a solubility from about 5 wt. % to about 60 wt. % (e.g., an HTP of about 20 μm⁻¹ to about 40 μm⁻¹ with a solubility of about 10 wt. % to about 30 wt. %).

Formulations and Liquid Crystalline Materials

The present disclosure encompasses a formulation having at least one host and at least one dopant. In particular embodiments, the formulation includes a plurality of dopants. The formulation can provide any useful material, such as a chiral nematic material, a cholesteric liquid crystalline material, among others. As used herein, the terms “formulation” and “liquid crystalline material” can be used interchangeably.

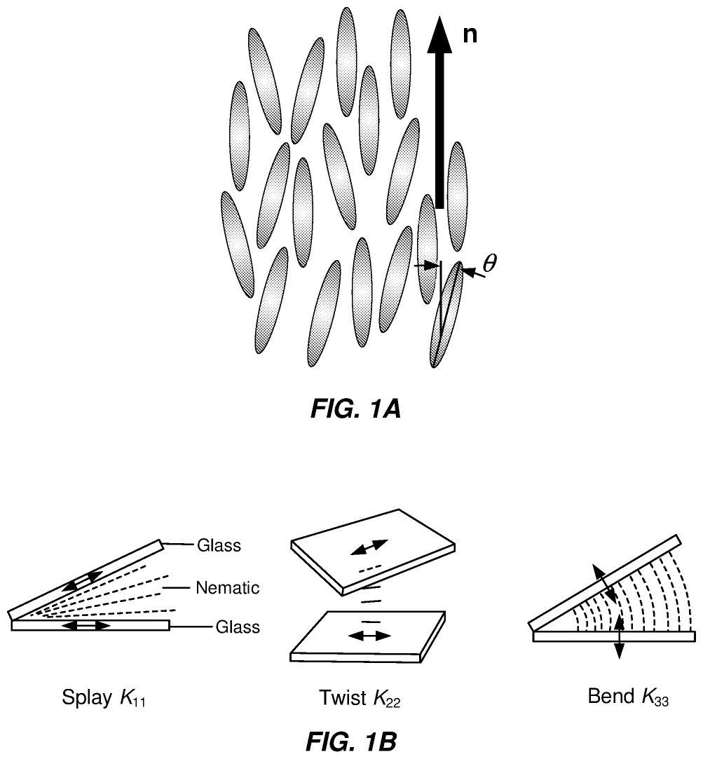

The simplest form of a liquid crystalline material is the nematic phase. Organic molecules of rod-like shape are oriented on average along one direction, called the director n (see FIG. 1A). In the most stable state, n is the same everywhere in the volume. By applying a voltage, for example, the uniform distribution of n can be very easily distorted, but there is a minute elastic resistance. The distortion of n can always be split into three independent modes referred to as “Splay,” “Twist,” and “Bend” as illustrated in FIG. 1B. These modes have their own elastic constants: K₁₁, K₂₂ and K₃₃, respectively. To understand and design the electro-optic responses of liquid crystals, knowledge of these elastic constants is fundamental.

Most of the physical properties of a liquid crystalline material depend on the direction relative to the average orientation of the molecules. The dielectric constant for an electric field parallel to the average orientation is ε₁, and the dielectric constant for an electric field perpendicular to the average orientation is ε₂. Some liquid crystals have ε₁>ε₂, and others have ε₁<ε₂. The former property, ε₁, is called the positive dielectric anisotropy; and the latter, ε₂, is called negative dielectric anisotropy. Under electric fields, the larger the difference between ε₁ and ε₂, the more easily the orientation of the liquid crystal can be controlled by an electric field. Liquid crystals with positive dielectric anisotropy are oriented parallel to the electric field, while the negative ones are perpendicularly oriented. Since the magnitude of the dielectric constants determine the responsiveness and the mode of response, their control is a desirable target of materials design for liquid crystals.

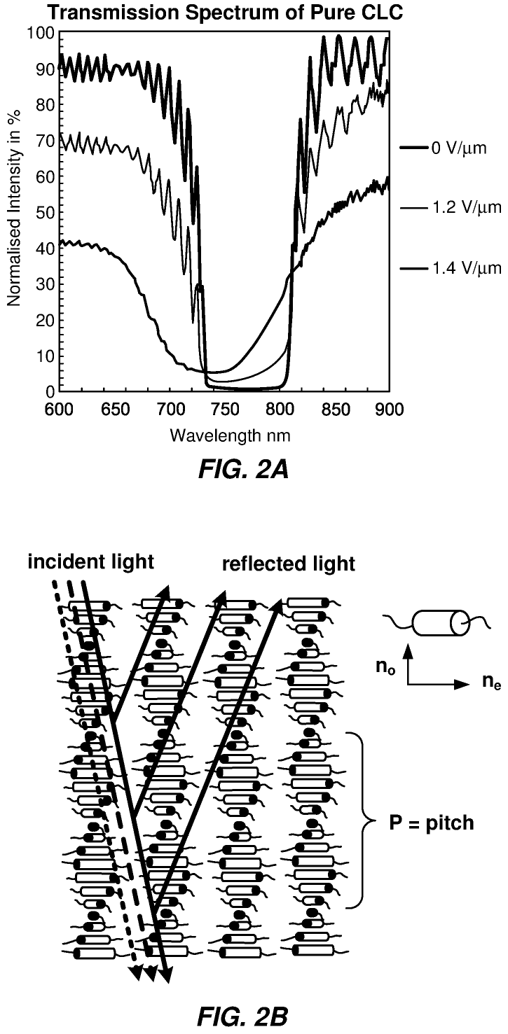

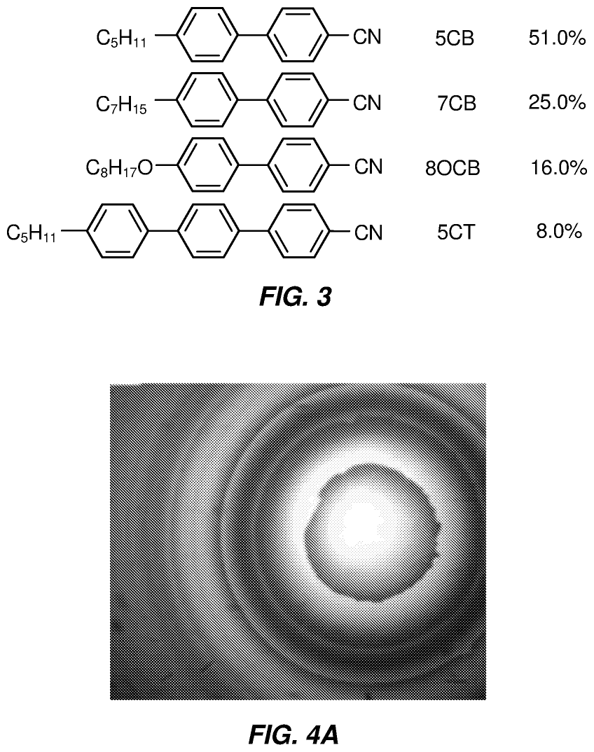

Cholesteric liquid crystals or chiral nematic liquid crystals can possess a one-dimensional periodic structure based on the natural helical twisting power of these materials (see FIG. 1A). The natural twist is associated with the molecular chirality of the liquid crystal molecules (or host molecules) and/or of the doping agents. When the pitch of the helical twist falls in the range of the wavelength of visible light, the periodic structure gives rise to a Bragg reflection of light. Unlike a simple Bragg reflection from a multilayer interference filter, the reflection from cholesteric liquid crystals is more complicated because of the continuously twisted structure of optically anisotropic media. One consequence of this fact is the selective reflection of circularly polarized light, and the other is the appearance of a well-defined selective reflection band with a sharp band edge (see FIG. 2A). The sharpness of the reflection band depends on the magnitude of birefringence of the liquid crystal and the uniformity of twist pitch. Also, structural anomalies could make the band edge less sharp.

The formulation can exhibit strong helical twist by, e.g., using a higher amount of dopant(s) and/or by using one or more dopants having a higher helical twisting power (HTP), thus a shorter pitch length. However, using chiral dopants in too high amounts can negatively affect the properties of the liquid crystalline host mixture, for example, the dielectric anisotropy, the viscosity, and the driving voltage or the switching times among others. Thus, the amount of dopant can be optimized to provide a desired combination of properties. In non-limiting liquid crystalline formulations that are used in selectively reflecting cholesteric displays, the pitch can be selected such that the maximum of the wavelength reflected by the cholesteric helix is in the range of required for the desired application.

Illustrative formulations include a binary formulation including one dopant and a host; a ternary formulation including two different dopants and a host; and a quaternary formulation including three different dopants and a host. Such formulations can have reflection bands in the visible range (e.g., from about 380 nm to about 780 nm) or any other range (e.g., in the ultraviolet region, such as from about 200 nm to about 380 nm; in the infrared region, such as from about 780 nm to about 1 mm; or in the near infrared region, such as about 740 nm to about 1000 nm).

Formulations can be selected to reflect various wavelengths of incident electromagnetic radiation. In one instance, the formulation can include an enantiomer of a particular dopant. As the chirality of the dopant influences the helical rotation of the host, a corresponding formulation can include an opposite enantiomer of that particular dopants. In yet other embodiments, enantiomeric pairs of dopants can be prepared, and formulations including one of the pair can be used to prepare separate light modulating layers.

Formulations and materials can possess any useful property that can be measured in any useful manner. For instance, stability can be determined by assessing the reflection band of the material in an absorption spectrum, conducting phase boundary and phase transition studies of the material as a function of dopant concentration, and/or measuring light transmittance of the material as a function of temperature. Evidences of instability include observing changes in the reflection band over time (e.g., red-shifting of the band, such as by about 100 nm), characterizing nematic-isotropic phase transitions, and/or determining the presence of crystallization or coexistence of one or more phases within the material. In addition to stability against phase segregation, formulations can be assessed for stability after UVA irradiation, stability after thermal cycling, lifetime stability, sample pitch, dopant HTP, and host NI transition temperature.

Any useful host can be employed within a formulation. The host can include a single compound or a combination of different compounds. Such compounds can include one or more mesogens, cholesteric compounds, nematic compounds, as well as combinations thereof. In particular embodiments, the host can include one or more achiral cholesteric nematic mesogens. In another embodiment, the host can include one or more nematic or nematogenic compounds.

In some embodiments, the formulation or liquid crystalline material includes 3 to 25 components, such as 3 to 15 compounds, or 4 to 10 compounds, of which at least two is a chiral dopant originating from the herein discussed bioreachables. The other compounds can be low molecular weight liquid crystalline compounds selected from nematic or nematogenic substances.

Exemplary host compounds (e.g., nematic or nematogenic substances) can be selected from azoxybenzenes, benzylideneanilines, biphenyls, terphenyls, phenyl benzoates, cyclohexyl benzoates, phenyl esters of cyclohexanecarboxylic acid, cyclohexyl esters of cyclohexanecarboxylic acid, phenyl esters of cyclohexylbenzoic acid, cyclohexyl esters of cyclohexylbenzoic acid, phenyl esters of cyclohexylcyclohexanecarboxylic acid, cyclohexyl esters of cyclohexylcyclohexanecarboxylic acid, cyclohexylphenyl esters of benzoic acid, cyclohexylphenyl esters of cyclohexanecarboxylic acid, cyclohexylphenyl esters of cyclohexylcyclohexanecarboxylic acid, phenylcyclohexanes, cyclohexylbiphenyls, phenylcyclohexylcyclohexanes, cyclohexylcyclohexanes, cyclohexylcyclohexenes, cyclohexylcyclohexylcyclohexenes, 1,4-bis-cyclohexylbenzenes, 4,4′-bis-cyclohexylbiphenyls, phenylpyrimidines, cyclohexylpyrimidines, phenylpyridines, cyclohexylpyridines, phenylpyridazines, cyclohexylpyridazines, phenyldioxanes, cyclohexyldioxanes, phenyl-1,3-dithianes, cyclohexyl-1,3-dithianes, 1,2-diphenylethanes, 1,2-dicyclohexylethanes, 1-phenyl-2-cyclohexylethanes, 1-cyclohexyl-2-(4-phenylcyclohexyl) ethanes, 1-cyclohexyl-2-biphenylethanes, 1-phenyl-2-cyclohexylphenylethanes, halogenated stilbenes, benzyl phenyl ether, tolanes, substituted cinnamic acids, or any combination thereof. The 1,4-phenylene groups in these compounds may also be fluorinated.

Yet other host compounds include R′—[O]ₕ₁-[A¹]ₕ₂-L¹-[A²]ₕ₃-L²-[O]ₕ₄—R″ or R′—[O]ₕ₁-[A¹]ₕ₂-L¹-[A²]ₕ₃-L²-R″ or R′—[O]-[A¹]-L¹-[A²]-L²-R″ or R′-[A¹]-L¹-[A²]-L²-R″, where each of A¹ and A² is, independently, -Phe-, -Cyc-, -Phe-Phe-, -Phe-Phe-Phe-, -Phe-Cyc-, -Cyc-Phe-, -Cyc-Cyc-, -Het-, —B-Phe-, and —B-Cyc-; Phe is unsubstituted or halo-substituted 1,4-phenylene, naphthalene-2,6-diyl, decahydronaphthalene-2,6-diyl, or 1,2,3,4-tetrahydronaphthalene-2,6-diyl; Cyc is trans-1,4-cyclohexylene or 1,4-cyclohexenylene or bicyclo [2.2.2]octane; Het is pyrimidine-2,5-diyl, pyridine-2,5-diyl, 1,3-dioxane-2,5-diyl, or tetrahydropyran-2,5-diyl; B is 2-(trans-1,4-cyclohexyl)ethyl, pyrimidine-2,5-diyl, pyridine-2,5-diyl 1,3-dioxane-2,5-diyl, or tetrahydropyran-2,5-diyl; each of L¹ and L² is, independently, —CH═CY′—, —CH═CH—, —C≡C—, —N═N(O)—, —CH═N(O)—, —CY′═N—, —CH═N—, —CY′₂—, —(CY′₂)₂—, —CY′₂O—, —OCY′₂—, —COO—, —O—, —C(O)—, —OCO—, —CY′₂—O—, —O—CY′₂—, —CO—S—, —CY′₂—S—, —COO-Phe-COO—, or a single bond; each Y′ is, independently, hydrogen, halo, or —CN; and each of R′ and R″ is, independently, alkyl (e.g., linear or branched C₁₋₁₂ or C₁₋₂₄ alkyl), alkenyl, alkoxy, alkenyloxy, alkanoyloxy, alkoxycarbonyl, alkoxycarbonyloxy, halo, —CF₃, —OCF₃, —NCS, —CN, —OR′″, —OC(O)R′″, —C(O)OR′″, —C(O)OH, or —OC(O)OR′″, in which R′″ is H, optionally substituted C₁₋₁₀ alkyl, or optionally substituted C₂₋₁₀ alkenyl; h1 is 0 or 1; h2 is 0, 1, 2, 3, 4, or 5; h3 is 0, 1, 2, 3, 4, or 5; and h4 is 0 or 1.

In some embodiments, the host can include one or more polymerizable compounds (e.g., a polymerizable mesogenic compound). Such polymerizable compounds can be configured to (co)polymerize with the dopant(s) in order to provide a polymer film. Accordingly, the polymerizable compound can have at least one polymerizable functional group. In one embodiment, the polymerizable functional group includes an epoxy group, a vinyl group, an allyl group, an acrylate, a methacrylate, an isoprene group, an alpha-amino carboxylate, or any combination thereof. In particular embodiments, the polymerizable compound provides a polymer network, which stabilizes the material, reduces scattering, and increases speed.

The host can have any useful property, such as beneficial viscosity, birefringence, electrical anisotropy, and magnetic anisotropy, among others. Any properties may be tailored to the desired usage by altering the chemical composition of the host (e.g., by including a mixture of mesogens or nematic compounds). Then, chiral dopant(s) can be incorporated to induce helical twisting so as to provide the desired chiral nematic pitch. For instance, as seen in FIG. 2B, the helical cholesteric structure is periodic in one dimension. It is characterized by its pitch P, which is the distance along the helix axis where the direction of average molecular orientation has rotated by an angle of 360°. The chiral dopant induces the helical structure; the induced pitch is inversely proportional to the concentration c of the chiral dopant. The extent of twist induced by the chiral dopant can be quantified as the helical twisting power (HTP), in which HTP=1/cP, where c is the concentration expressed as weight fraction and P is the cholesteric pitch.

The liquid crystalline material can include any useful dopant(s) in any useful amount, e.g., of at least 0.001 wt. %, such as at least 0.002 wt. %, at least 0.005 wt. %, at least 0.01 wt. %, at least 0.02 wt. %, at least 0.05 wt. %, at least 0.1 wt. %, at least 0.2 wt. %, at least 0.5 wt. %, at least 1 wt. %, at least 1.2 wt. %, at least 1.5 wt. %, at least 2 wt. %, at least 2.5 wt. %, at least 3 wt. %, at least 3.5 wt. %, at least 4 wt. %, at least 4.5 wt. %, at least 5 wt. %, at least 6 wt. %, at least 7 wt. %, at least 8 wt. %, at least 9 wt. %, or at least 10 wt. %, based on the weight of the liquid crystalline material.

In another embodiment, the liquid crystalline material includes at least one chiral dopant present in an amount of not greater than 20 wt. %, such as not greater than 18 wt. %, not greater than 16 wt. %, not greater than 14 wt. %, not greater than 12 wt. %, not greater than 10 wt. %, or not greater than 8 wt. % based on the weight of the liquid crystalline material. Further, in one embodiment, the chiral dopant can be present in an amount ranging from 0.0015 wt. % to 17 wt. %, such as from 0.01 wt. % to 15 wt. %, from 0.05 wt. % to 13 wt. %, or from 0.1 wt. % to 11 wt. % based on the weight of the liquid crystalline material.

Multicomponent formulations (e.g., having two or more dopants with a host) can be formulated in any useful manner. In particular embodiments, the method includes initially forming a mixture having two or more dopants. Then, the stability of that mixture can be tested prior to adding a host. Stability can be tested in any useful manner, e.g., as described herein, such as by comparing the reflection band of a transmission or absorption spectrum over time.

Mixing of formulations can include providing a uniform combination of host and chiral dopant(s). In some embodiments, such mixing reduces the extent of metastable crystals that can be formed due to inhomogeneous concentration or temperature fields. In non-limiting embodiments, the protocol includes providing a host and dopant(s) within a vessel; mixing and heating the combination above a first temperature T₁ (e.g., in which T₁ is above the isotropic phase, such as from about 80° C. to about 120° C.) for a first time duration t₁ (e.g., in which t₁ is from about 30 minutes to 1.5 hours); placing in a centrifuge (e.g., at a first rate from about 3000 rpm to 7000 rpm) for a second time duration t₂ (e.g., in which t₂ is from about 5 minutes to 1 hour); reheating the combination above a second temperature T₂ (e.g., in which T₂ is above the isotropic phase, such as from about 80° C. to about 120° C.) for a third time duration t₃ (e.g., in which t₃ is from about 5 minutes to 1 hour); optionally repeating the placing and reheating steps in cycles for any useful n number of times (e.g., n is 1, 2, 3, 4, 5, or more); and optionally repeating the placing step one last time.

Applications

The mixtures, formulations, and materials herein can find use in a variety of optical or photonic applications. Non-limiting embodiments of applications include filters (e.g., color filters), polarizers, other optical elements, devices (e.g., an agile optical filter device), displays, smart windows, sensor protection materials, photoactive materials, cosmetics, paints, coatings, chemical sensors, laser cavities, and other photonic devices. Other non-limiting applications include electronic writers or tablets, electronic skins, inks, among others.

In one instance, the present disclosure encompasses use of dopants for an optical element (e.g., a filter). Generally, optical filters are of two types: (i) absorptive filters, which absorb the unwanted radiation, and (ii) interference filters, which reflect rather than absorb. Interference filters are preferable in many applications, since absorbing the radiation can lead to damage and failure. Interference filters are typically layered structures, reflecting light from each interface in such a way that the propagating waves interfere destructively and cancel, while the reflected waves interfere constructively, and essentially all incident light is reflected, without damage to the filter. Such optical elements can include absorption or reflection of radiation (e.g., in the visible range), as well as protection of underlying components from such radiation. In some instances, the optical element can include tunable (or agile) filters, in which the amount and type of radiation to be adsorbed or reflected can be actively switched (e.g., on or off) or tuned (e.g., to different wavelengths of radiation). In other instances, the optical element is a polarizer (e.g., a cholesteric broadband polarizer), a liquid crystalline retardation film, an active optical element, a passive optical element, a color filter, a reflective film, among others.

A layer or a component of an optical element can include the mixtures, formulations, or materials described herein. In a particular embodiment, an optical element includes a pair of enantiomers of a dopant, in which a first layer includes one enantiomer and the second layer includes the other enantiomer.

An agile optical filter may include one or more of the dopants herein. In particular embodiments, the agile optical filter device has the ability to change wavelengths. For instance, a change in temperature can change the location of the reflection banc, and applying a voltage can do the same. In addition, if the K3 elastic constant is reduced by the addition of one or more dimers, the voltage tunability expands dramatically due to formation of heliconical structure.

In other embodiments, the agile optical filter is characterized by a broad temperature cholesteric range (usually including ambient temperature), a higher response speed, a twist with minimal temperature dependence, and/or enhanced rejection efficiency. The agile optical filter device can include a cholesteric (twisted nematic) media. In one case, the medium is comprised of a molecule that is both mesogenic and intrinsically chiral. The individual molecules comprising the media can contain one (pure enantiomer) or more (pure diastereomer) sites. It is also possible to mix different chiral nematic mesogens to create a medium with improved properties (attention must be paid to the relationship between the chiral centers and the resulting twist sense for each component). If an enantiomer of a molecule is mixed with its mirror image, the twist will be reduced (a racemic mixture contains equal amounts of the two enantiomers and will behave as an achiral nematic). In another case, the medium is comprised of a molecule that is mesogenic (nematic), but the molecule is not intrinsically chiral. Here again, it is possible to mix different achiral nematic mesogens to create a medium (or host) with improved properties (but it will never be cholesteric). An achiral nematic host can be converted into a cholesteric media by the addition of a twist agent. Alternatively, a cholesteric liquid crystal can serve as a twist agent when mixed into an achiral nematic mesogen.

Further applications include smart windows, sensor protection, photoactive materials, optical filters, liquid crystal displays, for example STN, TN, AMD-TN, temperature compensation, guest-host or phase change displays, or polymer free or polymer stabilized cholesteric texture (PFCT, PSCT) displays. Such liquid crystal displays can include a chiral dopant in a liquid crystalline medium and a polymer film with a chiral liquid crystalline phase obtainable by (co)polymerizing a liquid crystalline material containing a chiral dopant and a polymerizable mesogenic compound.

The liquid crystal display can include a layer of liquid crystalline material. In some embodiments, the layer of a liquid crystalline material is characterized by a cholesteric pitch (P) and a thickness (d). In one embodiment, a ratio of d/P is at least 0.01, at least 0.02, at least 0.05, at least 0.1, or at least 0.15. In another embodiment, the layer includes a ratio of d/P that is not greater than 1, not greater than 0.8, not greater than 0.6, not greater than 0.4, not greater than 0.3, or not greater than 0.25. In yet another embodiment, the ratio of d/P can range from 0.01 to 0.9, such as from 0.02 to 0.7, from 0.03 to 0.5, or from 0.04 to 0.4.

### EXAMPLES

### Example 1: Scaled-Up Synthesis of Dibutanoyl Ester of Betulin (CD13)

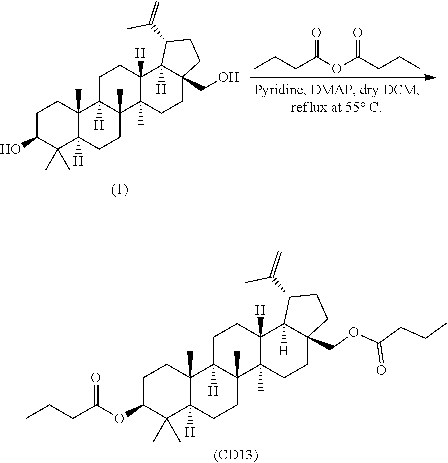

In a 2000 ml round bottom flask with stir bar was placed betulin (1, 44.300 gm, 100.0 mmol), dry dichloromethane (DCM, 500 ml), butyric anhydride (63.200 gm, 400.0 mmol), pyridine (200 ml), and 4-dimethylaminopyridine (DMAP, 24.400 gm, 200.0 mmol). The mixture was protected under nitrogen atmosphere and warmed at 55° C. for six hours. After this time, the reaction was monitored by thin layer chromatography (TLC), which indicated the complete consumption of betulin to give single less polar product. Then, 200 ml of cold water was added dropwise with stirring, and the solution was made acidic by adding 10% HCl (200 ml). Organic layer was separated, and the aqueous layer was extracted with ethyl acetate (EtOAc, 3×250 ml). The organic fractions were combined, washed with brine, and dried over anhydrous MgSO₄. Solvent was evaporated, and the liquid obtained was absorbed on 300 cc of silica gel with 500 ml of ethyl acetate. After concentration to dryness, the absorbed material was placed at the top of the silica gel column made up with EtOAc:Hexane 1:9 to elute (solvent:EtOAc:Hexane 1:9). Concentration of the fraction provided white solid, which was recrystallized from MeOH (yield=51.833 gm, 89%).

Melting Point: 102-104° C.

¹H NMR (CDCl₃, 400 MHz): δ=4.68 (d, 1H), 4.58-4.59 (m, 1H), 4.26 (dd, 1H), 3.85 (d, 1H), 3.16-3.20 (m, 1H), 2.41-2.49 (m, 1H), 2.31 (t, 2H), 1.91-2.05 (m, 1H), 1.50-1.87 (m, 16H), 1.34-1.45 (m, 5H), 1.15-1.33 (m, 8H), 1.05-1.15 (m, 1H), 1.03 (s, 3H), 0.93-0.99 (m, 8H), 0.85-0.89 (m, 5H), 0.82 (s, 3H), 0.76 (s, 3H), 0.76 (s, 3H), 0.67-0.69 (m, 1H).

¹³C NMR (CDCl₃, 100 MHz): δ=13.7, 14.7, 16.0, 16.1, 16.6, 18.1, 18.5, 18.6, 19.1, 20.8, 23.7, 25.2, 27.0, 28.0, 29.6, 29.8, 34.1, 34.6, 36.4, 36.7, 37.1, 37.6, 37.8, 24 38.4, 40.9, 42.7, 46.4, 47.7, 48.8, 50.3, 55.4, 62.5, 80.6, 109.8, 150.2, 173.4, 174.2.

### Example 2: Scaled-Up Synthesis of Di-p-Toluyl Ester of Betulin (CD29)

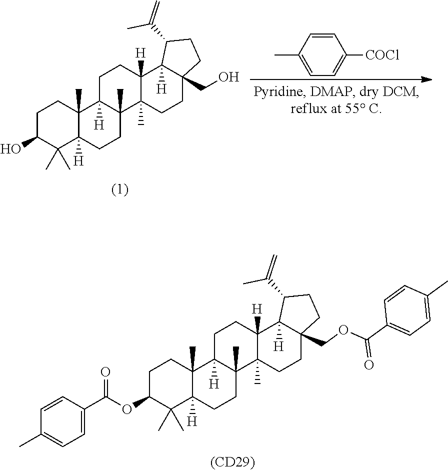

In a 2000 ml recovery flask with stir bar was placed betulin (1, 44.300 gm, 100.0 mmol), dry DCM (450 ml), p-toluoyl chloride (61.800 gm, 400.0 mmol), pyridine (250 ml), and 4-dimethylaminopyridine (19.874 gm, 162.6 mmol). The mixture was protected under nitrogen atmosphere and warmed at 55° C. for five hours. After this time, TLC indicated the complete consumption of the starting material and formation of two new less polar products. The mixture was left stirring at 55° C. overnight and monitored by TLC, which indicated the complete consumption the starting material to give single less polar product. Then, cold water (200 ml) and 10% HCl (200 ml) was added dropwise with stirring. The product was extracted with EtOAc (3×250 ml), washed with water, and dried over anhydrous MgSO₄. Solvent was evaporated, and the liquid obtained was absorbed on 300 cc of silica gel with 500 ml of ethyl acetate. The absorbed material was placed at the top of the silica gel column made up with EtOAc:Hexane 1:9 to elute (solvent:EtOAc:Hexane 1:9). Concentration of the fractions provided a solid product, which was recrystallized from 1-PrOH (yield=57.682 gm, 85%)

Melting Point: 207-209° C.

¹H NMR (CDCl₃, 400 MHz): δ=7.91-7.95 (m, 4H), 7.22-7.25 (m, 4H), 4.68-4.73 (m, 2H), 4.61-4.62 (m, 1H), 4.51 (d, 1H), 4.07 (d, 1H), 2.49-2.57 (m, 1H), 2.39-2.43 (m, 6H), 1.72 (s, 3H), 1.57 (s, 6H), 1.06 (s, 3H), 1.02 (s, 3H), 0.99 (s, 3H), 0.91 (s, 3H).

¹³C NMR (CDCl₃, 100 MHz): δ=14.1, 14.8, 16.1, 16.2, 16.8 (x2C), 18.2, 19.2, 20.9, 21.6, 21.7, 22.7, 23.8, 25.2, 27.2, 28.1, 29.7, 30.0, 34.1, 34.7, 37.1, 37.7, 38.2, 38.4, 40.9, 42.8, 46.7, 47.8, 48.9, 50.3, 55.5, 63.1, 81.3, 109.9, 127.8, 128.3, 129.0, 129.1, 129.5, 129.6 (x2C), 143.3, 143.5, 150.2, 166.4, 167.1.

### Example 3: Synthesis of Di-p-Toluyl Ester of Dihydrobetulin (PN02082)

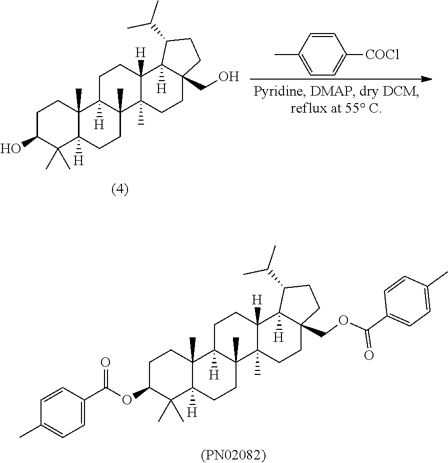

In a 100 ml recovery flask with stir bar was placed dihydrobetulin (4, 0.210 gm, 0.5 mmol), dry DCM (10 ml), p-toluoyl chloride (0.308 gm, 2.0 mmol), pyridine (5 ml), and 4-dimethylaminopyridine (0.122 gm, 1.0 mmol). The mixture was protected under nitrogen atmosphere and warmed at 55° C. overnight. After this time, TLC indicated the complete consumption of the starting material to give a single less polar product. Then, cold water (50 ml) and 10% HCl (5 ml) were added dropwise with stirring. The product was extracted with EtOAc (3×25 ml), washed with water, and dried over anhydrous MgSO₄. Solvent was evaporated, and the liquid obtained was absorbed on 25 cc of silica gel with 50 ml of ethyl acetate. The absorbed material was placed at the top of the silica gel column made up with EtOAc:Hexane 1:9 to elute (solvent:EtOAc:Hexane 1:9). Concentration of fractions provided a solid product, which was recrystallized from 1-PrOH (yield=0.262 gm, 77%).

Melting point: 210.5° C.

¹H NMR (400 MHz, CDCl₃): δ=7.29-7.95 (m, 4H), 7.22-7.26 (m, 4H), 4.69-4.73 (m, 1H), 4.71 (dd, J₁=5.1 Hz, J₂=10.7 Hz, 1H), 4.51 (d, J=10.8 Hz, 1H), 4.04 (d, J=11.1 Hz, 1H), 2.41 (s, 6H), 1.09 (s, 3H), 1.00 (s, 6H), 0.92 (s, 6H), 0.86 (d, J=6.7 Hz, 3H), 0.79 (d, J=6.7 Hz, 3H).

¹³C NMR (CDCl₃, 100 MHz): δ=167.07, 166.4, 143.5, 143.3, 129.6, 129.1, 129.0, 128.3, 127.8, 81.3, 63.1, 55.4, 50.0, 48.2, 46.9, 44.6, 43.0, 41.0, 38.4, 38.2, 37.2, 37.1, 34.9, 34.2, 30.1, 29.5, 28.1, 27.0, 26.9, 23.8, 23.0, 21.7, 20.8, 18.2, 16.8, 16.1, 16.1, 14.9, 14.7.

### Example 4: Synthesis of di-4-butylbenzoic acid ester of betulin (CD46)

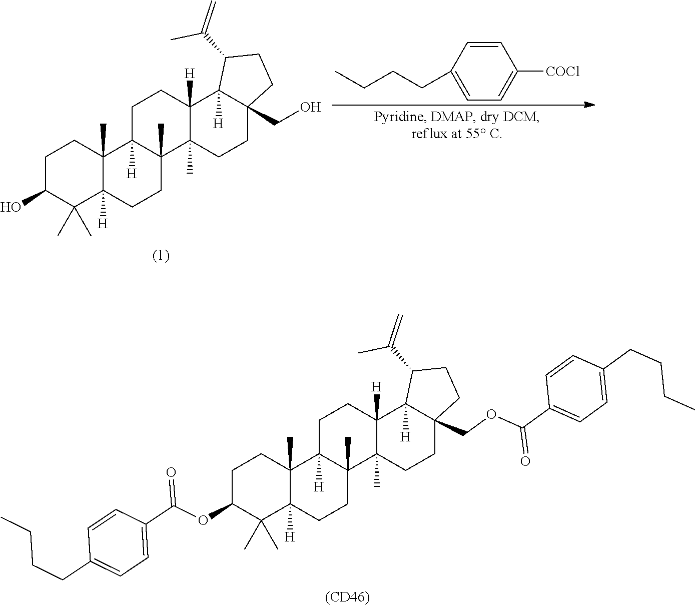

In a 100 ml recovery flask with stir bar was placed betulin (1, 0.443 gm, 1.0 mmol), dry DCM (10 ml), p-n-butylbenzoyl chloride (0.558 gm, 3.0 mmol), pyridine (10 ml), and 4-dimethylaminopyridine (0.366 gm, 3.0 mmol). The mixture was protected under nitrogen atmosphere and warmed at 55° C. for five hours. After this time, TLC indicated the formation of two new products. Additional pyridine (3.0 ml), DMAP (0.122 gm, 1.0 mmol), and p-n-butylbenzoyl chloride (0.392 gm, 2.0 mmol) were added, and the mixture was left stirring at 55° C. overnight. After this time, TLC indicated the complete consumption of the starting material to give single less polar product. Then, cold water (50 ml) and 10% HCl (5 ml) were added dropwise with stirring. The product was extracted with EtOAc (3×25 ml), washed with water, and dried over anhydrous MgSO₄. Solvent was evaporated, and the liquid obtained was absorbed on 20 cc of silica gel with 50 ml of ethyl acetate. After concentration to dryness, the absorbed material was placed at the top of the silica gel column made up with EtOAc:Hexane 1:9 to elute (solvent:EtOAc:Hexane 1:9). Concentration of the fractions provided a solid product, which was recrystallized from 1-PrOH/H₂O (yield=0.410 gm, 54%).

Melting Point: 164.8° C.

¹H NMR (CDCl₃, 400 MHz): δ=7.93-7.97 (m, 4H), 7.23-7.26 (m, 4H), 2.68-4.72 (m, 2H), 4.61-4.62 (m, 1H), 4.51 (d, J=10.8 Hz, 1H), 4.07 (d, J=11.0 Hz, 1H), 2.63-2.68 (m, 4H), 2.50-2.57 (m, 1H), 1.72 (s, 3H), 1.08 (s, 3H), 1.02 (s, 3H), 0.99 (s, 3H).

¹³C NMR (CDCl₃, 100 MHz): δ=167.1, 166.4, 150.2, 148.5, 148.3, 129.6, 129.6, 128.5, 128.4, 128.4, 127.9, 109.9, 81.3, 63.1, 55.5, 50.3, 48.9, 47.8, 46.7, 42.8, 40.9, 16 38.4, 38.2, 37.7, 37.1, 35.7, 34.8, 34.1, 33.3, 30.0, 29.7, 29.7, 29.6, 28.1, 27.1, 25.2, 23.8, 22.3, 20.8, 19.2, 18.2, 16.8, 16.2, 16.1, 14.8, 13.9.

IR (cm⁻¹): 2926, 2868, 1714, 1610, 1455, 1269, 1176, 1105, 971.

### Example 5: Synthesis of di-4-heptylbenzoic acid ester of betulin (CD47)

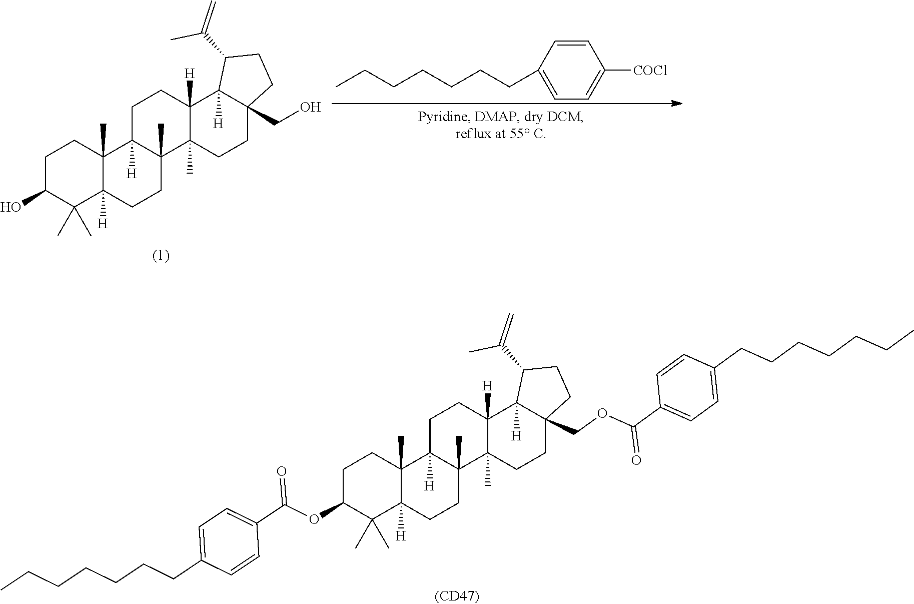

In a 100 ml recovery flask with stir bar was placed betulin (1, 0.443 gm, 1.0 mmol), dry DCM (10 ml), p-n-heptylbenzoyl chloride (0.956 gm, 4.0 mmol), pyridine (10 ml), and 4-dimethylaminopyridine (0.366 gm, 3.0 mmol). The mixture was protected under nitrogen atmosphere and warmed at 55° C. for four hours. After this time, TLC indicated the formation of two new products. Additional pyridine (3.0 ml), DMAP (0.122 gm, 1.0 mmol) and p-n-heptylbenzoyl chloride (0.478 gm, 2.0 mmol) were added, and the mixture was left stirring at 55° C. overnight. After this time, TLC indicated the complete consumption of the starting material to give single less polar product. Then, cold water (50 ml) and 10% HCl (5 ml) were added dropwise with stirring. The product was extracted with EtOAc (3×25 ml), washed with water, and dried over anhydrous MgSO₄. Solvent was evaporated, and the liquid obtained was absorbed on 20 cc of silica gel with 50 ml of ethyl acetate. After concentration to dryness, the absorbed material was placed at the top of the silica gel column made up with EtOAc:Hexane 1:9 to elute (solvent:EtOAc:Hexane 1:9). Concentration of the fractions provided a viscous liquid product.

The crude product was suspected to contain acid chloride impurities from ¹H NMR, and so it was attempted to selectively hydrolyze into carboxylic acid to remove from the mixture. The crude product was transferred into a 200 ml recovery flask with stir bar and dissolved in THF (20 ml). Aqueous sodium bicarbonate solution (20 ml, 20% w/v) was added, and the mixture with two layers was stirred for 48 hours at room temperature. After this time, TLC indicated no change in the mixture (acid chloride persisted in the mixture), and so the reaction was forced to stop by adding 100 ml water. The product was extracted with EtOAc (3×25 ml), dried over anhydrous MgSO₄ and filtered through the sintered funnel. Solvent was removed, and the product was transferred into a 200 ml recovery flask with 1,4-dioxane (20 ml). Aqueous hydrazine solution (10% v/v, 5 ml) was added dropwise with stirring, and the mixture was stirred at room temperature for 25 minutes. After this time, only a single spot was observed on TLC indicating all the acid chloride disappeared from the mixture. Cold water (100 ml) was added dropwise, and the product was extracted with EtOAc (3×25 ml). Organic phase was dried over anhydrous MgSO₄, filtered through sintered funnel, and concentrated under reduced pressure. The liquid residue was absorbed on silica gel (15 cc) with 50 ml EtOAc. After concentration to dryness, the absorbed material was placed at the top of the silica gel column made up with EtOAc:Hexane 1:9 to elute (solvent:EtOAc :Hexane 1:9). Concentration of the fractions provided a viscous liquid as a product which was shown to be pure by ¹H NMR (yield=0.733 gm, 53%).

¹H NMR (CDCl₃, 400 MHz): δ=7.93-7.97 (m, 4H), 7.22-7.26 (m, 4H), 4.61-4.70 (m, 2H), 4.51 (d, J=10.8 Hz, 1H), 4.31 (t, J=6.6 Hz, 1H), 4.07 (d, J=11.2 Hz, 1H), 2.63-2.68 (m, 4H), 2.49-2.56 (m, 1H), 1.56 (s, 3H), 1.08 (s, 3H), 1.02 (s, 3H), 0.99 (s, 3H).

¹³C NMR (CDCl₃, 100 MHz): δ=167.1, 166.4, 150.2, 148.5, 148.3, 129.6, 129.6, 128.4, 128.3, 127.9, 109.9, 81.3, 64.6, 63.1, 55.5, 50.3, 48.9, 47.8, 46.7, 42.8, 41.0, 38.4, 37.7, 37.1, 36.0, 34.8, 34.2, 31.8, 31.2, 30.8, 30.3, 30.0, 29.7, 29.2, 29.1, 28.1, 27.1, 25.2, 23.8, 22.6, 20.9, 19.3, 19.2, 18.2, 16.8, 16.2, 16.1, 14.8, 14.1, 13.8.

IR (cm⁻¹): 2924, 2854, 1713, 1456, 1269, 1175, 1105, 1018, 970.

### Example 6: Potential Strategies to Mitigate Crystallization/Phase Segregation Instabilities

Three strategies can be adopted to eliminate phase separation instability, which include the following:
Utilizing the mixing protocol in Example 7, below, to ensure uniform mixture of host and chiral dopant. This eliminated metastable crystals formed during past history due to homogeneous concentration or temperature fields.
Increasing the solubility of chiral dopants by structural modifications. Three chiral dopants, CD46, CD47 and CD48, were synthesized with modified structure to enhance solubility.
Formulating multicomponent mixtures. Typically, binary mixtures including a nematic host and one chiral dopant with a given concentration have been used in previous studies. However, crystallization can be avoided if two chiral dopants, with reduced concentrations, are used instead. The stability of ternary mixtures is discussed below.

In subsequent work, all three of the above strategies were implemented. The developed mixing protocol was used with success, and using the protocol appeared to eliminate unwanted long-lived metastable crystals. Various chiral dopants were synthesized and characterized; their properties are reported below. Multicomponent mixtures were formulated and studied; various stable ternary mixtures with reflection bands in the visible are reported below.

### Example 7: Non-Limiting Mixing Protocol

One aspect of the phase behavior of liquid crystals is the existence of long-lived metastable states. These metastable states can persist despite changes in temperature or other experimental conditions, thus providing anomalous phase behavior (e.g., crystallization or phase segregation) that depends on the prior history of the material.

In order to minimize spurious history—dependent phenomena (e.g., such as crystallization due to concentration inhomogeneities), we have implemented a nematic—chiral dopant mixture preparation protocol. This protocol can enhance reliable formation and comparison of mixtures, as well as contributes to stability against phase separation.

An illustrative protocol is provided below:
1. host nematic and chiral dopant(s) are weighed and put into a vial
2. mixture with magnetic stirrer is heated above isotropic phase (e.g., about 90° C.) for a first time duration (e.g., about 60 minutes)
3. mixture is placed in centrifuge (e.g., 6000 rpm) for a second time duration (e.g., about 10 minutes)
4. mixture with magnetic stirrer is heated above isotropic phase for a third time duration (e.g., about 5 minutes)
5. steps 3 and 4 can be optionally repeated for any useful n number of times (e.g., n is 1, 2, 3, 4, 5, or more)
6. optionally, the mixture is placed in centrifuge (e.g., 6000 rpm) for a fourth time duration (e.g., about 10 minutes)

The resulting mixture can be used to form a material (e.g., by filling a sample cell).

Furthermore, the protocol can optionally include an initial assessment regarding the stability of a mixture of dopants without the host. For instance, when stability is observed within a dopant mixture, then such stability will likely contribute to the stability of multi-component formulation having a host.

### Example 8: Characterization of Dopants from Small-Scale and Scaled-Up Synthesis

Physical properties of CD13 and CD29 from scaled-up synthesis were compared to prior small-scale results. Of note, there were no significant differences in the product properties based on chemical and spectroscopic analysis, as well as functional/performance analysis. Any differences were within experimental accuracy.

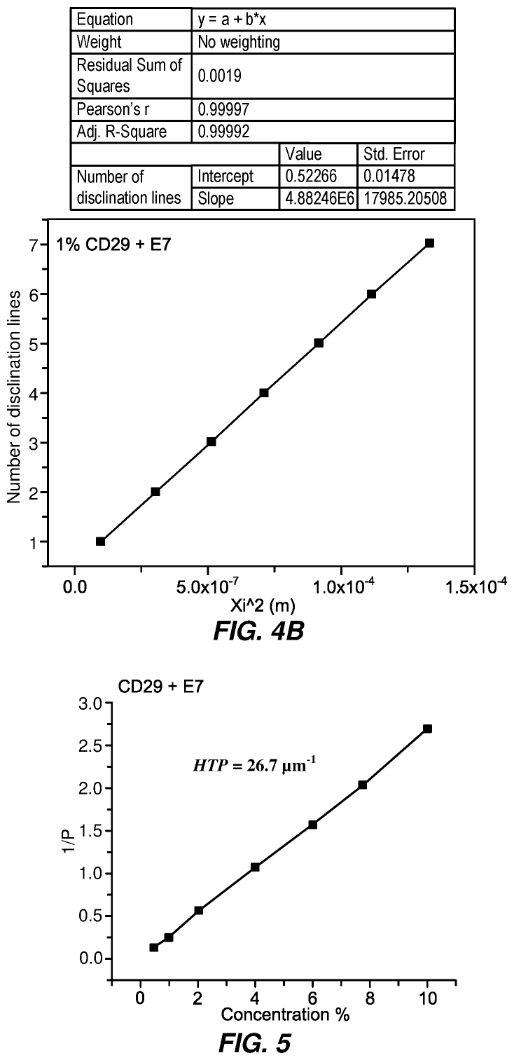

In brief, samples were prepared with various concentrations (0.5, 2, 4, 6, 8, and 10 wt. %) of CD29 in E7. The pitch of each sample was measured using the cylindrical Cano wedge method (FIG. 4A-4B). Here, the number of circular disclination lines is plotted versus their radius, as shown in FIG. 4B for 1% concentration. Plotting inverse pitch versus dopant concentration gives the HTP (see FIG. 5).

When using CD29 in E7, measured HTP included 27.2 μm⁻¹ for small scale synthesis of CD29, as compared to 26.7 μm⁻¹ for scale-up synthesis of CD29. This difference is less than 2%, which is within experimental accuracy. Similar measurements of CD13 in E7 provided HTP of 16.5 μm⁻¹ for both small scale and scaled-up synthesis. Although less sensitive than pitch measurements, low voltage measurements of the dielectric constant ε_{⊥} gave similar agreement. We conclude therefore that there appears to be minimal difference in the relevant physical properties of CD13 and CD29 from small scale and scaled up synthesis.

Accordingly, these results indicate the feasibility of optimizing chemical transformations (and molecule purification as needed) to produce a desired bioreachable chiral dopant with scaled-up synthetic processes. Further derivatives can include hydrogenated derivatives of any chiral dopant described herein, as well as structurally modified derivatives having aliphatic ester or alkaryl ester modifications. In addition, physical and optical properties of the scaled-up material can be compared to prior small-scale results in order to verify the process.

### Example 9: Further Characterization of Phase-Stable Dopants CD13 and CD29

CD13 and CD29 were assessed in two different hosts: E7 or MAT12-978 (available as Licristal®, from Merck Advanced Technologies Ltd., Pyongtaek, Korea, having a clearing point of 80° C. and a twist angle of 90°). Table 2 summarizes these results.

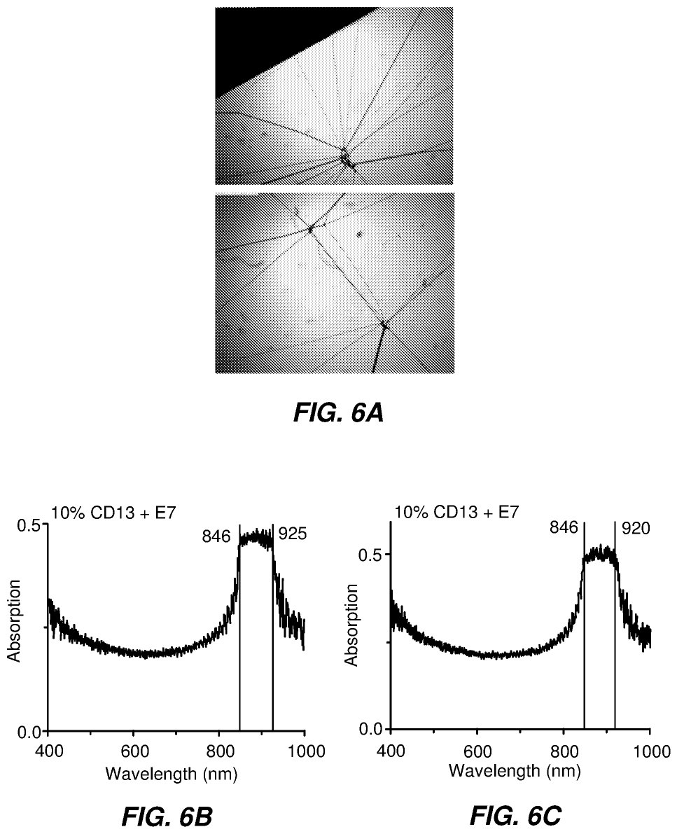

As can be seen, CD13 was stable at some concentrations, e.g., 10 wt. % in E7 or 5 wt. % in MAT12-978. Characterization of 10 wt. % CD13 in E7 is provided in FIG. 6A-6C. As can be seen, there was no evidence of crystallization (FIG. 6A), and the observed shift (˜5 nm) in the spectrum after ten days was likely due to a change in lab temperature (FIG. 6B-6C). CD13 and CD29 also exhibited UV stability, based on dielectric and pitch measurements.

TABLE 2
Phase stability of binary doped materials with CD13 or CD29

| Dopant and concentration [wt. %] | E7 host | MAT 12-978 host |
|---|---|---|
| 5% CD13 | — | Yes |
| 10% CD13 | Yes | No |
| 5% CD29 | No | Yes |
| 10% CD29 | No | No |

### Example 10: Characterization of Phase-Stable Dopants CD46, CD47, and CD48

Other phase-stable dopants provided herein have extended aliphatic groups (e.g., linear or branched C₃₋₁₂ alkyl groups). Illustrative dopants include CD46 and CD47, which are benzoate esters having pendant C₄₋₇ alkyl groups. CD48 is an aliphatic ester having branched C₇ alkyl groups.

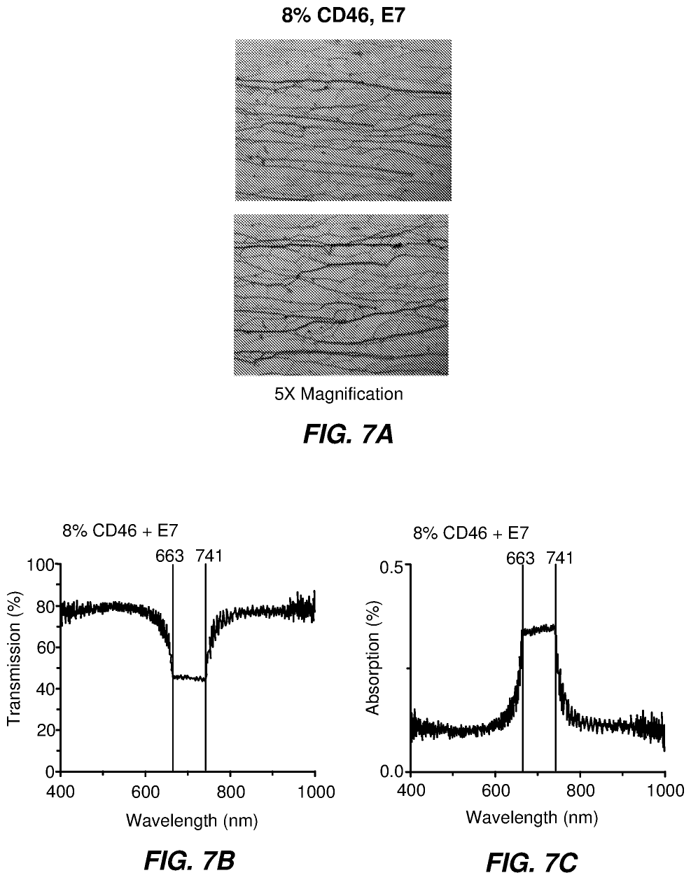

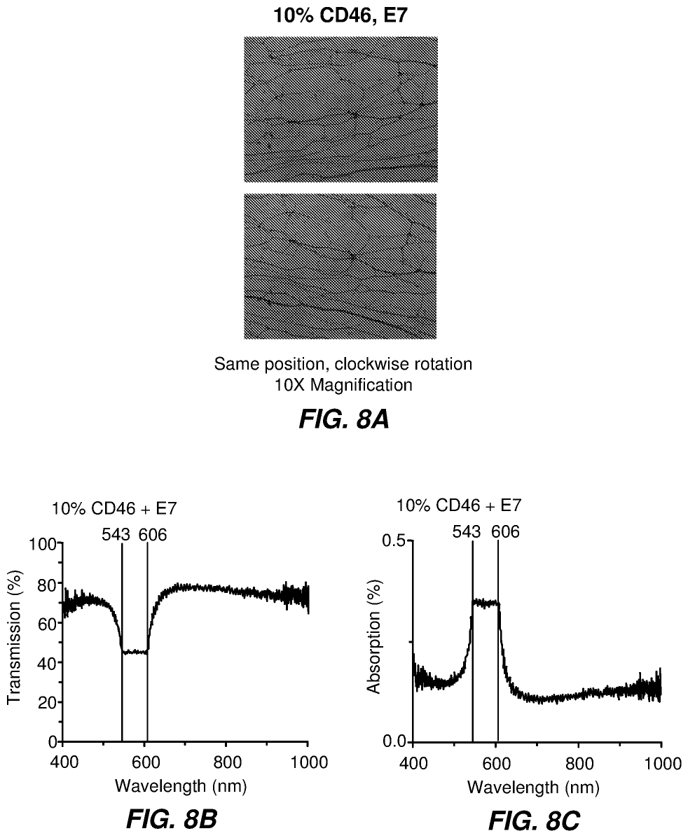

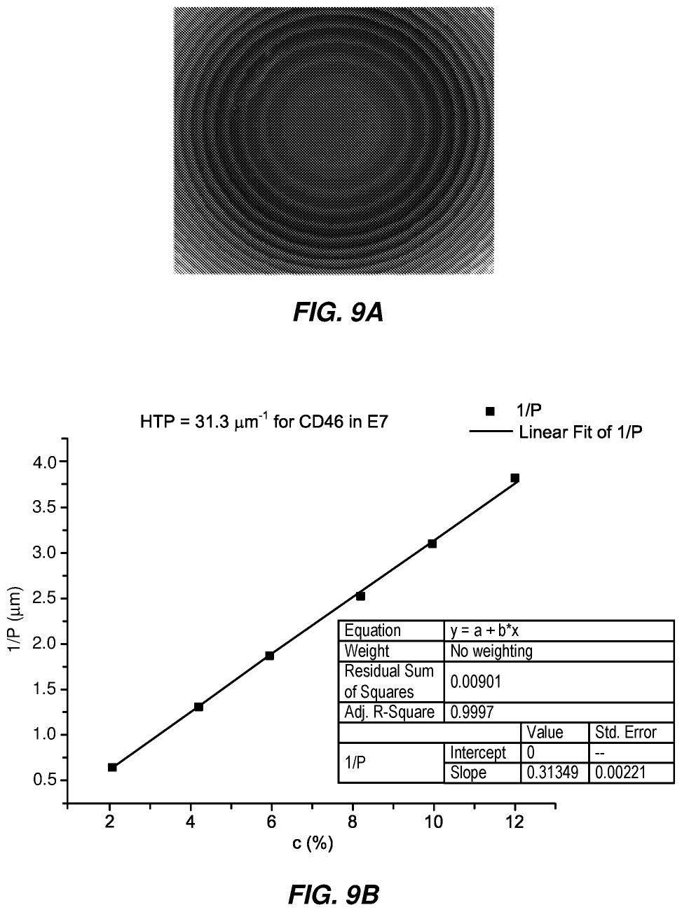

CD46 showed enhanced miscibility in E7 at concentrations up to 10 wt. %, in which no crystallization was observed (FIGS. 7A-7C and FIGS. 8A-8C). Without wishing to be limited by mechanism, the presence of extended aliphatic groups may contribute to lowering crystallization temperatures. The present HTP value for CD46 is 31.3 μm⁻¹ (FIG. 9A-9B, Table 3). Dielectric and pitch measurements indicate that CD46 is UV stable.

TABLE 3
Pitch of CD46 and E7 formulations

| CD46 concentration [wt. %] | Pitch [μm] |
|---|---|
| 2.1 | 1.529 |
| 4.2 | 0.766 |
| 6 | 0.531 |
| 8.2 | 0.398 |
| 10 | 0.322 |
| 12 | 0.261 |

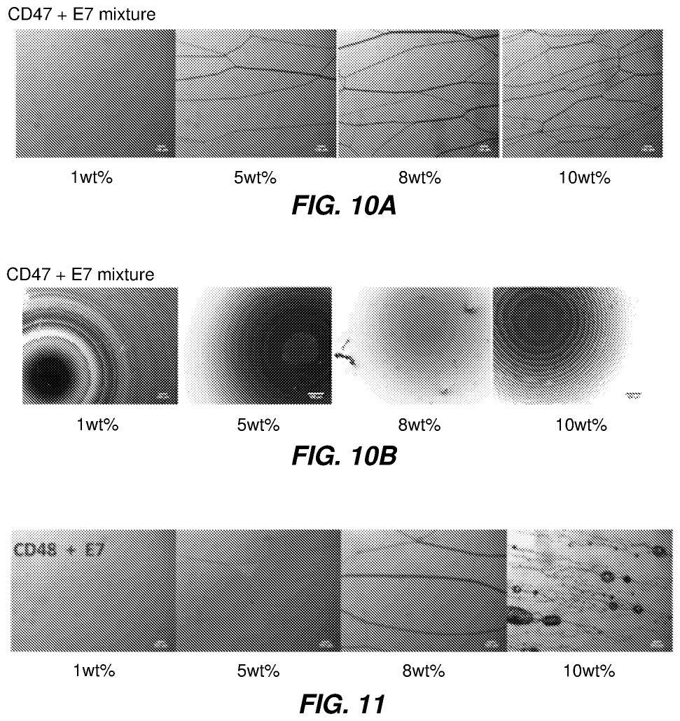

CD47 also showed suitable miscibility in E7 at all tested concentrations (FIG. 10A-10B), but CD48 formulations tend to phase separate at concentrations above 8 wt. % (FIG. 11, in which dark regions indicate isotropic fluid at 10 wt. % of CD48). Table 4 provides measured HTP values using the cylindrical Cano wedge method for dopants in E7.

TABLE 4
Summary of helical twisting power
and phase of CD46, CD47, and CD48

| Dopant | Host | Phase at 20° C. | HTP [μm⁻¹] |
|---|---|---|---|
| CD46 | E7 | crystalline powder | 31.3 |
| CD47 | E7 | liquid | 24.5 |
| CD48 | E7 | liquid | 13.8 |

### Example 11: Multicomponent Formulations

Multicomponent nematic formulations could allow for fine tuning of the physical and optical properties of the material. Another advantage of multicomponent formulations is the suppression of crystallization. Rather than using a single chiral component with a given HTP at 10% concentration to realize a bandgap in the visible, two chiral dopants with similar HTPs can be employed at a lower concentration (e.g., about 5 wt. % for each dopant). Without wishing to be limited by mechanism, the lower concentration could reduce the crystallization temperature, resulting in a formulation with desired optical properties and stability against crystallization/phase segregation.

To demonstrate this approach, four ternary formulations were formulated and tested. Each ternary formulation included two chiral dopants that were simultaneously present in the host. Table 5 summarizes these results.

TABLE 5
Composition and stability of non-limiting ternary materials

| | | Stable against |
|---|---|---|
| Formulation No. | Composition | phase segregation |
| 10-1 | 5 wt. % CD13 + 5 wt. % | No |
| | CD29 + MAT 12-978 | |
| 10-2 | 5 wt. % CD13 + 5 wt. % | Yes |
| | CD29 + E7 | |
| 10-3 | 5 wt. % CD29 + 5 wt. % | Yes |
| | CD46 + E7 | |
| 10-4 | 5 wt. % CD29 + 5 wt. % | Yes |
| | CD47 + E7 | |

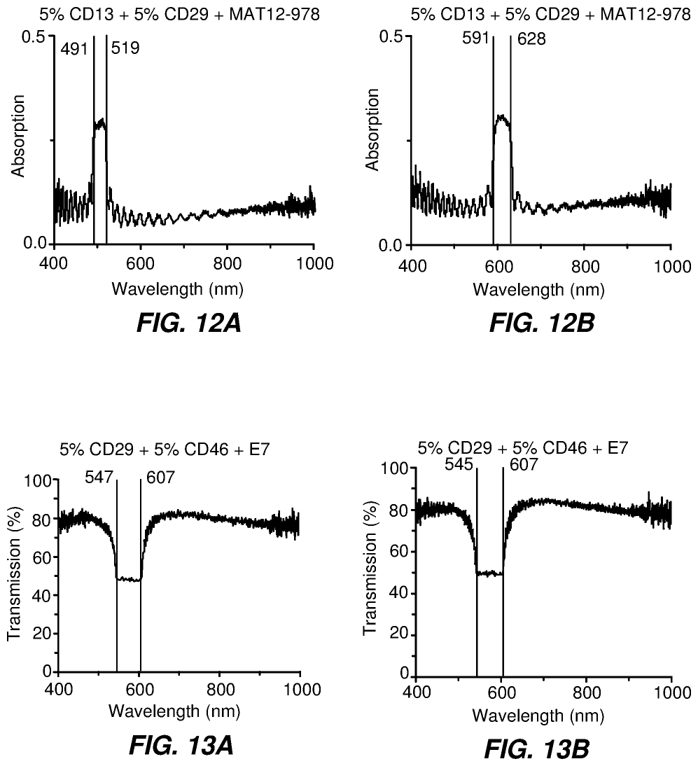

Stability was determined by obtaining absorption spectra of the formulations and then assessing any temporal changes in the reflection band (e.g., changes such as red-shifting). As seen in FIG. 12A-12B, formulation 10-1 appeared unstable, as evidenced by the red-shift of the reflection band.

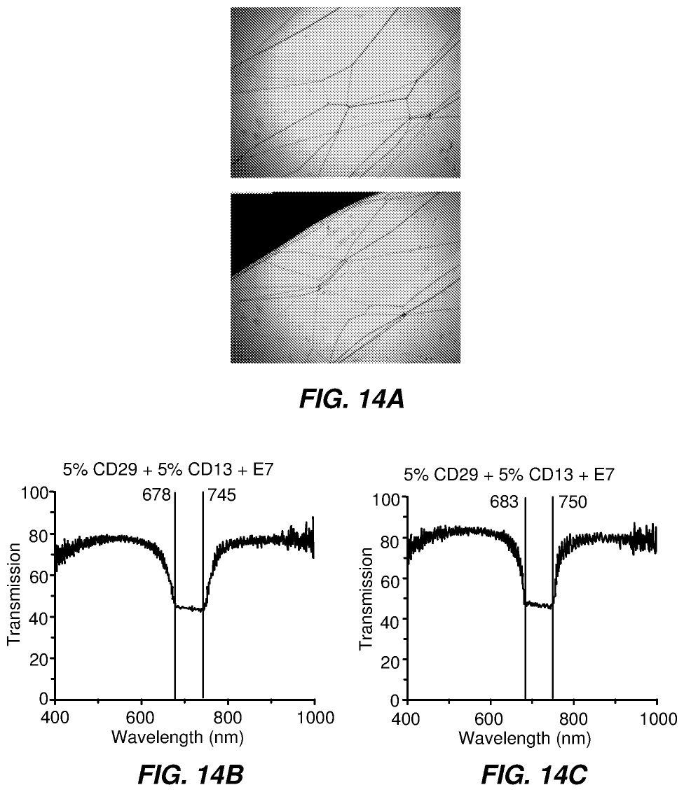

Ternary formulations 10-2, 10-3, and 10-4 were stable against crystallization/phase segregation (to date from the time of mixing). Further characterization data are provided for formulation 10-3 (5 wt. % CD29+5 wt. % CD46+E7, FIGS. 13A-13B) and formulation 10-2 (5 wt. % CD13+5 wt. % CD29+E7, FIG. 14A-14C). Formulation 10-3 also appears to possess thermal stability and UV stability.

### Example 12: UV Stability

For certain device application, chemical stability of the formulations under UV illumination may be beneficial. UV stability studies were conducted for a nematic host (E7), binary formulations (host and one chiral dopant), and ternary formulations (host and two chiral dopants). In each case, sample responses were measured and compared prior to and after UV exposure (e.g., at wavelength of about 310 nm to about 400 nm).

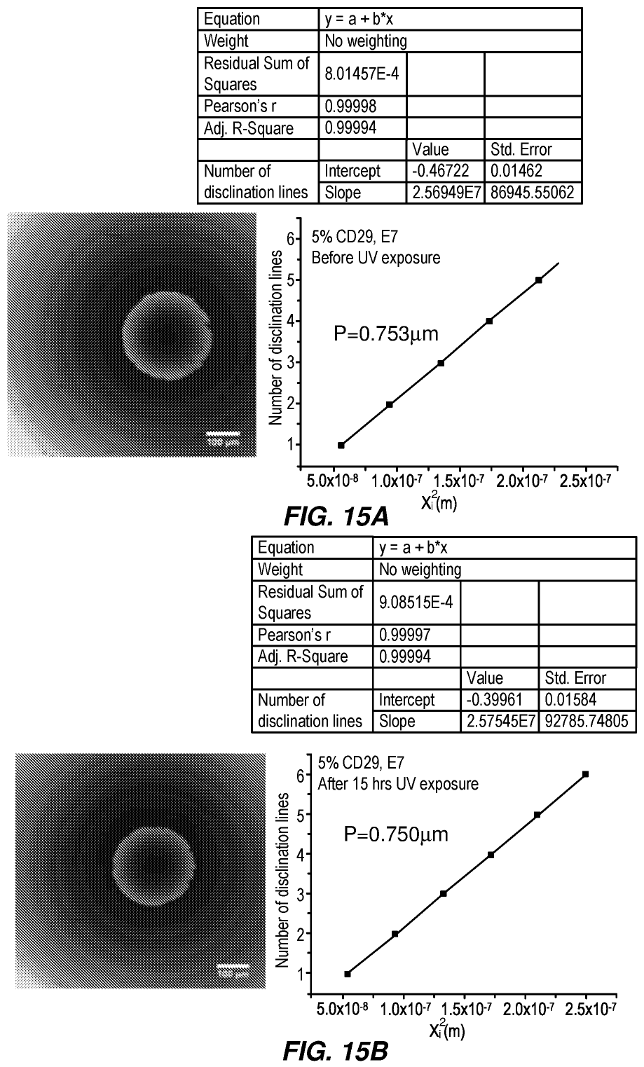

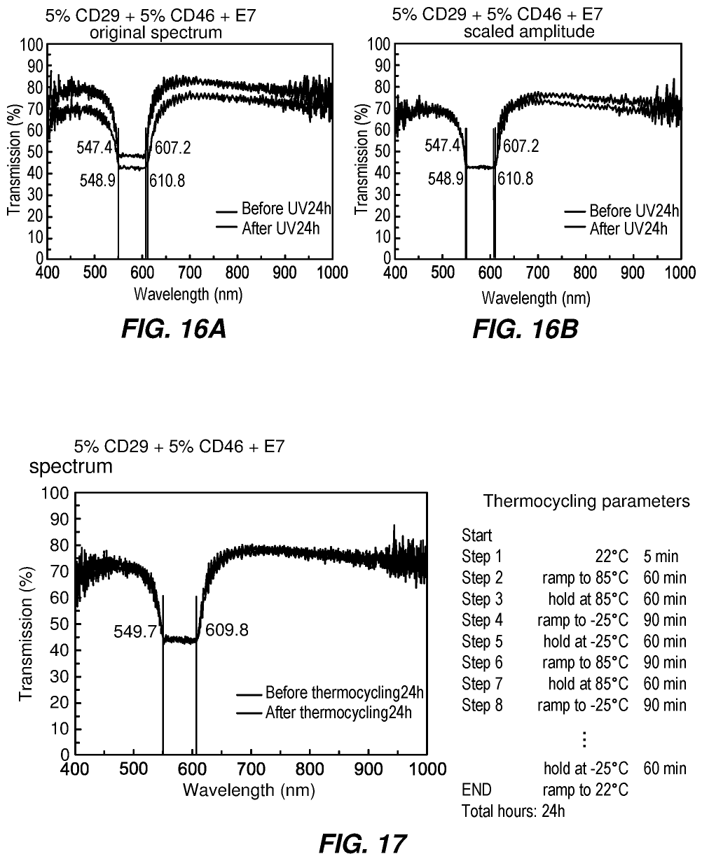

Dopant UV stability can be measured in any useful manner. Illustrative testing methods include dielectric measurements (e.g., measurement of one or more of capacitance or permittivity), pitch measurements, and/or relative band measurements (e.g., using absorption or transmission spectra in the visible range) of formulations before and after UV exposure. Examples of pitch measurements and relative band measurements are described in FIGS. 15A-15B and FIGS. 16A-16B, respectively. Similar results to that in FIG. 16A-16B were obtained for the formulation 5 wt. % CD 29+5 wt. % CD 47+E7 after 24 and 48 hours of exposure. Using the three testing methods outlined above, we have found that the chiral dopants CD13, CD29, CD46 and CD47 are stable against UVA to within experimental accuracy.

### Example 13: Thermal Cycling

Another property of a cholesteric bandgap material is its stability against thermal degradation. We studied the optical response of ternary formulations before and after thermal cycling to look for evidence of thermal degradation. In an example, a 5 wt. % CD29+5 wt. % CD46+E7 formulation exhibited thermally stability after 24 hours of thermocycling (FIG. 17). The thermocycling parameters are similar to that for automotive applications. No evidence of any alteration of the transmission spectrum or the reflection band were observed, indicating stability of the formulation against thermal degradation. Table 6 provides capacitance measurements of a 5 wt. % CD29+5 wt. % CD46+E7 before and after thermocycling.

TABLE 6
Capacitance measurements before and after thermocycling

| | Empty | Before | After |
|---|---|---|---|
| | cell | thermocycling | thermocycling |
| Capacitance (pF) | 42.5 | 232.0 | 232.0 |
| Loss | 0.0200 | 0.0600 | 0.0600 |

### Example 14: Voltage Cycling

When comparing samples before and after stimulus (e.g., such as exposure to UV or thermal cycling), the samples can possess defects with differing defect densities. Such defects can be ubiquitous in cholesterics, due to the high energy barrier that must be overcome to anneal defects.

One non-limiting strategy to reduce the number of defects is to apply a high AC voltage (e.g., about 100 V at 1 kHz across a 50 μm cell) and then suddenly reduce the voltage to zero. The high voltage creates a uniform homeotropic alignment, with the director normal to the cell windows everywhere, and when this voltage is suddenly removed, the director assumes the helical cholesteric structure with relatively few defects. This strategy can be applied to produce nearly uniform defect densities in cells needed for comparisons.

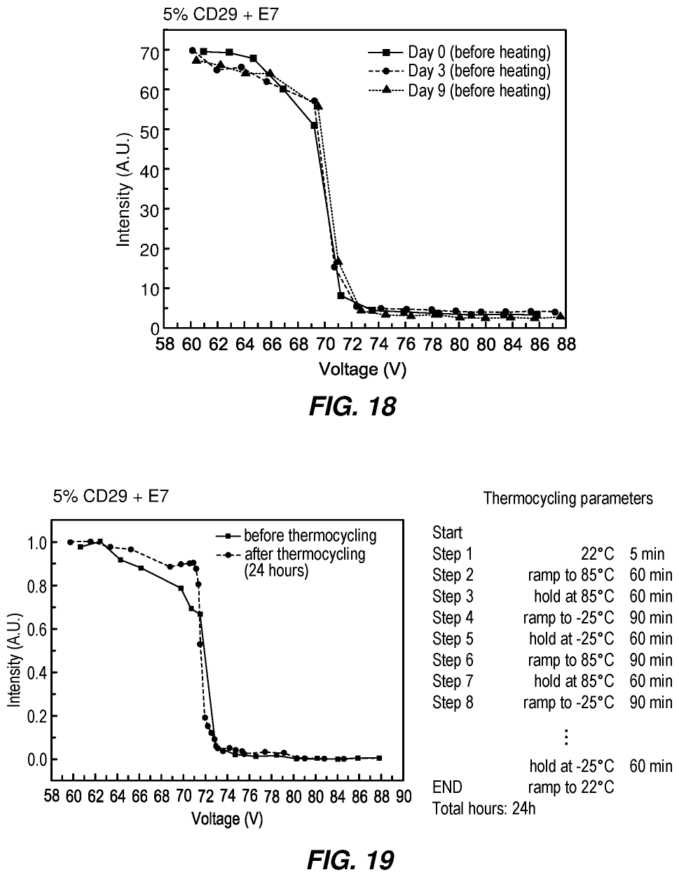

To determine the voltage required to produce homeotropic alignment, we devised a procedure where initially a small voltage is applied, followed by 0 volts, and the intensity of light transmitted through the cell between crossed polarizers is measured (see FIG. 18). If the cell is not homeotropic, the light transmission is high. In contrast, for a homeotropic structure, the transmitted light intensity is zero. The applied voltage is gradually increased while maintaining intensity at a near constant. When a critical voltage is reached, the intensity falls rapidly to zero. The critical voltage is highly reproducible, which indicates that this is a characteristic property of the sample in the cell. It can therefore be used to detect/confirm if the sample in the cell has been altered by stimulus. For instance, the nearly identical critical voltage of the two curves in FIG. 19 confirms that the 5 wt. % CD29+E7 formulation has not been significantly altered by thermal cycling.

Although the voltage cycling method described above can be employed for confirming stability results obtained by other means, such methods also reduce the defect density in cholesteric cells to a nearly uniform low value to facilitate comparisons. In addition to this, however, the process serves as a voltage cycling stimulus. Subsequent dielectric and optical measurements, together with critical voltage results, such as in FIG. 18, have shown that the formulations with CD13, CD 29, CD46, and CD47 are stable under repeated voltage cycling in the 100 V region at 1 kHz.

### Example 15: Long-Term Phase Stability

To assess long-term phase stability, studies were conducted after maintaining materials for more than seven months. Planar LC cells with a thickness of 20 μm were filled with formulations; and transmission spectra and polarization microscopy (PM) images were obtained and assessed.

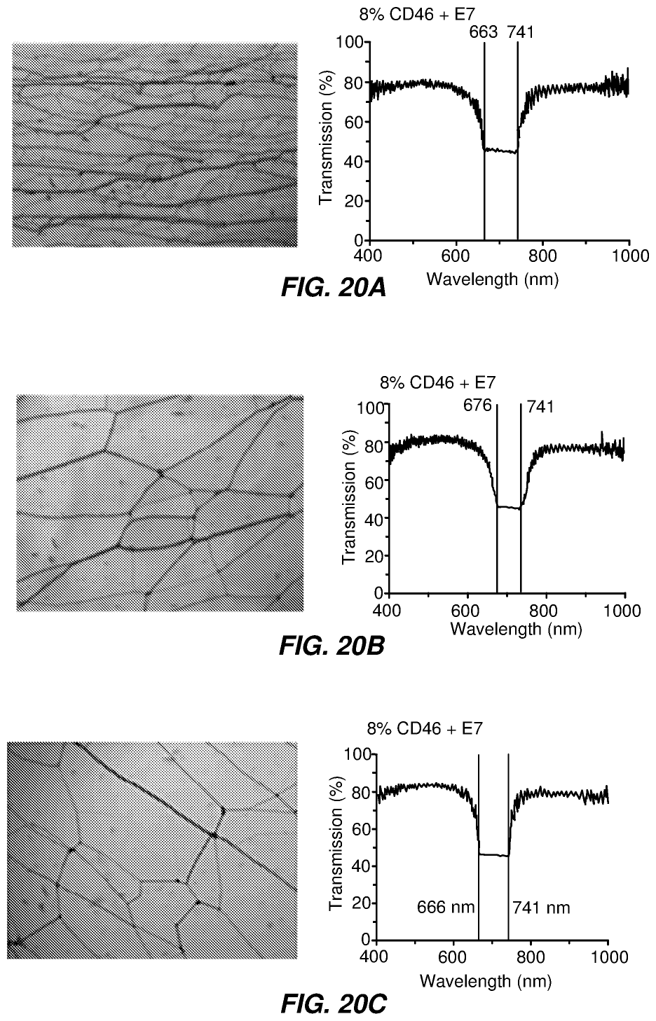

Results are provided for a binary formulation: 8 wt. % CD46+E7 (FIG. 20A-20C). These data show no change in positions of reflection bands within experimental accuracy over a period of more than seven months. PM images also indicate no evidence of crystallization.

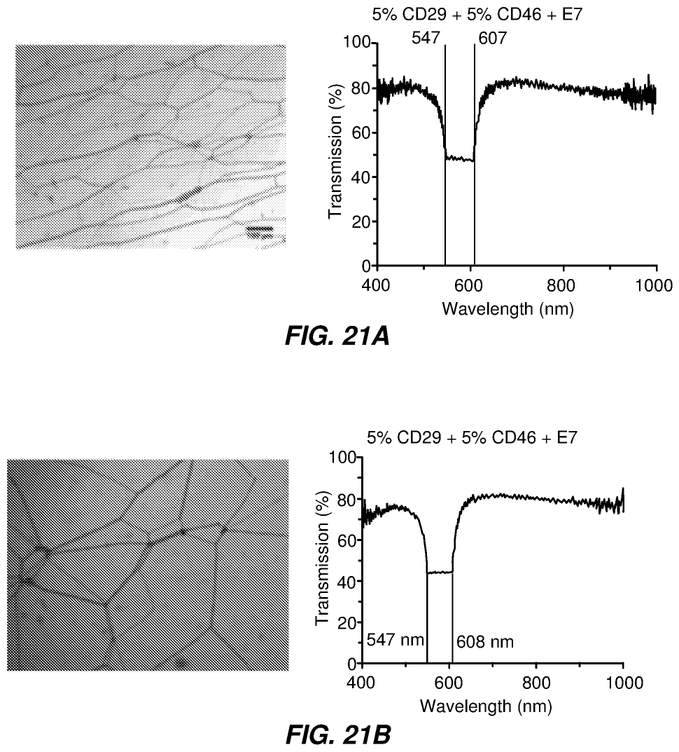

Further results are provided for a ternary formulation: 5 wt. % CD29+5 wt. % CD46+E7 (FIG. 21A-21B). These data indicate no changes in the captured OM images and measured transmission spectrum over a span of more than seven months, indicating stability of this ternary formulation within experimental accuracy.

### Example 16: Illustrative Agile Optical Filter Device

In order to make an “agile optical filter device,” a cholesteric (twisted nematic) media is required. This media can possess a variety of physical properties including a broad temperature cholesteric range (usually including ambient temperature) and a twist with minimal temperature dependence. The required cholesteric media can be created by mixing achiral nematic hosts with one or more bioreachable chiral dopants (e.g., any described herein).

Regarding achiral nematic mesogens (hosts), the medium can include molecules that are mesogenic (nematic), but the molecule is not intrinsically chiral. Typical commercial mixtures include a number of distinct molecular species, such that their combination results in the required physical and optical properties.

Regarding chiral twisting agents (dopants), the twist agent is a chiral molecule; often a pure enantiomer. The twist agent is added to the achiral nematic, producing a twist in the average molecular orientation of the bulk material. The twist increases in proportion to the dopant concentration. In many cases, the proportion of twist agent that can be added is limited by solubility or loss or cholesteric temperature range of the mixture.

The twisted cholesteric structure formed by the twisting agent can be a self-assembled layered structure, which, because of its periodicity, is a photonic band-gap material. Location and the width of the band-gap can be determined by the refractive indices of the nematic, and the pitch of the cholesteric structure. The contrast can be determined by the film thickness. Since the liquid crystal structure can be modified by applied fields, the filter can be switched on and off, and its location and bandwidth can be tuned.

The accessibility of enantiomerically pure chiral compounds through biology makes a bioreachable excellent candidates as twist agents for application in cholesteric liquid crystal technology. Chemical modification of the bioreachables can be performed in order to achieve new molecules with anticipated utility in liquid crystal technology. In particular, as described herein, betulin derivates show considerable promise as chiral dopants in cholesteric liquid crystal systems.

### Other Embodiments

While the disclosure has been described in connection with specific embodiments thereof, it will be understood that it is capable of further modifications and this application is intended to cover any variations, uses, or adaptations of the disclosure following, in general, the principles of the disclosure and including such departures from the present disclosure that come within known or customary practice within the art to which the disclosure pertains and may be applied to the essential features hereinbefore set forth, and follows in the scope of the claims.

Other embodiments are within the claims.

1. A formulation comprising:
about 0.5 wt. % to about 30 wt. % of a first chiral dopant derived from betulin or glycyrrhetinic acid; and
about 50 wt. % to about 99.5 wt. % of an achiral host.

2. The formulation of claim 1, wherein the first chiral dopant comprises a structure having formula (IA) or (IB): 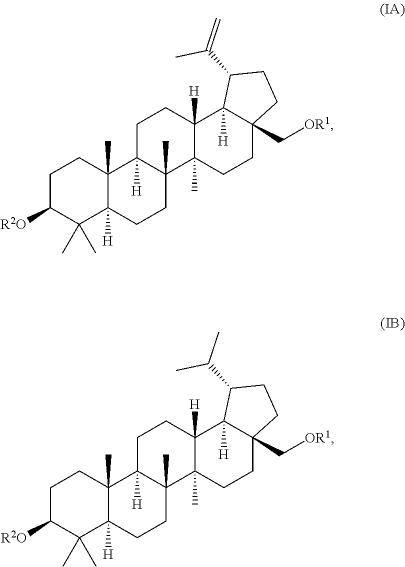
or a salt thereof, wherein:
each of R¹ and R² is, independently, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl.

3. The formulation of claims 1-2, wherein the first chiral dopant comprises a structure having formula (IAa), (IBa), (IAb), or (IBb): 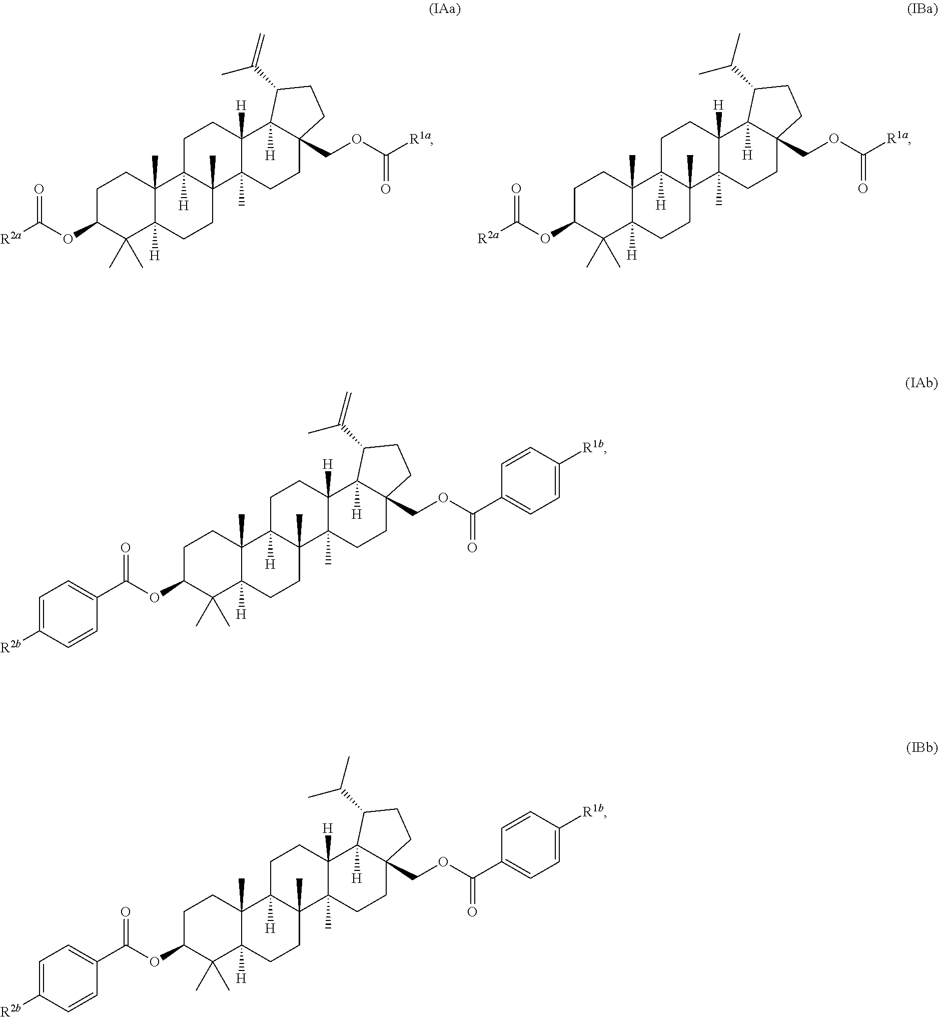
wherein:
each of R^{1a}, R^{2a}, R^{1b}, and R^{2b} is, independently, optionally substituted alkyl, optionally substituted haloalkyl, optionally substituted alkenyl, optionally substituted aralkyl, optionally substituted aryl, or optionally substituted alkaryl.

4. The formulation of claims 1-3, wherein the first chiral dopant is selected from the group consisting of:

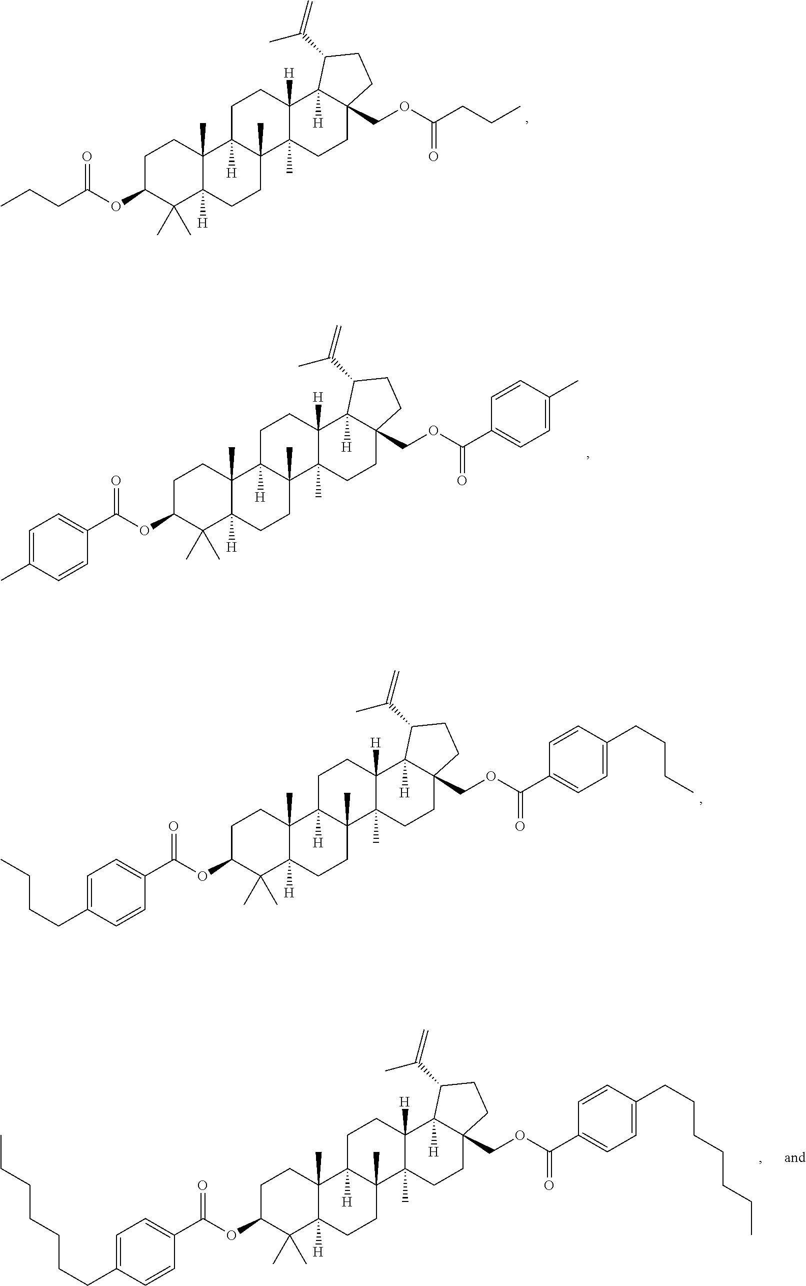

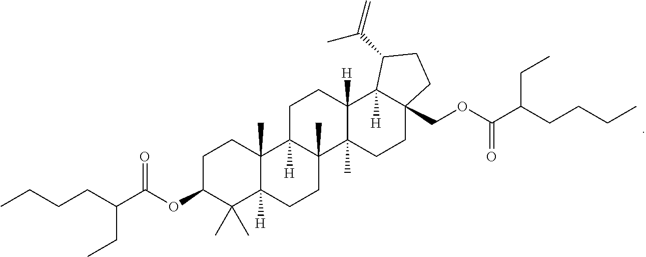

5. The formulation of claims 1-4, further comprising at least one polymerizable mesogenic compound having at least one polymerizable functional group or wherein the achiral host comprises at least one polymerizable mesogenic compound having at least one polymerizable functional group.

6. The formulation of claim 5, wherein the polymerizable functional group includes an epoxy group, a vinyl group, an allyl group, an acrylate, a methacrylate, an isoprene group, an alpha-amino carboxylate, or any combination thereof.

7. The formulations of claims 1-6, wherein the achiral host further comprises a nematic or a nematogenic substance.

8. The formulation of claim 7, wherein the nematic or the nematogenic substance is selected from azoxybenzenes, benzylideneanilines, biphenyls, terphenyls, phenyl benzoates, cyclohexyl benzoates, phenyl esters of cyclohehexanecarboxylic acid, cyclohexyl esters of cyclohehexanecarboxylic acid, phenyl esters of cyclohexylbenzoic acid, cyclohexyl esters of cyclohexylbenzoic acid, phenyl esters of cyclohexylcyclohexanecarboxylic acid, cyclohexyl esters of cyclohexylcyclohexanecarboxylic acid, cyclohexylphenyl esters of benzoic acid, cyclohexylphenyl esters of cyclohexanecarboxylic acid, cyclohexylphenyl esters of cyclohexylcyclohexanecarboxylic acid, phenylcyclohexanes, cyclohexylbiphenyls, phenylcyclohexylcyclohexanes, cyclohexylcyclohexanes, cyclohexylcyclohexenes, cyclohexylcyclohexylcyclohexenes, 1,4-bis-cyclohexylbenzenes, 4,4′-bis-cyclohexylbiphenyls, phenylpyrimidines, cyclohexylpyrimidines, phenylpyridines, cyclohexylpyridines, phenylpyridazines, cyclohexylpyridazines, phenyldioxanes, cyclohexyldioxanes, phenyl-1,3-dithianes, cyclohexyl-1,3-dithianes, 1,2-diphenylethanes, 1,2-dicyclohexylethanes, 1-phenyl-2-cyclohexylethanes, 1-cyclohexyl-2-(4-phenylcyclohexyl) ethanes, 1-cyclohexyl-2-biphenylethanes, 1-phenyl2-cyclohexylphenylethanes, halogenated stilbenes, benzyl phenyl ether, tolanes, substituted cinnamic acids, or any combination thereof.

9. A formulation comprising:
a first chiral dopant derived from betulin or glycyrrhetinic acid; and
a second chiral dopant derived from betulin or glycyrrhetinic acid, wherein the first and second chiral dopants are different.

10. The formulation of claim 9, wherein the first chiral dopant comprises a structure having formula (IA) or (IB): 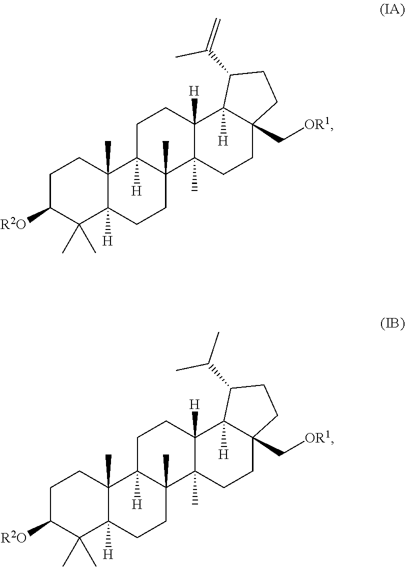
or a salt thereof, wherein:
each of R¹ and R² is, independently, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl.

11. The formulation of claims 9-10, wherein the second chiral dopant comprises a structure having formula (IIA) or (IIB): 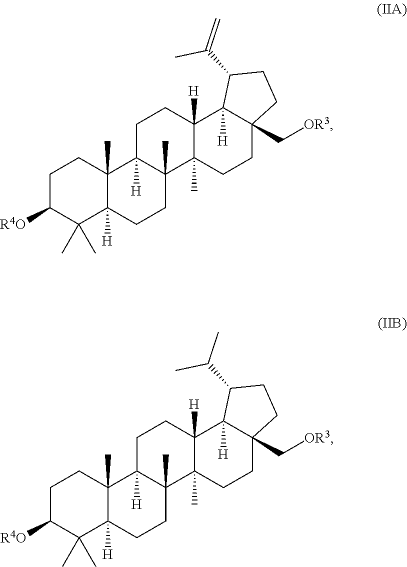
wherein:
each of R³ and R⁴ is, independently, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl.

12. The formulation of claims 9-11, wherein the first or second chiral dopant comprises a structure having formula (IAa), (IBa), (IAb), or (IBb): 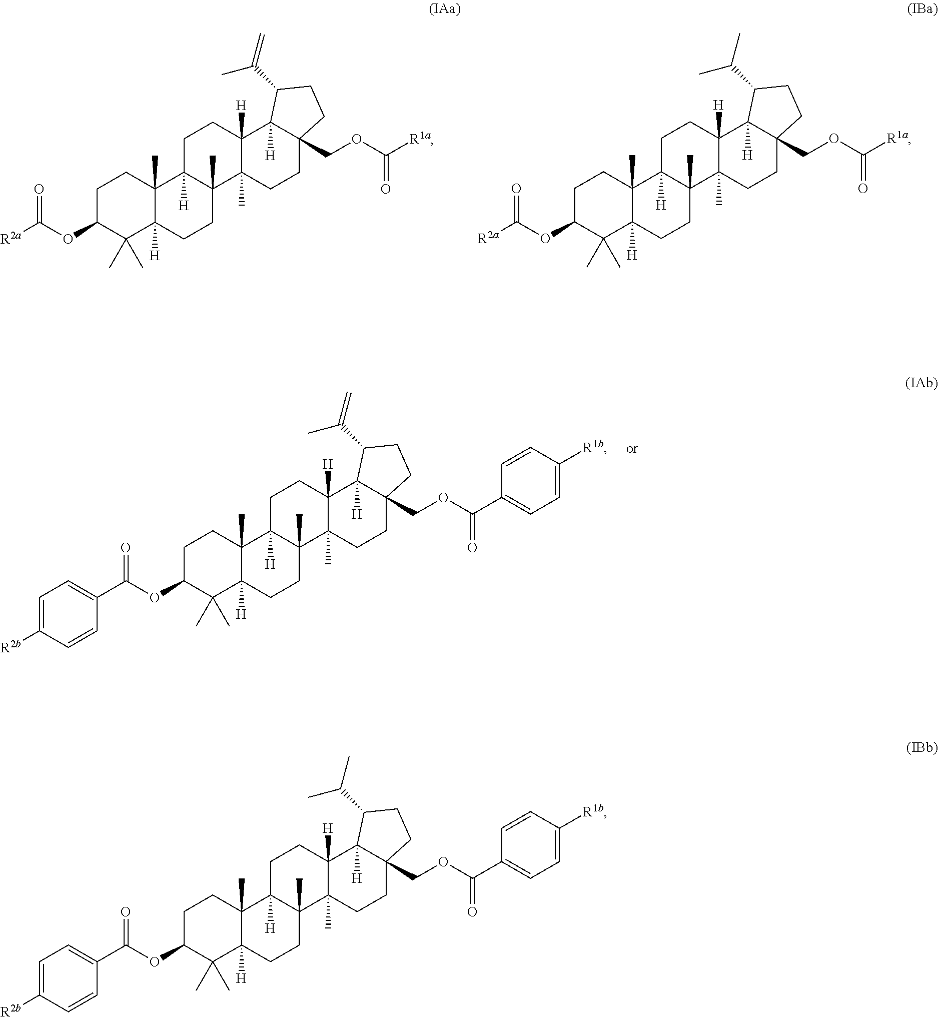
wherein:
each of R¹, R^{2a}, R^{1b}, and R^{2b} is, independently, optionally substituted alkyl, optionally substituted haloalkyl, optionally substituted alkenyl, optionally substituted aralkyl, optionally substituted aryl, or optionally substituted alkaryl.

13. The formulation of claims 9-12, further comprising:
a third chiral dopant derived from betulin, wherein the first, second, and third chiral dopants are different.

14. The formulation of claim 13, wherein the third chiral dopant comprises a structure having formula (IA) or (IB).

15. The formulation of claims 9-14, wherein each of the first chiral dopant, the second chiral dopant, and the third chiral dopant, if present, is selected from the group consisting of:

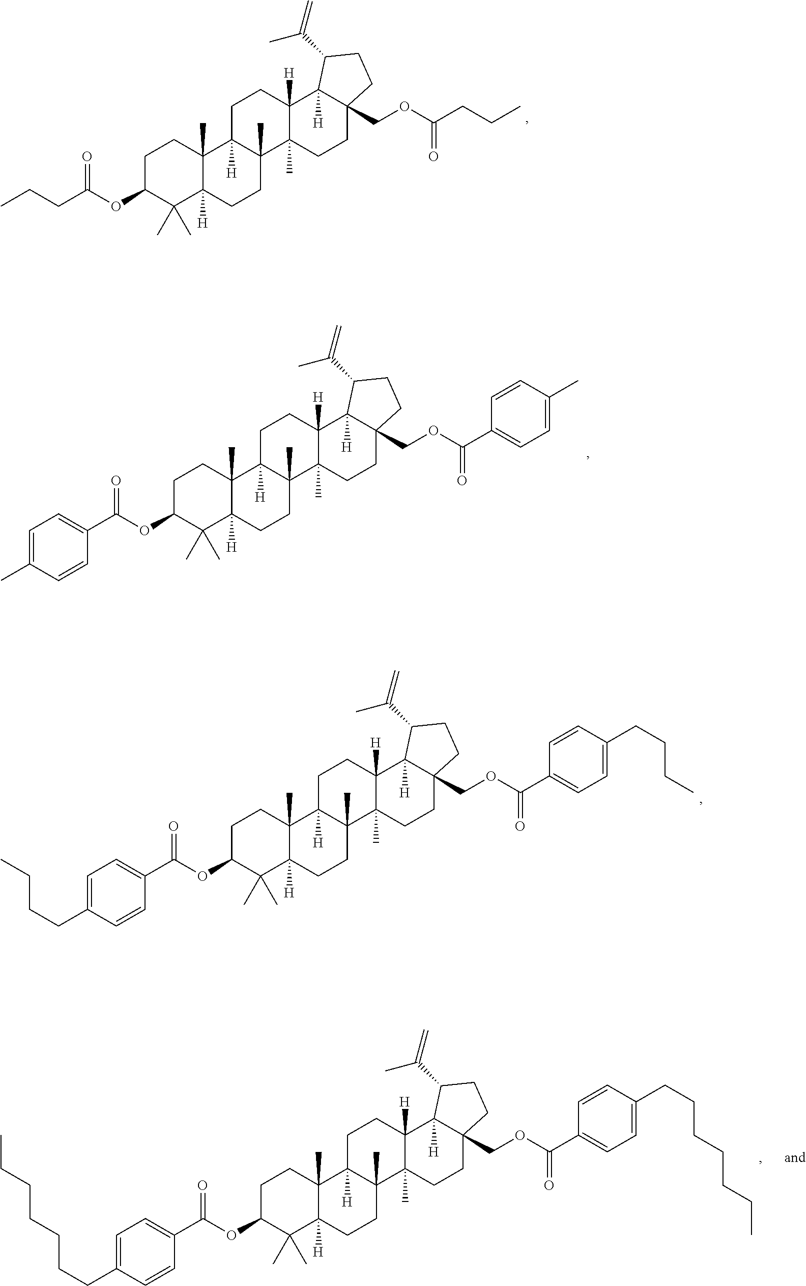

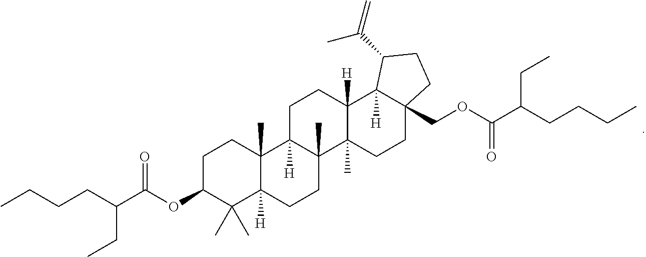

16. A liquid crystalline material comprising:
about 0.5 wt. % to about 20 wt. % of a first chiral dopant derived from betulin; and
about 0.5 wt. % to about 20 wt. % of a second chiral dopant derived from betulin, wherein the first and second chiral dopants are different.

17. The material of claim 16, further comprising:
a third chiral dopant derived from betulin, wherein the first, second, and third chiral dopants are different.

18. The material of claims 16-17, wherein the first chiral dopant comprises a structure having formula (IA) or (IB): 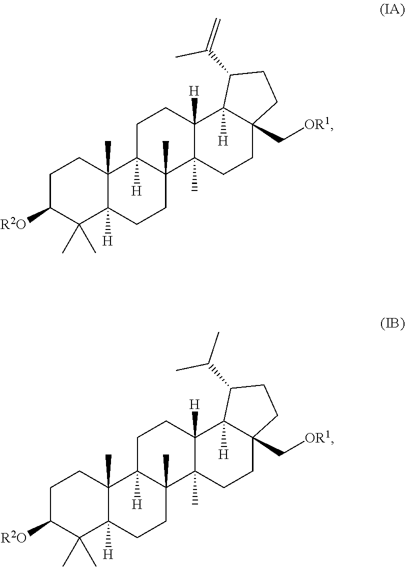
or a salt thereof, wherein:
each of R¹ and R² is, independently, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl.

19. The material of claims 16-18, the second chiral dopant comprises a structure having formula (IIA) or (IIB): 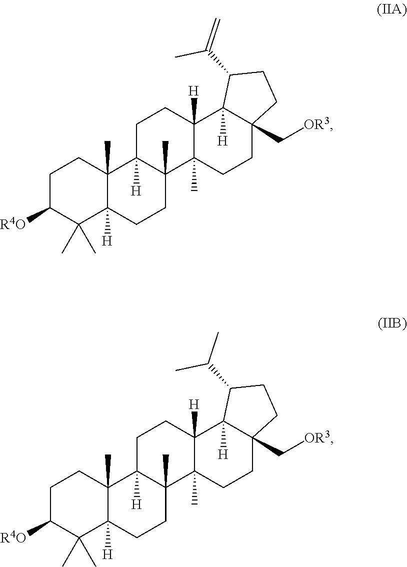
wherein:
each of R³ and R⁴ is, independently, optionally substituted alkyl, optionally substituted alkenyl, optionally substituted aralkyl, optionally substituted aryl, optionally substituted alkaryl, optionally substituted alkanoyl, optionally substituted aryloyl, or optionally substituted heterocyclyloyl.

20. The material of claims 16-19, further comprising at least one polymerizable mesogenic compound having at least one polymerizable functional group.

21. The material of claim 20, wherein the polymerizable functional group includes an epoxy group, a vinyl group, an allyl group, an acrylate, a methacrylate, an isoprene group, an alpha-amino carboxylate, or any combination thereof.

22. The material of claims 16-19, further comprising a nematic or a nematogenic substance.

23. The material of claim 22, wherein the nematic or the nematogenic substance is selected from azoxybenzenes, benzylideneanilines, biphenyls, terphenyls, phenyl benzoates, cyclohexyl benzoates, phenyl esters of cyclohehexanecarboxylic acid, cyclohexyl esters of cyclohehexanecarboxylic acid, phenyl esters of cyclohexylbenzoic acid, cyclohexyl esters of cyclohexylbenzoic acid, phenyl esters of cyclohexylcyclohexanecarboxylic acid, cyclohexyl esters of cyclohexylcyclohexanecarboxylic acid, cyclohexylphenyl esters of benzoic acid, cyclohexylphenyl esters of cyclohexanecarboxylic acid, cyclohexylphenyl esters of cyclohexylcyclohexanecarboxylic acid, phenylcyclohexanes, cyclohexylbiphenyls, phenylcyclohexylcyclohexanes, cyclohexylcyclohexanes, cyclohexylcyclohexenes, cyclohexylcyclohexylcyclohexenes, 1,4-bis-cyclohexylbenzenes, 4,4′-bis-cyclohexylbiphenyls, phenylpyrimidines, cyclohexylpyrimidines, phenylpyridines, cyclohexylpyridines, phenylpyridazines, cyclohexylpyridazines, phenyldioxanes, cyclohexyldioxanes, phenyl-1,3-dithianes, cyclohexyl-1,3-dithianes, 1,2-diphenylethanes, 1,2-dicyclohexylethanes, 1-phenyl-2-cyclohexylethanes, 1-cyclohexyl-2-(4-phenylcyclohexyl) ethanes, 1-cyclohexyl-2-biphenylethanes, 1-phenyl2-cyclohexylphenylethanes, halogenated stilbenes, benzyl phenyl ether, tolanes, substituted cinnamic acids, or any combination thereof.

24. The material of claims 16-23, wherein the material comprises a helical twisting power of from about 1 μm⁻¹ to about 100 μm⁻¹.

25. A liquid crystal display, optical element, or color filter comprising a formulation of any of claims 9-15.

26. A display comprising a layer of liquid crystalline material of any of claims 16-24, the liquid crystalline material having a cholesteric pitch (P) and a thickness (d), wherein a ratio of d/P is at least 0.01, at least 0.02, at least 0.05, at least 0.1, or at least 0.15.

27. The display of claim 26, wherein the ratio of d/P is not greater than 1, not greater than 0.8, not greater than 0.6, not greater than 0.4, not greater than 0.3, or not greater than 0.25.

28. A method of making a formulation, the method comprising:
reacting a first biomolecule with a first derivatizing agent to provide a first chiral dopant comprising a structure having formula (I), (III), or a salt thereof, wherein first biomolecule comprises betulin or glycyrrhetinic acid; and
combining the first chiral dopant with an achiral host to provide the formulation comprising about 0.5 wt. % to about 30 wt. % of the first chiral dopant and about 50 wt. % to about 99.5 wt. % of the achiral host.

29. The method of claim 28, wherein said combining provides the formulation of claims 1-8.

30. A method of making a formulation, the method comprising:
reacting a first biomolecule with a first derivatizing agent to provide a first chiral dopant comprising a structure having formula (I), (III), or a salt thereof, wherein first biomolecule comprises betulin or glycyrrhetinic acid;
reacting a second biomolecule with a second derivatizing agent to provide a second chiral dopant comprising a structure having formula (I), (III), or a salt thereof, wherein second biomolecule comprises betulin or glycyrrhetinic acid and wherein the first and second chiral dopants are different; and
combining the first and second chiral dopants to provide the formulation.

31. The method of claim 30, wherein said combining provides the formulation of claims 9-15.

32. The method of claim 30, wherein said combining further includes combining the first and second chiral dopants with an achiral host to provide a further formulation.

33. The method of claim 32, wherein said combining provides the further formulation comprising about 0.5 wt. % to about 30 wt. % of the first chiral dopant, about 0.5 wt. % to about 30 wt. % of the second chiral dopant, and about 40 wt. % to about 99 wt. % of the achiral host.
